(19) United States
(12) Patent Application Publication
(10) Pub. No.: US 2004/0142227 A1
(43) Pub. Date: Jul. 22, 2004

(54) Fuel cell casing, fuel cell, and electronic apparatus

(75) Inventors: Koichiro Sugai, Kokubu-shi (JP); Takayuki Miyao, Kokubu-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/721,828

(22) Filed: Nov. 25, 2003

(30) Foreign Application Priority Data
Nov. 26, 2002 (JP) P2002-342862
Nov. 26, 2002 (JP) P2002-342863
Dec. 26, 2002 (JP) P2002-375755
Jun. 27, 2003 (JP) P2003-185919
Jul. 18, 2003 (JP) P2003-199022

(51) Int. Cl. H01M 2/02; H01M 8/02; H01M 8/10

(52) U.S. Cl. 429/38; 429/32

(57) ABSTRACT

A fuel cell casing includes a base body having plural concavities for housing a membrane electrode assembly, the membrane electrode assembly having first and second electrodes; a first fluid channel extending from a bottom surface of the concavity to an outer surface of base body; a first wiring conductor having one end disposed on the bottom surface of the concavity, and another end led to the outer surface of the base body; a lid body mounted around the concavity; a second fluid channel extending from a lower surface to an outer surface of the lid body; a second wiring conductor having one end disposed on the lower surface of the lid body, and another end led to outer surface of the lid body; and a third wiring conductor having one end opposed to the first electrode on bottom surface of one concavity, and another end opposed to the first electrode on the bottom surface of the other concavity.

### BACKGROUND OF THE INVENTION

1. Field of the Invention

The present invention relates to a fuel cell casing that is capable of accommodating a membrane electrode assembly, made of ceramics, small and highly reliable, a fuel cell using the same and electronic apparatus, and further relates to electronic apparatus having a fuel cell as a power source which fuel cell is a small, highly reliable, capable of accommodating a membrane electrode assembly and made of multilayer ceramics.

2. Description of the Related Art

In recent years, development of a compact fuel cell which is operated at lower temperature than ever before has been briskly underway. Fuel cells are classified according to their electrolytes in use. For example, there have been known Polymer Electrolyte Fuel Cell (hereinafter abbreviated to “PEFC”); Phosphoric-acid Fuel Cell; and Solid-oxide Fuel Cell.

In recent years, in accordance with an increase of functions of mobile electronic apparatus, consumed electric power has increased. Moreover, since a secondary battery needs charging after use of a fixed amount of electric power and needs a battery charger and charging time, there remain a lot of problems in long driving of mobile electronic apparatus.

From these demands, electronic apparatus such as a mobile phone or a laptop PC (personal computer) provided with a small fuel cell as a power source is proposed. A fuel cell can be used continuously as far as supply of fuel and oxygen is continued. As a small fuel cell, PEFC, a direct methanol fuel cell (referred to as a DMPC hereafter) and the like are known.

These fuel cells, whose operation temperatures are as low as approximately 00 to 100° C., have outstanding merits as follows:

(1) their power densities are high, and miniaturization and weight reduction are allowed;

(2) since an electrolyte membrane is not corrosive, their operation temperatures are low and therefore the constitution materials of the cells are constrained little from the aspect of corrosion-resistance, cost reduction is easy; and

(3) in comparison with other fuel cells, actuation at ordinary temperatures is allowed, and therefore, actuation time is short.

Therefore, making the best use of the merits as mentioned above, it lids been considered to not only apply a PEFC and a DMPC to a driving power source for a vehicle, a household cogeneration system and the like but also use as a power source fox mobile electronic apparatus such as a mobile phone, a PDA (personal digital assistant), a laptop PC (personal computer) or a digital camera or video whose outputs are a few watts to several tens of watts.

Roughly, a PEFC and a DMFC comprise, for example, a fuel electrode (a cathode) made of a carbon electrode on which fine particles of a catalyst such as platinum or platinum-ruthenium are attached, an air electrode (an anode) made of a carbon electrode on which fine particles of a catalyst such as platinum are attached, and a film-like membrane electrode assembly interposed between the fuel electrode and the air electrode (referred to as a membrane electrode assembly hereafter).

Here, in the case of PEFC, the fuel electrode is supplied with hydrogen gas (H₂) extracted through a reforming section, whereas the air electrode is supplied with oxygen gas (O₂) present in the air. Consequently, certain electric energy is generated through an electrochemical reaction (electricity production), and thereby electric energy acting as driving power (voltage/current) for a load is produced.

Specifically, when hydrogen gas (H₂) is supplied to the fuel electrode, as shown in the following chemical equation (1), with the action of the catalyst, an electron (e⁻)-separated hydrogen ion (proton; H⁺) is generated, and the proton passes through the membrane electrode assembly toward the air electrode. Moreover, the electron (e⁻) is ejected by the carbon electrode constituting the fuel electrode and is supplied to the load.

3H₂→6H⁺+6e⁻ (1)

On the other hand, when air is supplied to the air electrode, as shown in the following chemical equation (2), with the action of the catalyst, the electron (e⁻) having passed through the load, the hydrogen ion (H⁺) having passed through the membrane electrode assembly, and oxygen gas (O₂) present in the air react with one another to form water (H₂O).

6H⁺+3/2O₂+6e⁻→3H₂O (2)

Such a series of electrochemical reactions (equations (1) and (2)) commonly take place at a relatively low temperature of 80 to 100° C. Basically, a by-product material other than electric power is water (H₂O) alone.

In concrete, when a methanol (CH₃OH) aqueous solution is supplied to the fuel electrode, as shown by the following chemical reaction formula (3), hydrogen ions (proton; H⁺) from which electrons (e⁻) are separated by the catalyst are evolved and passed through to the side of the air electrode via the membrane electrode assembly, and the electrons (e⁻) are taken out by the carbon electrode constituting the fuel electrode and supplied to the load.

CH₃OH+H₂O→CO₂+6H⁺+6e⁻ (3)

On the other hand, when the air is supplied to the air electrode, as shown by the following chemical reaction formula (4), electrons (e⁻) passed through a load by the catalyst, hydrogen ions (H⁺) passed through the membrane electrode assembly, and oxygen gas (O₂) in the air react, and water (H₂O) is generated.

6H⁺+3/2O₂+6e⁻→3H₂O (4)

Such a series of electrochemical reactions (equations (3) and (4)) commonly take place at a relatively low temperature of 80 to 100° C. Basically, a by-product material other than electric power is water (H₂O) alone.

As an ionically conductive membrane (Polymeric solid ele constituting a membrane electrode assembly, a cation-exchange membrane of polystyrene-base having a sulfonic acid group, a mixed membrane of fluorocarbon sulfonic acid and polyvinylidene fluoride, a membrane obtained by grafting trifluoroethylene to fluorocarbon matrix, and the like are known, and recently, a perfluorocarbon sulfonic acid membrane (for example, Nation: a product name, produced by DuPont) or the like is used.

In FIG. 20, the constitution of a conventional fuel cell (PEFC) is shown in a sectional view. In this view, reference numeral 1 denotes a PEFC, reference numeral 3 denotes a membrane electrode assembly, reference numerals 4, 5 denote a pair of porous electrodes that are placed on the membrane electrode assembly 3 so as to sandwich the membrane electrode assembly and that have functions as a gas diffusely layer and a catalyst layer, that is, a fuel electrode and an air electrode, reference numeral 6 denotes a gas separator, reference numeral 8 denotes a fuel duct, and reference numeral 9 denotes an air duct.

The gas separator 6 is constituted by a stacked portion and a gas input/output frame that form the outer shape of the gas separator 6, a separator portion that separates the fuel duct 8 and the air duct 9, and electrodes that are disposed so as to pierce the separator portion and placed so as to correspond to the fuel electrode 4 and the air electrode 5 of the membrane electrode assembly 3. A general PEFC main body is made by stacking in large numbers via the gas separators 6 so that the fuel electrodes 4 and the air electrodes 5 of the membrane electrode assemblies 3 are electrically connected in series and/or in parallel to become a stack of fuel cells as the minimum unit of a cell, and storing this stack of fuel cells in a box.

Fuel gas that contains water vapor (gas that is rich in hydrogen) is supplied from a reforming device to the fuel electrode 4 through the fuel duct 8 formed in the gas separator 6 and the air is supplied as oxidant gas from the air to the air electrode 5 through the air duct 9, and electric power is generated by a chemical reaction in the membrane electrode assembly 3.

Related art is disclosed in Japanese Unexamined Patent Publications JPA 2001-266910 and 2001-507501.

However, this fuel cell 1 that has been proposed and developed up to now as a high-voltage and high-capacity cell is a heavy and large cell which has a stack structure and whose constitution elements have large areas, and use of a fuel cell as a small cell has been hardly considered so far.

That is to say, the conventional gas separator 6 in the fuel cell 1 has a problem that since the side surfaces of the membrane electrode assemblies 3 are exposed outside in a stacked body made by stacking the membrane electrode assemblies 3 by the use of the gas separators, they are easily damaged because of a fall at the time of carrying, and it is hard to guarantee mechanical reliability of the whole fuel cell 1.

Further, in order to install the fuel cell 1 in mobile electronic apparatus, a fuel cell casing that is excellent in compactness, convenience and safety unlike a conventional large fuel cell casing is necessary. In other words, although it is necessary, in order to apply as a portable power source such as a general-purpose chemical cell, to miniaturize and low-profile a fuel cell casing for the purpose of shortening time for increasing temperature up to operation temperature and making a thermal capacity small, the gas separator 6 that dominates a large proportion of a thermal capacity in the conventional fuel cell 1, specifically, the gas separator 6 where the ducts are formed on the surface of a carbon plate by cutting processing becomes fragile when becoming thin-walled, and therefore, it needs thickness of a few millimeters. Therefore, there is also a problem that it is hard to miniaturize and low-profile.

Furthermore, an output voltage of the fuel cell 1 is determined by partial pressures of gases supplied to the respective electrodes 4, 5 on both faces of the membrane electrode assembly 3. That is to say, when fuel gas supplied to the membrane electrode assembly 3 goes through the gas duct 8 and is consumed in an electric power generation reaction, partial pressure of fuel gas on the face of the fuel electrode 4 decreases and an output voltage decreases. In the same manner, when the air goes through the air duct 9 and is consumed, partial pressure of oxygen on the face of the air electrode 5 decreases and an output voltage decreases. Although it is therefore necessary to supply fuel gas equally, the ducts are formed on the surface of a carbon plate by cutting processing specifically in the gas separator 6 of the conventional fuel cell 1, and therefore, grooves of the ducts become narrow at the time of low-profiling, so that there is also a problem that duct resistance becomes large and uniform fuel supply is difficult.

Moreover, a plurality of membrane electrode assemblies 3 need to be arbitrarily connected in series or parallel with their corresponding fuel electrode 4, air electrode 5, and gas separator 6 with efficiency to adjust the output voltage and output current as a whole. In the conventional fuel cell 1, however, electric power cannot be obtained from the fuel electrode and the air electrode having sandwiched therebetween the membrane electrode assembly 3 without drawing out the components externally and establishing connection, or without stackedly connecting the components in series using the gas separator 6 as a conductive material. Inconveniently, such operations are difficult to perform in a compact fuel cell. This leads to difficulty in providing a compact stack structure of the fuel cell that allows enhancement of the volume output density in the fuel cell by increasing the effective usable area of the membrane electrode assembly 3.

At the time of using by installing in mobile electronic apparatus, it is hard to connect to a motherboard or the like for forming an electronic circuit as a main part of electronic apparatus in a limited space.

Further, electronic apparatus using the conventional fuel cell 1 need a lot of components such as a collector board that takes out electricity generated in the membrane electrode assembly 3 to a motherboard or the like for forming electronic circuit as a main part of electronic apparatus, an insulating material such as silicon rubber for insulating the collector board from the housing for storing the fuel cell, and screws and clamps (not shown in the drawing) for mounting the gas separator 6, the membrane electrode assembly 3, the collector board and the insulating material to the fuel cell casing, and it has a problem that miniaturization and low-profiling are difficult.

As a method of causing the entire output voltage and output current to be regulated, a method of arranging a plurality of combinations of the membrane electrode assemblies 3, the fuel electrodes 4 and the air electrodes 5 facing thereto and the gas separators 6 on the same plane is considered. This arrangement on the same plane is effective for low-profiling as compared with the stack structure frequently used up to now, whereas it causes a problem that an insulating member for securing insulation between the adjacent fuel cell is required additionally and the parts count increases further. Moreover, there are also problems that interlayer duct processing in the plane direction to connect the adjacent fuel cells cannot be done because the ducts are processed by machining or molding, it is impossible to install electronic parts or the like in the gas separator 6 to integrate functions of an electric circuit or the like because a conductive material is used, and so on.

Further, although, at the time of mounting such a fuel cell to mobile electronic apparatus, it is necessary to provide the fuel cell with a terminal for connection to a motherboard or the like for forming an electronic circuit as a main part of the electronic apparatus and dispose a terminal corresponding to the connection terminal to the mobile electronic apparatus, there is a problem that both the terminal on the mobile electronic apparatus and the terminal on the fuel cell casing need relatively complicated designing in the structure. Besides, since, in the case of using a cartridge type of fuel cell that can be freely attached and detached from the viewpoint of convenience at the time of using and carrying the mobile electronic apparatus, it is required to devise the terminals so as to enable such free attachment and detachment, there is a problem that there are more difficulties.

Furthermore, fuel supplied to the side of the fuel electrode is consumed in accordance with electric power generation, and when the density thereof decreases, the efficiency of electric power generation also decreases. Therefore, in order to increase the efficiency of electric power generation in a fuel cell, an oxygen supplying mechanism that forcibly circulates and supplies oxygen to the air electrode and a fuel supplying mechanism that forcibly circulates and supplies fuel to the fuel electrode are needed. However, since the mechanisms for forcibly supplying oxygen and fuel becomes bulky, the whole fuel cell also becomes large, and it is unsuitable for use as a small power source for mobile electronic apparatus.

### SUMMARY OF THE INVENTION

The invention has been devised in view of the above-described problems with the conventional art, and accordingly its object is to provide a compact, sturdy fuel cell casing capable of housing membrane electrode assemblies; a highly-reliable fuel cell casing that allows even gas supply, uniformization of temperature gradients within the fuel cell casing, highly-efficient electrical connection, and highly-efficient electricity production; and a fuel cell employing said fuel cell casing.

Another object of the invention is to provide a fuel cell casing that is capable of equal supply of fuel and highly efficient electrical connection and is reliable, and a fuel cell using the same, and electronic apparatus using the fuel cell that is small, short in height and high-performance and that allows stable use.

The invention provides a fuel cell casing comprising:

a base body made of ceramics that has a plurality of concavities formed on one surface thereof, for accommodating therein a membrane electrode assembly, the membrane electrode assembly having a first electrode and a second electrode which are formed on one principal surface and another principal surface thereof, respectively;

a first fluid channel formed so as to extend from a bottom surface of the concavity facing one principal surface of the membrane electrode assembly to an outer surface of the base body;

a first wiring conductor having its one end disposed on the bottom surface of the concavity facing the first electrode of the membrane electrode assembly, and its another end led to the outer surface of the base body;

a lid body mounted on one surface of the base body near the concavity so as to cover the concavity, for sealing the concavity hermetically;

a second fluid channel formed so as to extend from one surface of the lid body facing the other principal surface of the membrane electrode assembly to an outer surface of the lid body;

a second wiring conductor having its one end disposed on one surface of the lid body facing the second electrode of the membrane electrode assembly, and its another end led to the outer surface of the lid body; and

a third wiring conductor formed in the base body, the third wiring conductor having its one end opposed to the first electrode of the membrane electrode assembly on a bottom surface of one concavity, and its another end opposed to the first electrode of the membrane electrode assembly on a bottom surface of another concavity.

The invention provides a fuel cell casing comprising:

a base body made of ceramics that has a plurality of concavities formed on one surface thereof, for accommodating therein a membrane electrode assembly, the membrane electrode assembly having a first electrode and a second electrode which are formed on one principal surface and another principal surface thereof, respectively;

a first fluid channel formed so as to extend from a bottom surface of the concavity facing one principal surface of the membrane electrode assembly to an outer surface of the base body;

a first wiring conductor having its one end disposed on the bottom surface of the concavity facing the first electrode of the membrane electrode assembly, and its another end led to the outer surface of the base body;

a lid body mounted on one surface of the base body near the concavity so as to cover the concavity, for sealing the concavity hermetically;

a second fluid channel formed so as to extend from one surface of the lid body facing the other principal surface of the membrane electrode assembly to an outer surface of the lid body;

a second wiring conductor having its one end disposed on one surface of the lid body facing the second electrode of the membrane electrode assembly, and its another end led to the outer surface of the lid body;

a fourth wiring conductor having its one end opposed to the first electrode of the membrane electrode assembly on a bottom surface of one concavity, and its another end led to the other surface of the base body on which the lid body is mounted; and

a fifth wiring conductor having its one end opposed to the second electrode of another membrane electrode assembly of the concavity on one surface of the lid body, and its another end led to one surface of the lid body to be mounted on one surface of the base body, so as to face the other end of the fourth wiring conductor.

According to the invention, the fuel cell casing is composed of: the base body made of ceramics having the concavity for housing the membrane electrode assembly formed on one surface thereof, the membrane electrode assembly having the first and second electrodes disposed on one and the other principal surfaces thereof, respectively; and the lid body to be mounted on one surface of the base body near the concavity so as to cover the concavity, for air-tightly sealing the concavity. With this construction, by air-tightly sealing the fuel cell casing, leakage of fluid such as gas can be prevented. Moreover, since there is no need to prepare an extra package in addition to the casing, the fuel cell can be operated with high efficiency, and also miniaturization can be achieved. Further, the fuel cell is constructed by housing a plurality of membrane electrode assemblies in the casing composed of the ceramic-made base body having the concavity formed on its top surface and the lid body for sealing the concavity. Hence, it never occurs that the membrane electrode assembly is exposed outside, and therefore the membrane electrode assembly can be protected against damage, with the result that the mechanical reliability of the fuel cell as a whole can be enhanced. Besides, the first to third wiring conductors (or the first, second, fourth, and fifth wiring conductors), each of which has its one end disposed within the casing composed of the concavity and the lid body, are the only components that make electrical contact with the membrane electrode assembly. This frees the membrane electrode assembly itself from unnecessary electrical connection, whereby making it possible to obtain a fuel cell which is excellent in reliability and safety. In addition, by using ceramics as a material for constituting the fuel cell casing, the fuel cell can be made highly resistant to corrosion by fluid, typified by various gaseous materials.

Moreover, the first and second fluid channels are provided. The first fluid channel is so formed as to extend from the bottom surface of the concavity facing one principal surface of the membrane electrode assembly to the outer surface of the base body, whereas the second fluid channel is so formed as to extend from one surface of the lid body facing the other principal surface of the membrane electrode assembly to the outer surface of the lid body. In this construction, since a plurality of fluid channels are individually formed on their corresponding inner wall surfaces of the casing so as to have sandwiched therebetween the membrane electrode assembly, it is possible to enhance the uniform supply of the fluid to be supplied to the membrane electrode assembly. By constituting such fluid paths, a fluid material is allowed to flow perpendicularly to the membrane electrode assembly. Thus, for example, in the case of supplying hydrogen gas and air (oxygen) gas as a fluid material, it is possible to prevent a decrease in the partial pressure of the gas supplied to the first and second electrodes that are disposed on one and the other principal surfaces, respectively, of the membrane electrode assembly, and thereby obtain a predetermined stable output voltage. Further, since the pressure of the fluid supplied, for example, the partial pressure of the gas is stabilized, the temperature distribution as observed within the fuel cell casing is made uniform. As a result, a thermal stress occurring in the membrane electrode assembly can be suppressed, leading to enhancement of the reliability of the fuel cell. In addition, since the fluid channels are individually formed in the base body and the lid body, each of the fluid channels is excellent in hermeticity. This makes it possible to prevent mixing of two different fluid materials (for example, oxygen gas and hydrogen gas or methanol) that must be basically separated by the fluid channels, and therefore it never occurs that the fuel cell fails to function properly and that flammable fluid materials are ignited and exploded through mixture at a high temperature. As a result, the safety of the fuel cell can be assured.

Moreover, according to the invention, the third wiring conductor is formed in the base body. The third wiring conductor has its one end opposed to the first electrode of the membrane electrode assembly on the bottom surface of one concavity, and its other end opposed to the first electrode of the membrane electrode assembly on the other bottom surface of the concavity. In this construction, a plurality of membrane electrode assemblies can be connected in parallel with one another through electrical connection. This makes it possible to properly adjust the output current in the entire fuel cell, and thereby externally extract electricity in good condition that has been electrochemically produced in the membrane electrode assembly.

Further, according to the invention, the fourth and fifth wiring conductors are respectively formed in the base body having the plurality of concavities for accommodating the membrane electrode assembly and the lid body to be mounted in the base body. The fourth wiring conductor has its one end opposed to the first electrode of the membrane electrode assembly on the bottom surface of one concavity, and its other end led to one surface of the base body on which the lid body is mounted. The fifth wiring conductor has its one end opposed to the second electrode of the other membrane electrode assembly of the concavity on one surface of the lid body, and its other end led to one surface of the lid body which is mounted on one surface of the base body, so as to face the other end of the fourth wiring conductor. In this construction, a plurality of membrane electrode assemblies can be connected in series with one another through electrical connection. As a result, although only a little voltage is obtained through electricity production achieved by a single membrane electrode assembly, by connecting together a plurality of membrane electrode assemblies in series, adjustment can be made to a total voltage. This makes it possible to externally extract electricity in good condition that has been electrochemically produced in the membrane electrode assembly.

The invention provides a fuel cell comprising:

a plurality of membrane electrode assemblies, each having a first electrode and a second electrode which are formed on one principal surface and another principal surface thereof, respectively; and

the fuel cell casing mentioned above,

wherein the membrane electrode assembly is housed in the plurality of concavities of the fuel cell casing, respectively, one and the other principal surfaces of the membrane electrode assembly are arranged such that fluid can be exchanged between one and the other principal surfaces and their corresponding first and second fluid channels, the first and second wiring conductors are electrically connected to the first and second electrodes, respectively, the third wiring conductor is electrically connected to the first electrode, and the lid body is mounted on one surface of the base body near the concavity so as to cover the concavity.

The invention provides a fuel cell comprising:

a plurality of membrane electrode assemblies, each having a first electrode and a second electrode which are formed on one principal surface and another principal surface thereof, respectively; and

the fuel cell casing mentioned above,

wherein the membrane electrode assembly is housed in the plurality of concavities of the fuel cell casing, respectively, one and the other principal surfaces of the membrane electrode assembly are arranged such that fluid can be exchanged between one and the other principal surfaces and their corresponding first and second fluid channels, the first and second wiring conductors are electrically connected to the first and second electrodes, respectively, the fourth and fifth wiring conductors are electrically connected to the first and second electrodes, respectively, the other end of the fourth wiring conductor is connected to the other end of the fifth wiring conductor, and the lid body is mounted on one surface of the base body near the concavity so as to cover the concavity.

According to the invention, the fuel cell is constructed by housing the membrane electrode assembly in the concavity of the fuel cell casing; followed by arranging one and the other principal surfaces of the membrane electrode assembly such that fluid can be exchanged between them and the first and second fluid channels; followed by electrically connecting the first and second electrodes individually to the first to third wiring conductors, or the first, second, fourth, and fifth wiring conductors; and followed by mounting the lid body on one surface of the base body near the concavity so as to cover the concavity. With this construction, it is possible to provide a compact, sturdy, and highly-reliable fuel cell that allows even gas supply, uniformization of temperature gradients within the fuel cell casing, and highly-efficient electrical connection by exploiting the features of the fuel cell casing embodying the invention. Moreover, by connecting together a plurality of membrane electrode assemblies in parallel, adjustment can be made to the output current of the entire fuel cell, or, by connecting together a plurality of membrane electrode assemblies in series, adjustment can be made to a total voltage. This makes it possible to externally extract electricity in good condition that has been electrochemically produced in the membrane electrode assembly.

According to the invention, by constructing the fuel cell in the way as stated above, the membrane electrode assembly can be prevented from being exposed outside and suffering from damage. Besides, the first to third wiring conductors (or the first, second, fourth, and fifth wiring conductors), each of which has its one end disposed within the casing composed of the concavity and the lid body, are the only components that make electrical contact with the membrane electrode assembly. This frees the membrane electrode assembly itself from unnecessary electrical connection, whereby making it possible to obtain a fuel cell which is excellent in reliability and safety. Further, the first and second fluid channels are individually formed on their corresponding inner wall surfaces of the casing, that is, formed on the concavity bottom surface of the base body and one surface of the lid body, respectively, so as to have sandwiched therebetween the membrane electrode assembly. With this arrangement, it is possible to enhance the uniform supply of the gas to be supplied to the membrane electrode assembly, and also to prevent a decrease in the partial pressure of the gas supplied to the first and second electrodes of the membrane electrode assembly. Thus, a predetermined stable output voltage can be attained. Further, a stress occurring in the membrane electrode assembly can be suppressed, leading to enhancement of the reliability of the fuel cell.

The invention provides a fuel cell casing comprising:

a base body made of ceramics that has a concavity formed on one surface thereof, for accommodating a plurality of membrane electrode assemblies, each membrane electrode assembly having a first electrode and a second electrode which are formed on one principal surface and another principal surface thereof, respectively;

a first fluid channel formed so as to extend from a bottom surface of the concavity facing one principal surface of the membrane electrode assembly to an outer surface of the base body;

a first wiring conductor having its one end disposed on the bottom surface of the concavity facing the first electrode of the membrane electrode assembly, and its another end led to the outer surface of the base body;

a lid body mounted on one surface of the base body near the concavity so as to cover the concavity, for sealing the concavity hermetically;

a second fluid channel formed so as to extend from one surface of the lid body facing the other principal surface of the membrane electrode assembly to an outer surface of the lid body;

a second wiring conductor having its one end disposed on one surface of the lid body facing the second electrode of the membrane electrode assembly, and its other end led to the outer surface of the lid body; and

a third wiring conductor formed in the base body, the third wiring conductor having its one end opposed to the first electrode of one membrane electrode assembly on the bottom surface of the concavity, and its another end opposed to the first electrode of another membrane electrode assembly on the bottom surface of the concavity.

The invention provides a fuel cell casing comprising:

a base body made of ceramics that has a concavity formed on one surface thereof, for accommodating a plurality of membrane electrode assemblies, each membrane electrode assembly having a first electrode and a second electrode which are formed on one principal surface and another principal surface thereof, respectively;

a first fluid channel formed so as to extend from a bottom surface of the concavity facing one principal surface of the membrane electrode assembly to an outer surface of the base body;

a first wiring conductor having its one end disposed on the bottom surface of the concavity facing the first electrode of the membrane electrode assembly, and its another end led to the outer surface of the base body;

a lid body mounted on one surface of the base body near the concavity so as to cover the concavity, for sealing the concavity hermetically;

a second fluid channel formed so as to extend from one surface of the lid body facing the other principal surface of the membrane electrode assembly to an outer surface of the lid body;

a second wiring conductor having its one end disposed on one surface of the lid body facing the second electrode of the membrane electrode assembly, and its another end led to the outer surface of the lid body;

a fourth wiring conductor having its one end opposed to the first electrode of one membrane electrode assembly on the bottom surface of the concavity, and its another end led to one surface of the base body on which the lid body is mounted; and

a fifth wiring conductor having its one end opposed to the second electrode of another membrane electrode assembly on one surface of the lid body, and its another end led to one surface of the lid body to be mounted on one surface of the base body, so as to face the other end of the fourth wiring conductor.

According to the invention, the fuel cell casing is composed of: the base body made of ceramics having the concavity formed on one surface thereof, for housing a plurality of membrane electrode assemblies, each membrane electrode assembly having the first and second electrodes disposed on one and the other principal surfaces thereof, respectively; and the lid body to be mounted on one surface of the base body near the concavity so as to cover the concavity, for air-tightly sealing the concavity. In this construction, by air-tightly sealing the fuel cell casing, leakage of a fluid material such as gas can be prevented. Moreover, since there is no need to prepare an extra package in addition to the casing, the fuel cell can be operated with high efficiency, and also miniaturization can be achieved. Further, the fuel cell is constructed by housing a plurality of membrane electrode assemblies in the casing composed of the ceramic-made base body having the concavity formed on its one surface and the lid body for sealing the concavity. Hence, it never occurs that the membrane electrode assembly is exposed outside, and therefore the membrane electrode assembly can be protected against damage, with the result that the mechanical reliability of the fuel cell as a whole can be enhanced. Besides, the first to third wiring conductors (or the first, second, fourth, and fifth wiring conductors), each of which has its one end disposed within the casing composed of the concavity and the lid body, are the only components that make electrical contact with the membrane electrode assembly. This frees the membrane electrode assembly itself from unnecessary electrical connection, whereby making it possible to obtain a fuel cell which is excellent in reliability and safety. In addition, by using ceramics as a material for constituting the fuel cell casing, the fuel cell can be made highly resistant to corrosion by fluid, typified by various gaseous materials.

Moreover, the first and second fluid channels are provided. The first fluid channel is so formed as to extend from the bottom surface of the concavity facing one principal surface of the membrane electrode assembly to the outer surface of the base body, whereas the second fluid channel is so formed as to extend from one surface of the lid body facing the other principal surface of the membrane electrode assembly to the outer surface of the lid body. In this construction, since a plurality of fluid channels are individually formed on their corresponding inner wall surfaces of the casing so as to have sandwiched therebetween the membrane electrode assembly, it is possible to enhance the uniform supply of the fluid to be supplied to the membrane electrode assembly. By constituting such fluid paths, a fluid material is allowed to flow perpendicularly to the membrane electrode assembly. Thus, for example, in the case of supplying hydrogen gas and air (oxygen) gas as a fluid material, it is possible to prevent a decrease in the partial pressure of the gas supplied to the first and second electrodes that are disposed on the lower and upper principal surfaces, respectively, of the membrane electrode assembly, and thereby obtain a predetermined stable output voltage. Further, since the pressure of the fluid supplied, for example, the partial pressure of the gas is stabilized, the temperature distribution as observed within the fuel cell casing is made uniform. As a result, a thermal stress occurring in the membrane electrode assembly can be suppressed, leading to enhancement of the reliability of the fuel cell. In addition, since the fluid channels are individually formed in the base body and the lid body, each of the fluid channels is excellent in hermeticity. This makes it possible to prevent mixing of two different fluid materials (for example, oxygen gas and hydrogen gas or methanol) that must be basically separated by the fluid channels, and therefore it never occurs that the fuel cell fails to function properly and that flammable fluid materials are ignited and exploded through mixture at a high temperature. As a result, the safety of the fuel cell can be assured.

Moreover, according to the invention, the third wiring conductor is formed in the base body. The third wiring conductor has its one end opposed to the first electrode of one membrane electrode assembly on the bottom surface of the concavity, and its other end opposed to the first electrode of the other membrane electrode assembly on the bottom surface of the concavity. In this construction, a plurality of membrane electrode assemblies can be connected in parallel with one another through electrical connection. This makes it possible to properly adjust the output current in the entire fuel cell, and thereby externally extract electricity in good condition that has been electrochemically produced in the membrane electrode assembly.

Further, according to the invention, the fourth and fifth wiring conductors are respectively formed in the base body having a concavity for accommodating a plurality of membrane electrode assemblies and the lid body to be mounted in the base body. The fourth wiring conductor has its one end opposed to the first electrode of one membrane electrode assembly on the bottom surface of the concavity, and its other end led to one surface of the base body on which the lid body is mounted. The fifth wiring conductor has its one end opposed to the second electrode of the other membrane electrode assembly on one surface of the lid body, and its other end led to one surface of the lid body which is mounted on one surface of the base body, so as to face the other end of the fourth wiring conductor. In this construction, a plurality of membrane electrode assemblies can be connected in series with one another through electrical connection. As a result, although only a little voltage is obtained through electricity production achieved by a single membrane electrode assembly, by connecting together a plurality of membrane electrode assemblies in series, adjustment can be made to a total voltage. This makes it possible to externally extract electricity in good condition that has been electrochemically produced in the membrane electrode assembly.

The invention provides a fuel cell comprising:

a plurality of membrane electrode assemblies, each having a first electrode and a second electrode which are formed on one principal surface and another principal surface thereof, respectively; and

the fuel cell casing mentioned above,

wherein the plurality of membrane electrode assemblies are housed in the concavity of the fuel cell casing, one and the other principal surfaces of the membrane electrode assembly are arranged such that fluid can be exchanged between one and the other principal surfaces and their corresponding first and second fluid channels, the first and second wiring conductors are electrically connected to the first and second electrodes, respectively, the third wiring conductor is electrically connected to the first electrode, and the lid body is mounted on one surface of the base body near the concavity so as to cover the concavity.

The invention provides a fuel cell comprising:

a plurality of membrane electrode assemblies, each having a first electrode and a second electrode which are formed on one principal surface and another principal surface thereof, respectively; and

the fuel cell casing mentioned above,

wherein the plurality of membrane electrode assemblies are housed in the concavity of the fuel cell casing, one and the other principal surfaces of the membrane electrode assembly are arranged such that fluid can be exchanged between one and the other principal surfaces and their corresponding first and second fluid channels, the first and second wiring conductors are electrically connected to the first and second electrodes, respectively, the fourth and fifth wiring conductors are electrically connected to the first and second electrodes, respectively, the other end of the fourth wiring conductor is connected to the other end of the fifth wiring conductor, and the lid body is mounted on one surface of the base body near the concavity so as to cover the concavity.

According to the invention, the fuel cell is constructed by housing the membrane electrode assembly in the concavity of the fuel cell casing; followed by arranging one and the other principal surfaces of the membrane electrode assembly such that fluid can be exchanged between them and the first and second fluid channels; followed by electrically connecting the first and second electrodes individually to the first to third wiring conductors, or the first, second, fourth, and fifth wiring conductors; and followed by mounting the lid body on one surface of the base body near the concavity so as to cover the concavity. With this construction, it is possible to provide a compact, sturdy, and highly-reliable fuel cell that allows even gas supply, uniformization of temperature gradients within the fuel cell casing, and highly-efficient electrical connection by exploiting the features of the fuel cell casing embodying the invention. Moreover, by connecting together a plurality of membrane electrode assemblies in parallel, adjustment can be made to the output current of the entire fuel cell, or, by connecting together a plurality of membrane electrode assemblies in series, adjustment can be made to a total voltage. This makes it possible to externally extract electricity in good condition that has been electrochemically produced in the membrane electrode assembly.

According to the invention, by constructing the fuel cell in the way as stated above, the membrane electrode assembly can be prevented from being exposed outside and suffering from damage. Besides, the first to third wiring conductors (or the first, second, fourth, and fifth wiring conductors), each of which has its one end disposed within the casing composed of the concavity and the lid body, are the only components that make electrical contact with the membrane electrode assembly. This frees the membrane electrode assembly itself from unnecessary electrical connection, whereby making it possible to obtain a fuel cell which is excellent in reliability and safety. Further, the first and second fluid channels are individually formed on their corresponding inner wall surfaces of the casing, that is, formed on the concavly bottom surface of the base body and one surface of the lid body, respectively, so as to have sandwiched therebetween the membrane electrode assembly. With this arrangement, it is possible to enhance the uniform supply of the gas to be supplied to the membrane electrode assembly, and also to prevent a decrease in the partial pressure of the gas supplied to the first and second electrodes of the membrane electrode assembly. Thus, a predetermined stable output voltage can be attained. Further, a stress occurring in the membrane electrode assembly can be suppressed, leading to enhancement of the reliability of the fuel cell.

The invention provides an electronic apparatus comprising:

the fuel cell mentioned above, as a power source,

wherein the base body is made of multi-layer ceramics, and an external connection terminal is formed in at least one of the base body and the lid body.

According to the invention, the electronic apparatus includes: the membrane electrode assembly having the first and second electrodes disposed on one and the other principal surfaces thereof, respectively; the base body made of multi-layer ceramics having the concavity formed on one surface thereof, for housing the membrane electrode assembly; and the lid body to be mounted on the top surface of the base body near the concavity so as to cover the concavity, for air-tightly sealing the concavity. In this construction, by air-tightly sealing the fuel cell casing, leakage of a fluid material such as gas can be prevented. Moreover, since there is no need to prepare an extra package in addition to the casing, it is possible to realize a high-performance, stably-operable electronic apparatus that can be efficiently operated with safety. Moreover, compactness and lower profile can be achieved in the electronic apparatus.

The fuel cell is constructed by housing a plurality of membrane electrode assemblies in the casing composed of the base body made of multi-layer ceramics having the concavity formed on its one surface and the lid body for sealing the concavity. Hence, the membrane electrode assembly can be prevented from being exposed outside and suffering from damage, with the result that the mechanical reliability of the fuel cell as a whole can be enhanced.

The first and second wiring conductors, each of which has its one end disposed within the casing composed of the concavity and the lid body, are the only components that make electrical contact with the membrane electrode assembly. This frees the membrane electrode assembly itself from unnecessary electrical connection, whereby making it possible to obtain a fuel cell which is excellent in reliability and safety. As a result, there is provided an electronic apparatus which offers long-term reliability and high degree of safety.

In the above-described fuel cell, the external connection terminal (the terminal with positive and negative polarities) is provided in at least one of the base body and the lid body. This allows the fuel cell to be electrically connected to the circuit board of the electronic apparatus with ease, and also makes the fuel cell detachable and attachable freely. As a result, the fuel cell can be easily replaced with a new one without using a facility having specially-designed safety equipment, etc., resulting in an advantage in enhancing the convenience of the electronic apparatus.

Moreover, by using multi-layer ceramics as a material for constituting the fuel cell casing, it is possible to use various gaseous and fluid materials with no consideration given to corrosivity. This helps facilitate improvement in the power-supply efficiency. Another advantage is that a wiring conductor can be arbitrarily formed in each of the ceramic layers constituting the multi-layer ceramics by a conventionally-known metallization method. This allows free electrical wiring in the fuel cell, and thereby a plurality of cells can be readily connected in series or parallel with one another. As a result, dramatic improvement can be achieved for the electronic apparatus in terms of miniaturization, low-profile styling, and weight reduction. That is, according to the invention, the third wiring conductor is formed in the base body. The third wiring conductor has its one end opposed to the first electrode of the membrane electrode assembly on the bottom surface of one concavity, and its other end opposed to the first electrode of the membrane electrode assembly on the bottom surface of the other concavity. In this construction, a plurality of membrane electrode assemblies can be connected in parallel with one another through electrical connection. This makes it possible to properly adjust the output current in the entire fuel cell, and thereby externally extract electricity in good condition that has been electrochemically produced in the membrane electrode assembly.

According to the invention, the fourth and fifth wiring conductors are provided. The fourth wiring conductor, which is formed in the base body, has its one end opposed to the first electrode of the membrane electrode assembly on the bottom surface of one concavity, and its other end led to one surface of the base body on which the lid body is mounted. The fifth wiring conductor has its one end opposed to the second electrode of the other membrane electrode assembly of the concavity on one surface of the lid body, and its other end led to one surface of the lid body which is mounted on one surface of the base body, so as to face the other end of the fourth wiring conductor. In this construction, a plurality of membrane electrode assemblies can be connected in series with one another through electrical connection. As a result, although only a little voltage is obtained through electricity production achieved by a single membrane electrode assembly, by connecting together a plurality of membrane electrode assemblies in series, adjustment can be made to a total voltage. This makes it possible to externally extract electricity in good condition that has been electrochemically produced in the membrane electrode assembly.

According to the invention, the third wiring conductor is formed in the base body. The third wiring conductor has its one end opposed to the first electrode of one membrane electrode assembly on the bottom surface of the concavity, and its other end opposed to the first electrode of the other membrane electrode assembly on the bottom surface of the concavity. In this construction, a plurality of membrane electrode assemblies can be connected in parallel with one another through electrical connection. This makes it possible to properly adjust the output current in the entire fuel cell, and thereby externally extract electricity in good condition that has been electrochemically produced in the membrane electrode assembly.

According to the invention, the fourth and fifth wiring conductors are provided in the fuel cell. The fourth wiring conductor, which is formed in the base body, has its one end opposed to the first electrode of one membrane electrode assembly on the bottom surface of the concavity, and its other end led to one surface of the base body on which the lid body is mounted. The fifth wiring conductor has its one end opposed to the second electrode of the other membrane electrode assembly on one surface of the lid body, and its other end led to one surface of the lid body which is mounted on one surface of the base body, so as to face the other end of the fourth wiring conductor. In the fuel cell, a plurality of membrane electrode assemblies can be connected in series with one another through electrical connection. As a result, although only a little voltage is obtained through electricity production achieved by a single membrane electrode assembly, by connecting together a plurality of membrane electrode assemblies in series, adjustment can be made to a total voltage. This makes it possible to externally extract electricity in good condition that has been electrochemically produced in the membrane electrode assembly. By employing such a fuel cell, it is possible to realize an electronic apparatus which lends long-term voltage stability and excellent reliability.

Moreover, the first and second fluid channels are provided in the fuel cell. The first fluid channel is so formed as to extend from the bottom surface of the concavity facing one principal surface of the membrane electrode assembly to the outer surface of the base body, whereas the second fluid channel is so formed as to extend from one surface of the lid body facing the other principal surface of the membrane electrode assembly to the outer surface of the lid body. In the fuel cell, since a plurality of fluid channels are individually formed on their corresponding inner wall surfaces of the casing so as to have sandwiched therebetween the membrane electrode assembly, it is possible to enhance the uniform supply of the fluid to be supplied to the membrane electrode assembly. By constituting such fluid paths, a fluid material is allowed to flow perpendicularly to the membrane electrode assembly. Thus, for example, in the case of supplying hydrogen gas and air (oxygen) gas as a fluid material, it is possible to prevent a decrease in the partial pressure of the gas supplied to the first and second electrodes that are disposed on the lower and upper principal surfaces, respectively, of the membrane electrode assembly, and thereby obtain a predetermined stable output voltage.

Further, since the pressure of the fluid supplied, for example, the partial pressure of the gas is stabilized, the temperature distribution as observed within the fuel cell casing is made uniform. This helps suppress a thermal stress occurring in the membrane electrode assembly, leading to enhancement of the reliability of the fuel cell. As a result, an electronic apparatus can be provided that is excellent in reliability.

In addition, since the fluid channels are individually formed in the base body and the lid body, each of the fluid channels is excellent in hermeticity. This makes it possible to prevent mixing of two different fluid materials (for example, oxygen gas and hydrogen gas or methanol) that must be basically separated by the fluid channels, and therefore it never occurs that the fuel cell fails to function properly and that flammable fluid materials are ignited and exploded through mixture at a high temperature. As a result, an electronic apparatus can be provided that is excellent in safety.

According to the invention, the fuel cell is constructed by housing the membrane electrode assembly in the concavity of the fuel cell casing; followed by arranging one and the other principal surfaces of the membrane electrode assembly such that fluid can be exchanged between them and the first and second fluid channels; followed by electrically connecting the first and second electrodes individually to the first and second wiring conductors, or the first to third wiring conductors, or the first, second, fourth, and fifth wiring conductors; followed by electrically connecting the first and second electrodes to the external connection terminal; and followed by mounting the lid body on one surface of the base body near the concavity so as to cover the concavity. With this construction, it is possible to realize a compact, sturdy, and highly-reliable fuel cell that allows even fuel supply and highly-efficient electrical connection by exploiting the features of the fuel cell casing embodying the invention. By employing such a fuel cell, the electronic apparatus can be made lower in profile, but higher in performance and efficiency.

According to the invention, since the base body is made of multi-layer ceramics, a metal layer can be formed, as by a metallization method, on the surface of the internally-located ceramic layer in various configurations with various electrical characteristics. This makes it possible to form within the base body an electronic circuit component acting as resistance, capacitance, inductance, etc. Hence, for example, by forming a large-capacitance capacitor alongside the fuel cell, when the current fed from the fuel cell is in short supply, the shortage of the current can be compensated for successfully; wherefore the desired current supply appropriate to the target output current can be secured. Moreover, since a voltage-boosting circuit can be formed, a voltage necessary for the electronic apparatus can be secured.

In the invention, it is preferable that at least one of the first and second wiring conductors is formed around the opening of the first fluid channel disposed on the bottom surface of the concavity, or around the opening of the second fluid channel disposed on one surface of the lid body, so as to abut against the first or second electrode.

According to the invention, at least one of the first and second wiring conductors is formed around the opening of the first fluid channel disposed on the bottom surface of the concavity, or around the opening of the second fluid channel disposed on one surface of the lid body, so as to abut against the first or second electrode. With this construction, the first or second wiring conductor can be in immediate electric contact with the entire area of the first or second electrode of the membrane electrode assembly, with the exception of the area corresponding to the opening of the first or second fluid channel. This makes it possible to increase the contact area between the first electrode of the membrane electrode assembly and the first wiring conductor, as well as the contact area between the second electrode and the second wiring conductor, and also to establish direct connection therebetween. As a result, an undesirable increase in electrical resistance and occurrence of improper contact can be effectively prevented, thus achieving an electronic apparatus that succeeds in providing high electricity-production efficiency.

The invention provides a fuel cell casing comprising:

a base body made of ceramics that has a first concavity and a second concavity formed on its one principal surface side and another principal surface side, respectively, for accommodating therein a membrane electrode assembly, the membrane electrode assembly having a first electrode and a second electrode which are formed on one principal surface and the other principal surfaces thereof, respectively;

a first fluid channel formed within the base body so as to extend from a region between the first and second concavities to a bottom surface of each of the concavities;

a first wiring conductor having its one end disposed on the bottom surface of the first/second concavity so as to face the first electrode of the membrane electrode assembly, and its another end led to the outer surface of the base body;

a first lid body mounted on one principal surface of the base body near the first concavity so as to cover the first concavity, for sealing the first concavity hermetically;

a second lid body mounted on another principal surface of the base body near the second concavity so as to cover the second concavity, for sealing the second concavity hermetically;

a second fluid channel formed so as to extend from a first/second concavity-side principal surface of the first/second lid body, facing the second electrode of the membrane electrode assembly, to an outer surface of the lid body; and

a second wiring conductor having its one end disposed on the first/second concavity-side principal surface of the first/second lid body facing the second electrode of the membrane electrode assembly, and its other end led to the outer surface of the lid body.

According to the invention, the fuel cell casing is composed of: the membrane electrode assembly having the first and second electrodes formed on its one and the other principal surfaces, respectively; the ceramic-made base body having the first and second concavities formed on its one and the other principal surfaces, respectively, for accommodating therein the membrane electrode assembly; the first lid body mounted on one principal surface of the base body near the first concavity so as to cover the first concavity, for sealing the first concavity hermetically; and the second lid body mounted on the other principal surface of the base body near the second concavity so as to cover the second concavity, for sealing the second concavity hermetically. In this construction, by air-tightly sealing the fuel cell casing, leakage of a fluid material such as gas can be prevented. Since there is no need to prepare an extra package in addition to the casing, the fuel cell can be operated with high efficiency, and also miniaturization can be achieved. Here, the base body takes on a double-layer structure in which the first and second concavities for housing the membrane electrode assembly are respectively formed on the opposite principal surfaces of the base body. This structure eliminates the need to arrange the membrane electrode assemblies side by side, thus achieving space saving. Moreover, the fuel cell is constructed by housing the membrane electrode assembly in the casing composed of the ceramic-made base body having the first and second concavities respectively formed on its one and the other principal surfaces and the first and second lid-bodies for sealing the first and second concavities, respectively. Hence, it never occurs that the membrane electrode assembly is exposed outside, and therefore the membrane electrode assembly can be protected against damage. As a result, the mechanical reliability of the fuel cell as a whole can be enhanced. Besides, the first and second wiring conductors, each of which has its one end disposed within the casing composed of the first and second concavities and the first and second lid bodies, are the only components that make electrical contact with the membrane electrode assembly. This frees the membrane electrode assembly itself from unnecessary electrical connection, whereby making it possible to obtain a fuel cell which is excellent in reliability and safety. In addition, by using ceramics as a material for constituting the fuel cell casing, the fuel cell can be made highly resistant to corrosion by fluid, typified by various gaseous materials.

Moreover, the first and second fluid channels are provided. The first fluid channel is formed within the base body so as to extend from the region between the first and second concavities to the bottom surface of each of the concavities, whereas the second fluid channel is formed so as to extend from the first/second concavity-side principal surface of the first/second lid body, facing the second electrode of the membrane electrode assembly, to the outer surface of the lid body. In this construction, since the individual fluid channels are respectively formed on their corresponding inner wall surfaces of the casing so as to have sandwiched therebetween the membrane electrode assembly, it is possible to enhance the uniform supply of the fluid to be supplied to the membrane electrode assembly. By constituting such fluid paths, a fluid material is allowed to flow perpendicularly to the membrane electrode assembly. Thus, for example, in the case of supplying hydrogen gas and air (oxygen) gas as a fluid material, it is possible to prevent a decrease in the partial pressure of the gas supplied to the first and second electrodes that are disposed on one and the other principal surfaces, respectively, of the membrane electrode assembly, and thereby obtain a predetermined stable output voltage. Moreover, since the pressure of the fluid supplied, for example, the partial pressure of the gas is stabilized, the temperature distribution as observed within the fuel cell casing is made uniform. This helps suppress a thermal stress occurring in the membrane electrode assembly, leading to enhancement of the reliability of the fuel cell. Hence, the fluid supplied can be stabilized in pressure. Further, on the opposite principal surfaces of the base body are respectively formed the first and second concavities for housing the membrane electrode assembly, and the first and second fluid channels are respectively formed in the first and second lid bodies that are mounted for covering the concavities. This structure allows enhancement of the volume output density in the down-sized, compact fuel cell in which the effective usable area rate of the membrane electrode assembly is increased. In addition, since the first and second fluid channels are individually formed in the base body and the lid body, each of the fluid channels is excellent in hermeticity. This makes it possible to prevent mixing of two different fluid materials (for example, oxygen gas and hydrogen gas or methanol) that must be basically separated by the fluid channels, and therefore it never occurs that the fuel cell fails to function properly and that flammable fluid materials are ignited and exploded through mixture at a high temperature. As a result, a fuel cell can be provided that is excellent in safety.

According to the invention, the individual first wiring conductors are electrically connected together at their other ends. Thereby, a plurality of membrane electrode assemblies can be connected in parallel with one another through electrical connection, with the distance between the adjacent membrane electrode assemblies kept short. Moreover, the connection can be established through low-resistance wiring. As a result, the output current in the entire fuel cell can be properly adjusted, thus achieving a fuel cell having a planer stack structure with which electricity that has been electrochemically produced in the membrane electrode assembly can be externally extracted in good condition.

According to the invention, the first and second wiring conductors are electrically connected together at their other ends. Thereby, a plurality of membrane electrode assemblies can be connected in series with one another through electrical connection, with the distance between the adjacent membrane electrode assemblies kept short. Moreover, the connection can be established through low-resistance wiring. As a result, although only a little voltage is obtained through electricity production achieved by a single membrane electrode assembly, by connecting together a plurality of membrane electrode assemblies in series, adjustment can be made to a total voltage, thus achieving a fuel cell having a planer stack structure with which electricity that has been electrochemically produced in the membrane electrode assembly can be externally extracted in good condition.

Moreover, the base body takes on a double-layer structure. In this structure, the membrane electrode assembly is placed on each of the opposite principal surfaces, and the individual membrane electrode assemblies can be connected together by the first and second wiring conductors formed within the base body and the first and second lid bodies. This makes it possible to reduce the length in wiring and thereby reduce the resistance.

In the invention, it is preferable that the first fluid channel is arranged such that the openings on the bottom surfaces of the first and second concavities face each other.

According to the invention, the first fluid channel is arranged such that the openings on the bottom surfaces of the first and second concavities face each other. In this case, even if the first fluid channel is formed in plural over substantially the entire bottom surface of each of the first and second concavities, the individual first fluid channels can be readily connected together between the first and second concavities, thus requiring only one fuel supply inlet. This eliminates the need to provide a complicated fuel supply system, whereby making it possible to supply fuel to the membrane electrode assembly with ease and to achieve space saving.

The invention provides a fuel cell comprising:

a plurality of membrane electrode assemblies, each having a first electrode and a second electrode which are formed on one principal surface and the other principal surfaces thereof, respectively; and

the fuel cell casing mentioned above,

wherein the membrane electrode assembly is housed in the first and second concavities of the fuel cell casing, one and the other principal surfaces of the membrane electrode assembly are arranged such that fluid can be exchanged between one and the other principal surfaces and their corresponding first and second fluid channels, the first and second wiring conductors are electrically connected to the first and second electrodes, respectively, and the first/second lid body is mounted on the principal surface of the base body near the first/second concavity so as to cover the first/second concavity.

According to the invention, the fuel cell is constructed by housing the membrane electrode assembly in the first and second concavities of the fuel cell casing; followed by arranging one and the other principal surfaces of the membrane electrode assembly such that fluid can be exchanged between them and the first and second fluid channels; followed by electrically connecting the first and second wiring conductors to the first and second electrodes, respectively; and followed by mounting the first/second lid body on the principal surface of the base body near the first/second concavity so as to cover the first/second concavity. With this construction, it is possible to provide a compact, sturdy, and highly-reliable fuel cell that allows even gas supply, uniformization of temperature gradients within the fuel cell casing, and highly-efficient electrical connection by exploiting the features of the fuel cell casing embodying the invention. Moreover, by connecting together a plurality of membrane electrode assemblies in parallel, adjustment can be made to the output current of the entire fuel cell, or, by connecting together a plurality of membrane electrode assemblies in series, adjustment can be made to a total voltage. This makes it possible to externally extract electricity in good condition that has been electrochemically produced in the membrane electrode assembly.

The invention provides an electronic apparatus comprising:

the fuel cell mentioned above, as a power source,

wherein the base body is made of multi-layer ceramics, and an external connection terminal is formed in at least one of the base body, the first lid body, and the second lid body.

In the invention, it is preferable that, in the base body, a plurality of first and second concavities are formed, and a third wiring conductor is so formed as to have its one end opposed to the first electrode of the membrane electrode assembly on one bottom surface of the first/second concavity, and its other end opposed to the first electrode of the membrane electrode assembly on the other bottom surface of the first/second concavity.

In the invention, it is preferable that, in the base body, a plurality of first and second concavities are formed; a fourth wiring conductor is so formed as to have its one end opposed to the first electrode of the membrane electrode assembly on one bottom surface of the first/second concavity, and its other end led to the principal surface of the base body on which the first/second lid body is mounted; and a fifth wiring conductor is so formed as to have its one end opposed to the second electrode of the other membrane electrode assembly of the first/second concavity on the principal surface of the first/second lid body, and its other end led to the principal surface of the first/second lid body which is mounted on the principal surface of the base body, so as to face the other end of the fourth wiring conductor.

In the invention, it is preferable that, in the base body, a first concavity and a second concavity are formed for accommodating a plurality of membrane electrode assemblies, and a sixth wiring conductor is so formed as to have its one end opposed to the first electrode of one membrane electrode assembly on the bottom surface of the first/second concavity, and its other end opposed to the first electrode of another membrane electrode assembly on the bottom surface of the first/second concavity.

In the invention, it is preferable that, in the base body, a first concavity and a second concavity are formed for accommodating a plurality of membrane electrode assemblies; a seventh wiring conductor is so formed as to have its one end opposed to the first electrode of one membrane electrode assembly on the bottom surface of the first/second concavity, and its other end led to the principal surface of the base body on which the first/second lid body is mounted; and an eighth wiring conductor is so formed as to have its one end opposed to the second electrode of the other membrane electrode assembly on the principal surface of the first/second lid body, and its other end led to the principal surface of the lid body which is mounted on the principal surface of the base body, so as to face the other end of the seventh wiring conductor.

In the invention, it is preferable that the first fluid channel is arranged such that the openings on the bottom surfaces of the first and second concavities face each other.

In the invention, it is preferable that at least one of the first and second wiring conductors is formed around the opening of the first fluid channel disposed on the bottom surface of the first/second concavity, or around the opening of the second fluid channel disposed on the principal surface of the first/second lid body, so as to abut against the first or second electrode.

According to the invention, the electronic apparatus includes: the membrane electrode assembly having the first and second electrodes disposed on one and the other principal surfaces thereof, respectively; the base body made of multi-layer ceramics having the first and second concavities respectively formed on its one and the other principal surfaces, for housing the membrane electrode assembly; and the first/second lid body to be mounted on the principal surface of the base body near the first/second concavity so as to cover the first/second concavity, for air-tightly sealing the first/second concavity. In this construction, by air-tightly sealing the fuel cell casing, leakage of a fluid material such as gas can be prevented. Moreover, since there is no need to prepare an extra package in addition to the casing, it is possible to realize a high-performance, stably-operable electronic apparatus that can be operated with high efficiency. Moreover, compactness and lower profile can be achieved in the electronic apparatus.

Here, the base body takes on a double-layer structure in which the first and second concavities for housing a plurality of membrane electrode assemblies are respectively formed on the opposite principal surfaces of the base body. This structure allows space saving. Moreover, the fuel cell is constructed by housing a plurality of membrane electrode assemblies in the casing composed of the multilayer ceramic-made base body having the first and second concavities respectively formed on its one principal surface side and the other principal surface side, and the first and second lid bodies for sealing the first and second concavities, respectively. Hence, it never occurs that the membrane electrode assembly is exposed outside, and therefore the membrane electrode assembly can be protected against damage. As a result, the mechanical reliability of the fuel cell as a whole can be enhanced. Since there is no need to prepare an extra member for protecting the fuel cell, the electronic apparatus can be made smaller in size and lower in profile.

Besides, the first and second wiring conductors, each of which has its one end disposed within the casing composed of the first and second concavities and the first and second lid bodies, are the only components that make electrical contact with the membrane electrode assembly. This frees the membrane electrode assembly itself from unnecessary electrical connection, whereby making it possible to obtain a fuel cell which is excellent in reliability and safety. As a result, there is provided an electronic apparatus which offers long-term reliability and high degree of safety.

In the above-described fuel cell, the external connection terminal (the terminal with positive and negative polarities) is provided in at least one of the base body and the lid body. This allows the fuel cell to be electrically connected to the circuit board of the electronic apparatus with ease, and also makes the fuel cell detachable and attachable freely. As a result, the fuel cell can be easily replaced with a new one without using a facility having specially-designed safety equipment, etc., resulting in an advantage in enhancing the convenience of the electronic apparatus.

Moreover, by using multi-layer ceramics as a material for constituting the fuel cell casing, it is possible to use various gaseous and fluid materials with no consideration given to corrosivity. This helps facilitate improvement in the power-supply efficiency. Another advantage is that a wiring conductor can be arbitrarily formed in each of the ceramic layers constituting the multi-layer ceramics by a conventionally-known metallization method. This allows free electrical wiring in the fuel cell, and thereby a plurality of cells can be readily connected in series or parallel with one another. As a result, dramatic improvement can be achieved for the electronic apparatus in terms of miniaturization, low-profile styling, and weight reduction. That is, according to the invention, the third wiring conductor is formed in the base body. The third wiring conductor has its one end opposed to the first electrode of the membrane electrode assembly on one bottom surface of the first/second concavity, and its other end opposed to the first electrode of the membrane electrode assembly on the other bottom surface of the first/second concavity. In this construction, a plurality of membrane electrode assemblies can be connected in parallel with one another through electrical connection. This makes it possible to properly adjust the output current in the entire fuel cell, and thereby externally extract electricity in good condition that has been electrochemically produced in the membrane electrode assembly. By employing such a fuel cell, it is possible to realize an electronic apparatus which lends long-term voltage stability and excellent reliability.

According to the invention, the fourth and fifth wiring conductors are provided. The fourth wiring conductor, which is formed in the base body, has its one end opposed to the first electrode of the membrane electrode assembly on one bottom surface of the first/second concavity, and its other end led to the principal surface of the base body on which the lid body is mounted. The fifth wiring conductor has its one end opposed to the second electrode of the other membrane electrode assembly of the first/second concavity on the principal surface of the lid body, and its other end led to the principal surface of the lid body which is mounted on the principal surface of the base body, so as to face the other end of the fourth wiring conductor. In this construction, a plurality of membrane electrode assemblies can be connected in series with one another through electrical connection. As a result, although only a little voltage is obtained through electricity production achieved by a single membrane electrode assembly, by connecting together a plurality of membrane electrode assemblies in series, adjustment can be made to a total voltage. This makes it possible to externally extract electricity in good condition that has been electrochemically produced in the membrane electrode assembly. By employing such a fuel cell, it is possible to realize an electronic apparatus which lends long-term voltage stability and excellent reliability.

According to the invention, the sixth wiring conductor is formed in the base body. The sixth wiring conductor has its one end opposed to the first electrode of one membrane electrode assembly on the bottom surface of the first/second concavity, and its other end opposed to the first electrode of the other membrane electrode assembly on the bottom surface of the first/second concavity. In this construction, a plurality of membrane electrode assemblies can be connected in parallel with one another through electrical connection. This makes it possible to properly adjust the output current in the entire fuel cell, and thereby externally extract electricity in good condition that has been electrochemically produced in the membrane electrode assembly. By employing such a fuel cell, it is possible to realize an electronic apparatus which lends long-term voltage stability and excellent reliability.

According to the invention, the seventh and eighth wiring conductors are provided in the fuel cell. The seventh wiring conductor, which is formed in the base body, has its one end opposed to the first electrode of one membrane electrode assembly on the bottom surface of the first/second concavity, and its other end led to the principal surface of the base body on which the lid body is mounted. The eighth wiring conductor has its one end opposed to the second electrode of the other membrane electrode assembly on the principal surface of the lid body, and its other end led to the principal surface of the lid body which is mounted on the principal surface of the base body, so as to face the other end of the seventh wiring conductor. In the fuel cell, a plurality of membrane electrode assemblies can be connected in series with one another through electrical connection. As a result, although only a little voltage is obtained through electricity production achieved by a single membrane electrode assembly, by connecting together a plurality of membrane electrode assemblies in series, adjustment can be made to a total voltage. This makes it possible to externally extract electricity in good condition that has been electrochemically produced in the membrane electrode assembly. By employing such a fuel cell, it is possible to realize an electronic apparatus which lends long-term voltage stability and excellent reliability.

Moreover, the first and second fluid channels are provided in the fuel cell. The first fluid channel is formed within the base body so as to extend from the region between the first and second concavities to the bottom surface of each of the concavities, whereas the second fluid channel is formed so as to extend from the first/second concavity-side principal surface of the first/second lid body, facing the second electrode of the membrane electrode assembly, to the outer surface of the lid body. In this construction, since the individual fluid channels are respectively formed on their corresponding inner wall surfaces of the casing so as to have sandwiched therebetween the membrane electrode assembly, it is possible to enhance the uniform supply of the fluid to be supplied to the membrane electrode assembly. By constituting such fluid paths, a fluid material is allowed to flow perpendicularly to the membrane electrode assembly. Thus, for example, in the case of supplying hydrogen gas, or aqueous solution of methanol and air (oxygen) gas as a fluid material, it is possible to prevent a decrease in the partial pressure of the gas supplied to the first and second electrodes that are disposed on one and the other principal surfaces, respectively, of the membrane electrode assembly, and thereby obtain a predetermined stable output voltage.

Since the pressure of the fluid supplied, for example, the partial pressure of the gas is stabilized, the temperature distribution as observed within the fuel cell casing is made uniform. This helps suppress a thermal stress occurring in the membrane electrode assembly, leading to enhancement of the reliability of the fuel cell. As a result, an electronic apparatus can be provided that offers higher reliability.

On the opposite principal surfaces of the base body are respectively formed the first and second concavities for housing the membrane electrode assembly, and the first and second fluid channels are respectively formed in the first and second lid bodies that are mounted for covering the concavities. This structure allows enhancement of the volume output density in the fuel cell.

Since the fluid channels are individually formed in the base body and the lid body, each of the fluid channels is excellent in hermeticity. This makes it possible to prevent mixing of two different fluid materials (for example, oxygen gas and hydrogen gas or methanol) that must be basically separated by the fluid channels, and therefore it never occurs that the fuel cell fails to function properly and that flammable fluid materials are ignited and exploded through mixture at a high temperature. As a result, a fuel cell can be provided that is excellent in safety.

According to the invention, the individual first wiring conductors are electrically connected together at their other ends. Thereby, a plurality of membrane electrode assemblies can be connected in parallel with one another through electrical connection, with the distance between the adjacent membrane electrode assemblies kept short. Moreover, the connection can be established through low-resistance wiring. As a result, the output current in the entire fuel cell can be properly adjusted, thus achieving a fuel cell having a planer stack structure with which electricity that has been electrochemically produced in the membrane electrode assembly can be externally extracted in good condition.

According to the invention, the first and second wiring conductors are electrically connected together at their other ends. Thereby, a plurality of membrane electrode assemblies can be connected in series with one another through electrical connection, with the distance between the adjacent membrane electrode assemblies kept short. Moreover, the connection can be established through low-resistance wiring. As a result, although only a little voltage is obtained through electricity production achieved by a single membrane electrode assembly, by connecting together a plurality of membrane electrode assemblies in series, adjustment can be made to a total voltage, thus achieving a fuel cell having a planer stack structure with which electricity that has been electrochemically produced in the membrane electrode assembly can be externally extracted in good condition.

Moreover, the base body takes on a double-layer structure. In this structure, the membrane electrode assembly is placed on each of the opposite principal surfaces, and the individual membrane electrode assemblies can be connected together by the first and second wiring conductors formed within the base body and the first and second lid bodies. This makes it possible to reduce the length in wiring and thereby reduce the resistance.

According to the invention, the first fluid channel is arranged such that the openings on the bottom surfaces of the first and second concavities face each other. In this case, even if the first fluid channel is formed in plural over substantially the entire bottom surface of each of the first and second concavities, the individual first fluid channels can be readily connected together between the first and second concavities, thus requiring only one fuel supply inlet. This eliminates the need to provide a complicated fuel supply system, whereby making it possible to supply fuel to the membrane electrode assembly with ease and to achieve space saving.

According to the invention, the fuel cell is constructed by housing the membrane electrode assembly in each of the first and second concavities; followed by arranging one and the other principal surfaces of the membrane electrode assembly such that fluid can be exchanged between them and the first and second fluid channels; followed by electrically connecting the first and second wiring conductors to the first and second electrodes, respectively; followed by electrically connecting the first and second electrodes to the external connection terminal; and followed by mounting the first/second lid body on the principal surface of the base body near the first/second concavity so as to cover the first/second concavity. With this construction, it is possible to realize a compact, sturdy, and highly-reliable fuel cell that allows even fuel supply and highly-efficient electrical connection by exploiting the features of the fuel cell casing embodying the invention. By employing such a fuel cell, the electronic apparatus can be made lower in profile, but higher in performance and efficiency. Moreover, by connecting together a plurality of membrane electrode assemblies in parallel, adjustment can be made to the output current of the entire fuel cell, or, by connecting together a plurality of membrane electrode assemblies in series, adjustment can be made to a total voltage. This makes it possible to externally extract electricity in good condition that was been electrochemically produced in the membrane electrode assembly.

According to the invention, at least one of the first and second wiring conductors is formed around the opening of the first fluid channel disposed on the bottom surface of the first/second concavity, or around the opening of the second fluid channel disposed on the principal surface of the first/second lid body, so as to abut against the first or second electrode. With this construction, the first or second wiring conductor can be in immediate electric contact with the entire area of the first or second electrode of the membrane electrode assembly, with the exception of the area corresponding to the opening of the first or second fluid channel. This makes it possible to increase the contact area between the first electrode of the membrane electrode assembly and the first wiring conductor, as well as the contact area between the second electrode and the second wiring conductor, and also to establish direct connection therebetween. As a result, an undesirable increase in electrical resistance and occurrence of improper contact can be effectively prevented, thus achieving an electronic apparatus that succeeds in providing high electricity-production efficiency.

According to the invention, since the base body is made of multi-layer ceramics, a metal layer can be formed, as by a metallization method, on the surface of the internally-located ceramic layer in various configurations with various electrical characteristics. This makes it possible to form within the base body an electronic circuit component acting as resistance, capacitance, inductance, etc. Hence, for example, even if the current fed from the fuel cell is in short supply, by forming a large-capacitance capacitor alongside the fuel cell, the shortage of the current can be compensated for, whereby making it possible to secure the desired current supply appropriate to the target output current. Moreover, since a voltage-boosting circuit can be formed, a voltage necessary for the electronic apparatus can be secured.

In the invention, it is preferable that an internal circuit is formed in the base body.

According to the invention, the base body includes the internal circuit. Thus, an electronic component can be mounted on the surface of the base body so as to be electrically connected to the internal circuit. The electronic component mounted on the surface of the base body serves to improve the functionality of the electronic apparatus.

In the invention, it is preferable that the base body has an electronic component which is disposed on the surface thereof so as to be electrically connected to the internal circuit.

According to the invention, on the surface of the base body is disposed the electronic component so as to be electrically connected to the internal circuit. Thus, for example, with use of a sensor, control IC, etc., the concentration of the fuel flowing through the fluid channels can be detected by a concentration sensor, whereby making it possible to achieve optimum circulation of fuel and proper fuel dilution, and also to prevent a decrease in the fuel usability. Furthermore, it is possible that regulate a voltage required for electronic apparatus by forming a voltage-boosting circuit with electronic parts, and yet it is possible to control the temperature of the electrolyte material with a temperature sensor.

In the invention, it is preferable that a piezoelectric pump is disposed partway along one of the first and second fluid channels.

According to the invention, the piezoelectric pump is disposed partway along one of the first and second fluid channels. The compact piezoelectric pump disposed in the fluid channel acts to prevent backflow of fuel; wherefore unused fuel can be protected against contamination caused by reaction substance, etc. Moreover, since the residual air is discharged successfully, its adverse effect can be prevented on the operation of the electronic apparatus. Further, fuel is supplied uniformly and this makes stable electricity production possible, and besides fuel supply is carried out smoothly. This helps shorten the time required to activate the electronic apparatus. Thus, the electronic apparatus can be activated as soon as the fuel cell or fuel cartridge is replaced with a new one, or fuel is replenished. In terms of convenience, the electronic apparatus of the invention can stand comparison with a conventional electronic apparatus employing a chemical cell.

Hence, according to the invention, there are provided a fuel cell casing and a fuel cell that are excellent in compactness, convenience, and safety; that allows even fluid supply and highly-efficient electrical connection; and that can be operated with stability for a longer period of time.

Moreover, according to the invention, by employing the fuel cell which is excellent in compactness, convenience, and safety and allows even fluid supply and highly-efficient electrical connection, it is possible to realize a compact, low-profile electronic apparatus which can be operated with stability for a longer period of time and is excellent in safety and convenience.

### BRIEF DESCRIPTION OF THE DRAWINGS

Other and further objects, features, and advantages of the invention will be more explicit from the following detailed description taken with reference to the drawings wherein:

FIG. 1 is a sectional view showing a fuel cell casing and a fuel cell employing the same according to one embodiment of the invention;

FIG. 2 is a sectional view showing a fuel cell casing and a fuel cell employing the same according to another embodiment of the invention;

FIG. 3 is a sectional view showing a fuel cell casing and a fuel cell employing the same according to still another embodiment of the invention;

FIG. 4 is a sectional view showing a fuel cell casing and a fuel cell employing the same according to still another embodiment of the invention;

FIG. 5 is a plan view showing a fuel cell casing and a fuel cell employing the same according to still another embodiment of the invention showing in FIG. 4;

FIG. 6 is a sectional view showing a fuel cell casing and a fuel cell employing the same according to still another embodiment of the invention;

FIG. 7 is a sectional view showing a fuel cell casing and a fuel cell employing the same according to still another embodiment of the invention;

FIG. 8 is a sectional view showing one embodiment of the fuel cell which is incorporated in the electronic apparatus according to the invention;

FIG. 9 is a sectional view showing another embodiment of the fuel cell which is incorporated in the electronic apparatus according to the invention;

FIG. 10 is a sectional view showing still another embodiment of the fuel cell which is incorporated in the electronic apparatus according to the invention;

FIG. 11 is a sectional view showing still another embodiment of the fuel cell which is incorporated in the electronic apparatus according to the invention;

FIG. 12 is a sectional view showing still another embodiment of the fuel cell which is incorporated in the electronic apparatus according to the invention;

FIG. 13 is a block diagram showing the embodiment of the fuel cell;

FIG. 14 is a sectional view showing still another embodiment of the fuel cell which is incorporated in the electronic apparatus according to the invention;

FIG. 15 is a sectional view showing still another embodiment of the fuel cell which is incorporated in the electronic apparatus according to the invention;

FIG. 16 is a sectional view showing still another embodiment of the fuel cell which is incorporated in the electronic apparatus according to the invention;

FIG. 17 is a sectional view showing still another embodiment of the fuel cell which is incorporated in the electronic apparatus according to the invention;

FIG. 18 is a sectional view showing still another embodiment of the fuel cell which is incorporated in the electronic apparatus according to the invention;

FIG. 19 is a sectional view showing still another embodiment of the fuel cell which is incorporated in the electronic apparatus according to the invention;

FIG. 20 is a sectional view showing the embodiment of the conventional fuel cell.

### DETAILED DESCRIPTION OF THE PREFERRED EMBODIMENTS

Now referring to the drawings, preferred embodiments of the invention are described below.

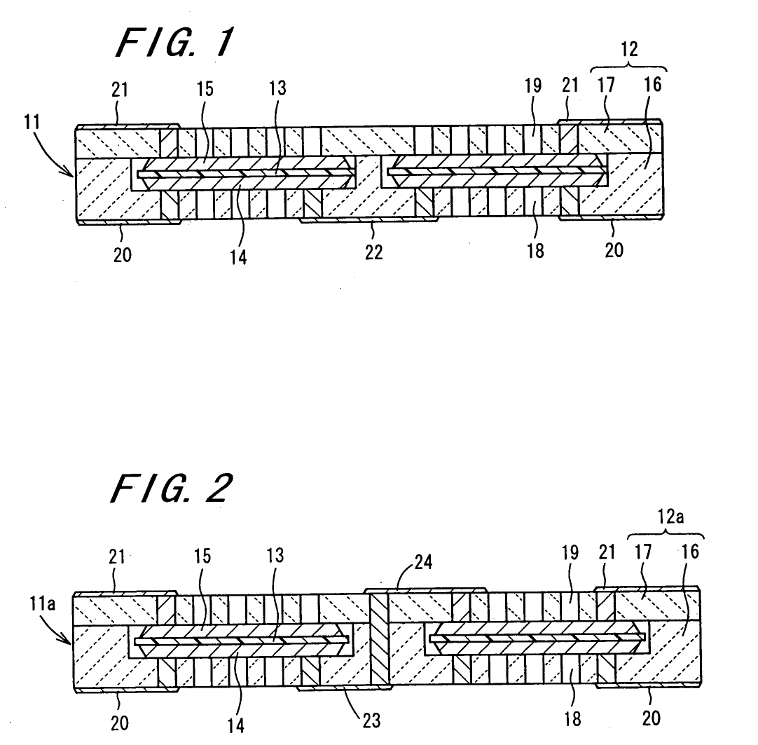

FIG. 1 is a sectional view showing a fuel cell casing and a fuel cell employing the same according to one embodiment of the invention. In FIG. 1, reference numeral 11 denotes a fuel cell; reference numeral 12 denotes a fuel cell casing; reference numeral 13 denotes a membrane electrode assembly; reference numeral 14 denotes a first electrode; reference numeral 15 denotes a second electrode; reference numeral 16 denotes a base body; reference numeral 17 denotes a lid body; reference numeral 18 denote a first fluid channel; reference numeral 19 denotes a second fluid channel; reference numeral 20 denotes a first wiring conductor: and reference numeral 21 denotes a second wiring conductor; and reference numeral 22 denotes a third wiring conductor.

On the membrane electrode assembly 13, for example, on both principal surfaces of an ionically conductive membrane (Polymeric solid electrolytes), a fuel electrode (not shown in the drawing) to become an anode electrode and an air electrode (not shown in the drawing) to become a cathode electrode are formed into one body so as to face the first electrode 14 formed on a lower principal surface an one principal surface and the second electrode 15 formed on an upper principal surface as another principal surface, respectively. Then, it is possible to flow an electric current generated in the membrane electrode assembly 13 to the first electrode 14 and the second electrode 15 and take it to the outside.

Such an ionically conductive membrane (Polymeric solid electrolytes) of the membrane electrode assembly 13 is constituted by a proton conductive ion exchange membrane such as a perfluorocarbon sulfonic acid resin, for example, Nafion (a product name, produced by DuPont). Moreover, the fuel electrode and the air electrode are porous-state gas diffusing electrodes, and have both functions of a porous catalyst layer and a gas diffusing layer. The fuel electrode and the air electrode are constituted by a porous material that holds conductive fine particles carrying a catalyst such as platinum, palladium or alloy thereof, for example, carbon fine particles by a hydrophobic resin binder such as polytetrafluoroethylene.

The first electrode 14 and the second electrode 15 on the lower principal surface and the upper principal surface or the membrane electrode assembly 13 are formed by a method of hot pressing a carbon electrode on which fine particles of a catalyst such as platinum or platinum-ruthenium are attached on the membrane electrode assembly 13, a method of applying or transferring a mixture of a carbon electrode material on which fine particles of a catalyst such as platinum or platinum-ruthenium are attached and a solution in which an electrolyte material is disparsed onto an electrolyte membrane, or the like.

The fuel cell casing 12 comprises the base body 16 that has a plurality of concavities and the lid body 17, has a function of storing the membrane electrode assembly 13 inside the concavity and hermetically sealing, and is made of a ceramics material such as sintered aluminum oxide (Al₂O₃), sintered mullite (3Al₂O₃.2SiO₂), sintered silicon carbide (SiC), sintered aluminum nitride (AlN), sintered silicon nitride (Si₃N₄) or sintered glass ceramics.

For example, sintered glass ceramic is made of a glass component and a filler component, and the glass component is, for example, SiO₂ D₂O₃, SiO₂—B₂O₃—Al₂O₃—, SiO₂—B₂O₃—Al₂( )₃-Mo (M denotes Ca, Sr, Mg, Ba or Zn), SiO₂—Al₂O₃-M¹O—M²1 (O M¹ and M² are the same or different, and denote Ca, Sr, Mg, Ba or Zn), SiO₂—B₂O₃—Al₂O₃-M¹O-M²O (M¹ and M² are the same as described before) a SiO₂—B₂O₃-M³₂1 (M³ denotes Li, Na or K), SiO₂—B₂O₃—Al₂O₃-MO (M³ is the same as described before), Pb glass, or Bi glass.

Further, the filler component is, for example, a composite oxide of Al₂O₃, SiO₂, ZrO₂ and an alkaline-earth metal oxide, a composite oxide of TiO₂ and an alkaline-earth metal oxide, or a composite oxide containing at least one of Al₂O₃ and SiO₂ (fox example, spinel, millite, cordierite).

Since the fuel cell casing 12 comprises the base body 16 having the plurality of concavities and the lid body 17, and the concavity is hermetically sealed by mounting the lid body 17 around the concavity of the base body 16 so as to cover the concavity, the lid body 17 is mounted to the base body 16 by bonding with a metal bonding material such as solder or silver brazing filler, by bonding with a resin material such as epoxy, or by a method of bonding a sealant or the like made of ferroalloy or the like on the upper surface as one surface around the concavity and welding by seam weld, electron beam, laser or the like. Here, the lid body 17 may be also provided with the plurality of concavities in the manner as the base body 16. In addition, a peripheral portion of the base body and the lid body may be provided with through holes and the base body and the lid body may be mechanically secured by screwing via the through holes.

The base body 16 and the lid body 17 are made to be thin, respectively, and in order to enable low-profiling of the fuel cell 11, it is preferable that flexural strength as mechanical strength is 200 MPa or more.

It is preferable that the base body 16 and the lid body 17 are made of sintered aluminum oxide of a close-packed substance whose relative density is 95% or more, for example. In this case, for example, in the case of sintered aluminum oxide, firstly, rare-earth oxide powder and sintering aids are added and mixed into aluminum oxide powder, and powder materials of sintered aluminum oxide is prepared. Secondly, an organic binder and a dispersion medium are added and mixed into the powder materials of aluminum oxide sinter to make paste, and by a doctor blade method, or by adding an organic binder into the powder materials and conducting press-molding, roll-molding or the like, a green sheet having specified thickness is manufactured from the paste. Then, by punching with a die, a microdrill, a laser or the like, through holes as the first fluid channels 18 and the second fluid channels 19, openings as fluid passages and through holes for disposing the first connection conductors 20 and the second connection conductors 21 are formed on the green sheet.

The first, second and third wiring conductors 20, 21 and 22 should preferably be composed of tungsten and/or molybdenum to prevent oxidation. In this case, for example, as an inorganic substance, Al₂O₃ in an amount of 3 to 20% by mass and Nb₂O₅ in an amount of 0.5 to 5% by mass is added to 100 mass percent tungsten and/or molybdenum powder to form a conductor paste. The conductor paste is filled in the through hole pierced in the green sheet to form a via hole acting as a through conductor.

Into the conductor paste, for the purpose of increasing close adhesion of the base body 16 and the lid body 17 to ceramics, aluminum oxide powder or powder of the same composite with a ceramics component forming the base body 16 and the lid body 117 can be added, for example, in the ratio of 0.05-2 volume %.

The first, second and third wiring conductors 20, 21 and 22 are formed in the outer and inner layers of the base body 16 and the lid body 17 before, after, or concurrently with the formation of the via conductor achieved by filling the conductor paste into the through hole. The formation of the wiring conductors is achieved by print-coating a similar conductor paste in a predetermined pattern on the green sheet in accordance with the screen printing method, gravure printing method, or the like method.

Thereafter, a predetermined number of sheet-like molded bodies carrying the printed, filled conductor paste are subjected to positional alignment, and are then stacked on top of each other under pressure. The stacked body is then fired, in a non-oxidative atmosphere, at a high temperature of approximately 1200 to 1500° C. Thereby, the desired ceramic base body 16, the lid body 17, and the first, second and third wiring conductors 20, 21 and 22 are obtained.

Further, it is preferable that the base body 16 and the lid body 17 made of ceramics have thickness of 0.2 mm or more. In a case where the thickness is less than 0.2 mm, because the strengths are apt to cover, the base body 16 and the lid body 17 tend to be easily cracked by stress caused when the base body 16 and the lid body 17 are mounted. On the other hand, in a case where the thickness is more than 5 mm, because slenderizing and low-profiling are difficult, it is hard to use as a fuel cell installed in small mobile equipment, and because a thermal capacity is large, it is likely to become hard to instantly set to appropriate temperature corresponding to an electrochemical reaction condition of the membrane electrode assembly 13.

The first, second and third wiring conductors 20, 21 and 22 are electrically connected to the first electrode 14 and the second electrode 15 of the membrane electrode assembly 13, respectively, thereby functioning as conductive paths for taking out an electric current generated in the membrane electrode assembly 13 to the outside of the fuel cell casing 12.

The first wiring conductor 20 has its one end disposed in that part of the concavity bottom surface of the base body 16 which faces the first electrode 14 of the membrane electrode assembly 13, and its other end led out toward the outer surface of the base body 16. As described above, it is preferable that the first wiring conductor 20 is formed integrally with the base body 16 and is made 10 μm or above higher than the concavity bottom surface of the base body 16. This allows both ends of the first wiring conductor 20 to-make contact with the first electrode 14 with ease. The desired height of the first wiring conductor 20 can be achieved by adjusting the printing condition such that the conductor paste is print-coated in a larger thickness during the print-coating process as described above. Further, the first wiring conductor 20 should preferably be arranged in plural face to face with the first electrode 14. This helps reduce electric loss in the first wiring conductor 20. That part of the first wiring conductor 20 which penetrates through the base body 16 should preferably be Φ50 μm or above in diameter.

The second wiring conductor 21 has its one end disposed in a part of a lower surface as one surface of the lid body 17 which faces the second electrode 15 of the membrane electrode assembly 13, and its other end led out toward the outer surface of the lid body 17. It is preferable that, like the first wiring conductor 20, the second wiring conductor 21 is formed integrally with the lid body 17 and is made 10 μm or above higher than the lower surface of the lid body 17. This allows the second wiring conductor 21 to make contact with the second electrode 15 with ease. The desired height of the second wiring conductor 21 can be achieved by adjusting the printing condition such that the conductor paste is print-coated in a larger thickness during the print-coating process as described above. Further, the second wiring conductor 21 should preferably be arranged in plural face to face with the second electrode 15. This helps reduce electric loss in the second wiring conductor 21. That part of the second wiring conductor 21 which penetrates through the lid body 17 should preferably be (50 μm or above in diameter.

The third wiring conductor 22, which is formed integrally with the base body 16, has its one end opposed to the first electrode 14 of the membrane electrode assembly 13 on a bottom surface of one of a plurality of concavities of the base body 16, and its other end opposed to the first electrode 14 of the other membrane electrode assembly 13 on the other bottom surface of the concavity. The third wiring conductor 22 should preferably be made 10 μm or above higher than the bottom surface of the concavity of the base body 16. This allows both ends of the third wiring conductor 22 to make contact with the first electrode 14 with ease. The desired height of the third wiring conductor 22 can be obtained by adjusting the printing condition such that the conductor paste is print-coated in a larger thickness during the print-coating process as described above. Further, the third wiring conductor 22 should preferably be arranged in plural face to face with the first electrode 14. This helps reduce electric loss ascribable to the third wiring conductor 22. That part of the third wiring conductor 22 which penetrates through the base body 16 should preferably be set at Φ50 μm or above in diameter.

It is preferable that the first, second and third wiring conductors 20, 21 and 22 each have its exposed surface coated with a highly-conductive metal material such as nickel or gold which is highly corrosion-resistant and exhibits excellent wettability with respect to a brazing filler material, using the plating method. This makes it possible to establish satisfactory electrical connection between the first, second and third wiring conductors 20, 21 and 22, as well as between the first, second and third wiring conductor 20, 21, 22 and an external electric circuit.

The first, second and third wiring conductors 20, 21 and 22 can be electrically connected to the first and second electrodes 14 and 15, respectively, by grippingly inserting the membrane electrode assembly 13 between the base body 16 and the lid body 17. By so doing, the first, second and third wiring conductors 20, 21 and 22 are brought into pressure-contact with the first and second electrodes 14 and 15, respectively.

Arranged on the concavity bottom surface of the base body 16 facing the first electrode 14 and on the lower surface of the lid body 17 facing the second electrode 15 are the first fluid channel 18 and the second fluid channel 19, respectively. The first fluid channel 18 is so formed as to extend toward the outer surface of the base body 16, whereas the second fluid channel 19 is so formed as to extend toward the outer surface of the lid body 17. The first and second fluid channels 18 and 19 are constituted by the through holes pierced in the base body 16 and the lid body 17, or grooves. The first and second fluid channels 18 and 19 each serve as a passage for a fluid to be supplied to the membrane electrode assembly 13, such as fuel gas for example hydrogen-rich reforming gas or oxidant gas for example air, and besides serves as a passage for a fluid to be discharged from the membrane electrode assembly 13 after reactions, such as water produced through reactions.

Regarding a through hole or a groove which is pierced in the base body 16 and the lid body 17 as the first and second fluid channels 18 and 19, the diameter and number of the through hole, or the width, depth, and arrangement of the groove are determined according to the specifications of the fuel cell 11 in such a way that a fluid such as fuel gas or oxidant gas can be evenly supplied to the membrane electrode assembly 13.

In the fuel cell casing 12 and the fuel cell 11 embodying the invention, the first and second fluid channels 18 and 19 should preferably have a hole diameter of D 0.1 mm or above and be equally spaced. Alternatively, in a case of forming grooves, the first and second fluid channels 18 and 19 should preferably have a width of 0.3 mm or above and a depth of 0.1 mm or above. This allows a fluid to flow into the membrane electrode assembly 13 under uniform pressure.

In this way, the first fluid channel 18 is disposed face to face with the lower principal surface of the membrane electrode assembly 13 having the first electrode 14, whereas the second fluid channel 19 is disposed face to face with the upper principal surface of the membrane electrode assembly 13 having the second electrode 15. With this arrangement, a fluid can be exchanged between the lower and upper principal surfaces of the membrane electrode assembly 13 and their corresponding first and second fluid channels 18 and 19, and thus the fluid can be supplied and discharged through the respective fluid path. Moreover, in the case of supplying gas as a fluid, it is possible to prevent a decrease in the partial pressure of the gas supplied to the first and second electrodes 14 and 15 of the membrane electrode assembly 13, and thus obtain a predetermined stable output voltage. Further, since the partial pressure of the supplied gas is stabilized, the inner pressure within the fuel cell 11 is made uniform. As a result, thermal stress occurring in the membrane electrode assembly 13 can be suppressed, leading to enhancement of the reliability of the fuel cell 11.

With the construction thus far described, it is possible to provide the compact and sturdy fuel cell casing 12 capable of housing the membrane electrode assembly 13 as shown in FIG. 1 and the fuel cell 11 that allows highly-efficient control according to the invention.

FIG. 2 is a sectional view showing the fuel cell casing and a second fuel cell employing it according to another embodiment of the invention. In the figure, reference numeral 11a denotes a fuel cell; reference numeral 12a denotes a fuel cell casing; reference numeral 13 denotes a membrane electrode assembly; reference numeral 14 denotes a first electrode; reference numeral 15 denotes a second electrode; reference numeral 16 denotes a base body; 17 reference numeral denotes a lid body; reference numeral 18 denotes a first fluid channel; reference numeral 19 denotes a second fluid channel; reference numeral 20 denotes a first wiring conductor; reference numeral 21 denotes a second wiring conductor; reference numeral 23 denotes a fourth wiring conductor; and reference numeral 24 denotes a fifth wiring conductor. The fuel cell casing 12a is composed of the base body 16 and the lid body 17.

The components identified by reference numerals 13 to 21 in FIG. 2 have basically the same structure as those shown in FIG. 1, and therefore the descriptions about them will be omitted.

Otherwise, the fourth wiring conductor 23 has its one end opposed to the first electrode 14 of the membrane electrode assembly 13 on the bottom surface of one of the plurality of concavities of the base body 16, and its other end led to the top surface of the base body 16 on which the lid body 17 is mounted. Moreover, the fifth wiring conductor 24 has its one end opposed to the second electrode 15 of the other membrane electrode assembly 13 of the concavity on the lower surface of the lid body 17, and its other end led to the lower surface of the lid body 17 which is mounted on the top surface of the base body 16, so as to face the other end of the fourth wiring conductor 23.

It is preferable that, like the third wiring conductor 22, the fourth wiring conductor 23 is formed integrally with the base body 16 and is made 10 μm or above higher than the bottom surface of the concavity of the base body 16. This allows one end of the fourth wiring conductor 23 to make contact with the first electrode 14 with ease. The desired height of the fourth wiring conductor 23 can be obtained by adjusting the printing condition such that the conductor paste is print-coated in a larger thickness during the print-coating process as described above. Further, the fourth wiring conductor 23 should preferably be arranged in plural face to face with the first electrode 14. This helps reduce electric loss ascribable to the fourth wiring conductor 23. That part of the fourth wiring conductor 23 which penetrates through the base body 16 should preferably be set at Φ50 μm or above in diameter.

It is preferable that, like the second wiring conductor 21, the fifth wiring conductor 24 is formed integrally with the lid body 17 and is made 10 μm or above higher than the lower surface of the lid body 17. This allows one end of the fifth wiring conductor 24 to make contact with the second electrode 15 with ease. The desired height of the fifth wiring conductor 24 can be obtained by adjusting the printing condition such that the conductor paste is print-coated in a larger thickness during the print-coating process as described above. Further, the fifth wiring conductor 24 should preferably be arranged in plural face to face with the second electrode 15. This helps reduce electric loss ascribable to the fifth wiring conductor 24. That part of the fifth wiring conductor 24 which penetrates through the lid body 17 should preferably be set at Φ50 μm or above in diameter.

As shown in FIGS. 1 and 2, according to the fuel cell casing 12, 12a and the fuel cell 11, 11a embodying the invention, the membrane electrode assembly 13 is housed in each of a plurality of concavities of the base body 16. Moreover, the third wiring conductor 22, or the fourth and fifth wiring conductors 23 and 24, is/are disposed so as to extend across the region between the adjacent concavities. Thereby, in a plurality of membrane electrode assemblies 13, their respective first electrodes 14, or their first and second electrodes 14 and 15, are electrically connected together. Then, to obtain the overall output through the endmost membrane electrode assemblies 13, the first and second wiring conductors 20 and 21 are electrically connected thereto respectively. In this case, since the first to third wiring conductors 20, 21, and 22, as well as the first, second, fourth, and fifth wiring conductors 20, 21, 23, and 24, allow free three-dimensional wiring, a plurality of membrane electrode assemblies 13 can be arbitrarily connected together in series or in parallel. This makes it possible to adjust the overall output voltage and output current with efficiency. Thus, in the fuel cell, electricity which has been electrochemically produced in a plurality of membrane electrode assemblies 13 can be externally extracted satisfactorily.

It should be noted that the invention need not be limited to the above-described embodiments and examples, and therefore various changes and modifications are possible without departing from the spirit or scope of the invention. For example, the first and second fluid channels may alternatively be constructed by forming an inlet on the side surface of the base body or the lid body. In this case, the entire fuel cell is slenderized, and the down-sized fuel cell is accordingly suited for a portable electronic apparatus. Moreover, the other ends of the first and second wiring conductors may be led out over the side surfaces of the base body and the lid body, respectively, that are located on the same side, instead of being led out over the outer surfaces thereof, respectively. In this case, the wiring lines, the ducts, etc. can be put together only on one side of the fuel cell. This helps facilitate miniaturization and protection of the externally-connected portions. Thus, the fuel cell can be designed with high reliability and accordingly operated with stability for a longer period of time.

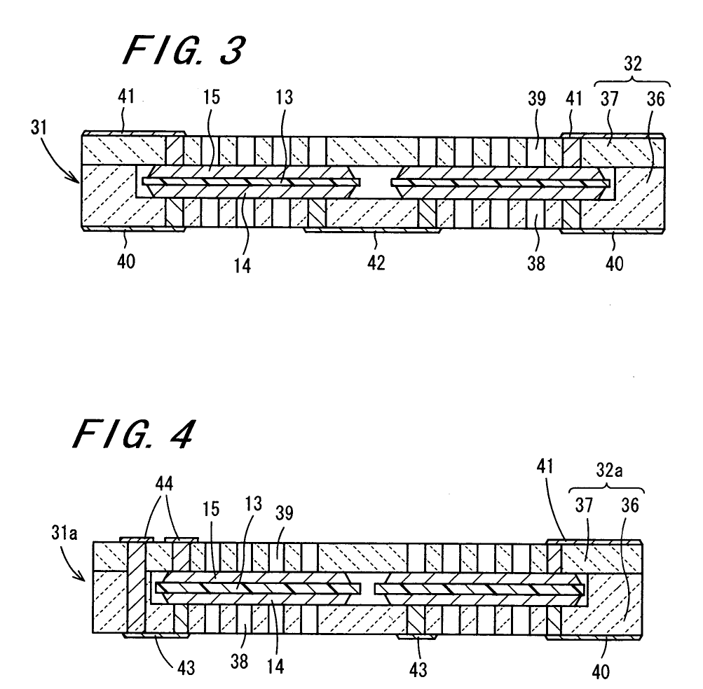

FIG. 3 is a sectional view showing a fuel cell casing and a fuel cell employing the same according to still another embodiment of the invention. In FIG. 3, reference numeral 31 denotes a fuel cell; reference numeral 32 denotes a fuel cell casing; reference numeral 13 denotes a membrane electrode assembly; reference numeral 14 denotes a first electrode; reference numeral 15 denotes a second electrode; reference numeral 36 denotes a base body; reference numeral 37 denotes a lid body; reference numeral 38 denotes a first fluid channel; reference numeral 39 denotes a second fluid channel; reference numeral 40 denotes a first wiring conductor; reference numeral 41 denotes a second wiring conductor; and reference numeral 42 denotes a third wiring conductor. In this embodiment, the same components as those of the aforementioned embodiment will be denoted by the same reference numerals, and it will be omitted to describe in detail.

The fuel cell casing 32 comprises the base body 36 that has a concavity and the lid body 37, has a function of storing a plurality of membrane electrode assembly 13 inside the concavity and hermetically sealing, and is made of a ceramics material such as sintered aluminum oxide (Al₂O₃), sintered mullite (3Al₂O₃.2SiO₂), sintered silicon carbide (SiC), sintered aluminum nitride (AlN), sintered silicon nitride (Si₃N₄) or sintered glass ceramics.

Note that, sintered glass ceramics is made of a glass component and a filler component, these components are the same as those of the aforementioned embodiment, and it will be omitted to describe in detail.

Since the fuel cell casing 32 comprises the base body 36 having a concavity and the lid body 37, and the concavity is hermetically sealed by mounting the lid body 37 around the concavity of the base body 36 so as to cover the concavity, the lid body 37 is mounted to the base body 36 by bonding with a metal bonding material such as solder or silver brazing filler, by bonding with a resin material such as epoxy, or by a method of bonding a sealant or the like made of ferroalloy or the like on the upper surface as one surface around the concavity and welding by seam weld, electron beam, laser or the like. Here, the lid body 37 may be also provided with a concavity in the manner as the base body 36. In addition, a peripheral portion of the base body and the lid body may be provided with through holes and the base body and the lid body may be mechanically secured by screwing via the through holes.

Like the aforementioned embodiment, the base body 36 and the lid body 37 are made to be thin, respectively, and in order to enable low-profiling of the fuel cell 1, it is preferable that flexural strength as mechanical strength is 200 MPa or more.

Like the aforementioned embodiment, it is preferable that the base body 36 and the lid body 37 are made of sintered aluminum oxide of a close-packed substance whose relative density is 95% or more, for example. In this case, for example, in the case of sintered aluminum oxide, firstly, rare-earth oxide powder and sintering aids are added and mixed into aluminum oxide powder, and powder materials of sintered aluminum oxide is prepared. Secondly, an organic binder and a dispersion medium are added and mixed into the powder materials of aluminum oxide sinter to make paste, and by a doctor blade method, or by adding an organic binder into the powder materials and conducting press-molding, roll-molding or the like, a green sheet having specified thickness is manufactured from the paste. Then, by punching with a die, a microdrill, a laser, press-molding or the like, through holes as the first fluid channels 18 and the second fluid channels 19, openings as fluid passages and through holes for disposing the first connection conductor 40, the second connection conductor 41 and the third connection conductor 42 are formed on the green sheet.

The first, second and third wiring conductors 40, 41 and 42 should preferably be composed of tungsten and/or molybdenum to prevent oxidation. In this case, for example, as an inorganic substance, Al₂O₃ in an amount of 3 to 20% by mass and Nb₂O₅ in an amount of 0.5 to 5% by mass is added to 100 mass percent tungsten and/or molybdenum powder to form a conductor paste. The conductor paste is filled in the through hole pierced in the green sheet to form a via hole acting as a through conductor.

Like the aforementioned embodiment, into the conductor paste, for the purpose of increasing close adhesion of the base body 36 and the lid body 37 to ceramics, aluminum oxide powder or powder of the same composite with a ceramics component forming the base body 36 and the lid body 37 can be added, for example, in the ratio of 0.05-2 volume %.

The first, second and third wiring conductors 20, 21 and 33 are formed in the outer and inner layers of the base body 36 and the lid body 37 before, after, or concurrently with the formation of the via conductor achieved by filling the conductor paste into the through hole. The formation of the wiring conductors is achieved by print-coating a similar conductor paste in a predetermined pattern on the green sheet in accordance with the screen printing method, gravure printing method, or the like method.

Thereafter, like the aforementioned embodiment, a predetermined number of sheet-like molded bodies carrying the printed, filled conductor paste are subjected to positional alignment, and are then stacked on top of each other under pressure. The stacked body is then fired, in a non-oxidative atmosphere, at a high temperature of approximately 1200 to 1500° C. Thereby, the desired ceramic base body 36, the lid body 37, and the first, second and third wiring conductors 40, 41 and 42 are obtained.

Further, like the aforementioned embodiment, it is preferable that the base body 36 and the lid body 37 made of ceramics have thickness of 0.2 mm or more. In a case where the thickness is less than 0.2 mm, because the strengths are apt to cover, the base body 36 and the lid body 37 tend to be easily cracked by stress caused when the base body 36 and the lid body 37 are mounted. On the other hand, in a case where the thickness is more than 5 mm, because slenderizing and low-profiling are difficult, it is hard to use as a fuel cell installed in small mobile equipment, and because a thermal capacity is large, it is likely to become hard to instantly set to appropriate temperature corresponding to an electrochemical reaction condition of the membrane electrode assembly 13.

The first wiring conductors 40, the second wiring conductors 41 and third wiring conductor 42 are electrically connected to the first electrode 14 and the second electrode 15 of the membrane electrode assembly 13, respectively, thereby functioning as conductive paths for taking out an electric current generated in the membrane electrode assembly 13 to the outside of the fuel cell casing 32.

The first wiring conductor 40 has its one end disposed in that part of the concavity bottom surface of the base body 36 which faces the first electrode 14 of the membrane electrode assembly 13, and its other end led out toward the outer surface of the base body 36. As described above, it is preferable that the first wiring conductor 40 is formed integrally with the base body 36 and is made 10 μm or above higher than the concavity bottom surface of the base body 16. This allows both ends of the first wiring conductor 20 to make contact with the first electrode 14 with ease. The desired height of the first wiring conductor 20 can be achieved by adjusting the printing condition such that the conductor paste is print-coated in a larger thickness during the print-coating process as described above. Further, the first wiring conductor 40 should preferably be arranged in plural face to face with the first electrode 14. This helps reduce electric loss in the first wiring conductor 40. That part of the first wiring conductor 40 which penetrates through the base body 36 should preferably be Φ50 μm or above in diameter.

The second wiring conductor 41 has its one end disposed in a part of a lower surface as one surface of the lid body 37 which faces the second electrode 15 of the membrane electrode assembly 13, and its other end led out toward the outer surface of the lid body 37. It is preferable that, like the first wiring conductor 40, the second wiring conductor 41 is formed integrally with the lid body 37 and is made 10 μm or above higher than the lower surface of the lid body 17. This allows the second wiring conductor 41 to make contact with the second electrode 15 with ease. The desired height of the second wiring conductor 41 can be achieved by adjusting the printing condition such that the conductor paste is print-coated in a larger thickness during the print-coating process as described above. Further, the second wiring conductor 41 should preferably be arranged in plural face to face with the second electrode 15. This helps reduce electric loss in the second wiring conductor 41. That part of the second wiring conductor 41 which penetrates through the lid body 37 should preferably be (50 μm or above in diameter.

The third wiring conductor 42, which is formed integrally with the base body 36, has its one end opposed to the first electrode 14 of one of the plurality of membrane electrode assembly 13 on the bottom surface of the concavity of the base body 36, and its other end opposed to the first electrode 14 of the other of the plurality of membrane electrode assembly 13 on the bottom surface of the concavity. The third wiring conductor 42 should preferably be made 10 μm or above higher than the bottom surface of the concavity of the base body 36. This allows both ends of the third wiring conductor 42 to make contact with the first electrode 14 with ease. The desired height of the third wiring conductor 42 can be obtained by adjusting the printing condition such that the conductor paste is print-coated in a larger thickness during the print-coating process as described above. Further, the third wiring conductor 42 should preferably be arranged in plural face to face with the first electrode 14. This helps reduce electric loss ascribable to the third wiring conductor 42. That part of the third wiring conductor 42 which penetrates through the base body 36 should preferably be set at Φ50 μm or above in diameter.

It is preferable that the first, second and third wiring conductors 40, 41 and 42 each have its exposed surface coated with a highly-conductive metal material such as nickel or gold which is highly corrosion-resistant and exhibits excellent wettability with respect to a brazing filler material, using the plating method. This makes it possible to establish satisfactory electrical connection between the first, second and third wiring conductors 40, 41 and 42, as well as between the first, second, third wiring conductor 40, 41, 42 and an external electric circuit.

The first, second and third wiring conductors 40, 41 and 42 can be electrically connected to the first and second electrodes 14 and 15, respectively, by grippingly inserting the membrane electrode assembly 13 between the base body 36 and the lid body 37. By so doing, the first, second and third wiring conductors 40, 41 and 42 are brought into pressure-contact with the first and second electrodes 14 and 15, respectively.

Arranged on the concavity bottom surface of the base body 36 facing the first electrode 14 and on the lower surface of the lid body 37 facing the second electrode 15 are the first fluid channel 38 and the second fluid channel 39, respectively. The first fluid channel 38 is so formed as to extend toward the outer surface of the base body 36, whereas the second fluid channel 39 is so formed as to extend toward the outer surface of the lid body 37. The first and second fluid channels 38 and 39 are constituted by the through holes pierced in the base body 36 and the lid body 37, or grooves. The first and second fluid channels 38 and 39 each serve as a passage for a fluid to be supplied to the membrane electrode assembly 13, such as fuel gas for example hydrogen-rich reforming gas or oxidant gas for example oxygen or air, and besides serves as a passage for a fluid to be discharged from the membrane electrode assembly 13 after reactions, such as water produced through reactions.

Regarding a through hole or a groove which is pierced in the base body 36 and the lid body 37 as the first and second fluid channels 38 and 39, the diameter and number of the through hole, or the width, depth, and arrangement of the groove are determined according to the specifications of the fuel cell 31 in such a way that a fluid such as fuel gas or oxidant gas can be evenly supplied to the membrane electrode assembly 13.

In the fuel cell casing 32 and the fuel cell 31 embodying the invention, the first and second fluid channels 38 and 39 should preferably have a hole diameter of Φ0.1 mm or above and be equally spaced. Alternatively, in a case of forming grooves, the first and second fluid channels 38 and 39 should preferably have a width of 0.3 mm or above and a depth of 0.1 mm or above. This allows a fluid to flow into the membrane electrode assembly 13 under uniform pressure.

In this way, the first fluid channel 38 is disposed face to face with the lower principal surface of the membrane electrode assembly 13 having the first electrode 14, whereas the second fluid channel 39 is disposed face to face with the upper principal surface of the membrane electrode assembly 13 having the second electrode 15. With this arrangement, a fluid can be exchanged between the lower and upper principal surfaces of the membrane electrode assembly 13 and their corresponding first and second fluid channels 38 and 39, and thus the fluid can be supplied and discharged through the respective fluid path. Moreover, in the case of supplying gas as a fluid, it is possible to prevent a decrease in the partial pressure of the gas supplied to the first and second electrodes 14 and 15 of the membrane electrode assembly 13, and thus obtain a predetermined stable output voltage. Further, since the partial pressure of the supplied gas is stabilized, the inner pressure within the fuel cell 31 is made uniform. As a result, thermal stress occurring in the membrane electrode assembly 13 can be suppressed, leading to enhancement of the reliability of the fuel cell 31.

With the construction thus far described, it is possible to provide the compact and sturdy fuel cell casing 32 capable of housing the membrane electrode assembly 13 as shown in FIG. 3 and the fuel cell 31 that allows highly-efficient control according to the invention.

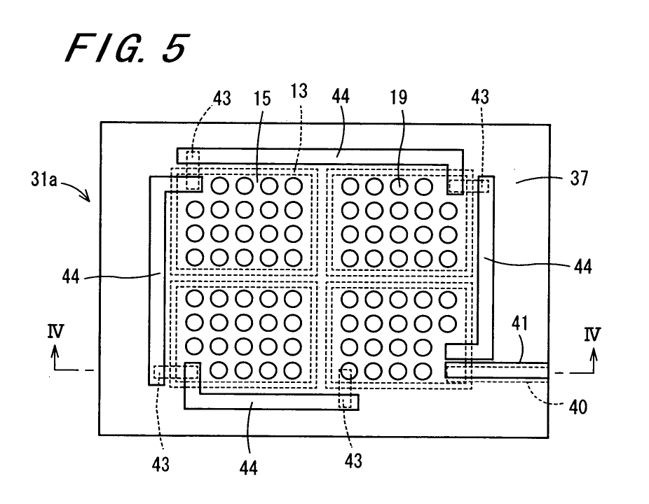

FIG. 4 is a sectional view showing the fuel cell casing and the fuel cell employing it according to still another embodiment of the invention. FIG. 5 is a plan view showing the same. In these figures, reference numeral 31a denotes a fuel cell; reference numeral 32a denotes a fuel cell casing; reference numeral 13 denotes a membrane electrode assembly; reference numeral 14 denotes a first electrode; reference numeral 15 denotes a second electrode; reference numeral 36 denotes a base body; reference numeral 37 denotes a lid body; reference numeral 38 denotes a first fluid channel; reference numeral 39 denotes a second fluid channel; reference numeral 40 denotes a first wiring conductor; reference numeral 41 denotes a second wiring conductor; reference numeral 43 denotes a fourth wiring conductor; and reference numeral 44 denotes a fifth wiring conductor. Note that FIG. 4 is a sectional view taken along the line IV-IV of FIG. 5.

The components identified by reference numerals 13 to 15 and 36 to 41 in FIGS. 4 and 5 have basically the same structure as those shown in FIG. 3, and therefore the descriptions about them will be omitted. Otherwise, the fourth wiring conductor 43 has its one end opposed to the first electrode 14 of one of the plurality of membrane electrode assemblies 13 on the bottom surface of the concavity of the base body 36, and its other end led to the top surface of the base body 36 on which the lid body 37 is mounted. Moreover, the fifth wiring conductor 44 has its one end opposed to the second electrode 15 of the other of the plurality of membrane electrode assemblies 13 on the lower surface of the lid body 37, and its other end led to the lower surface of the lid body 37 which is mounted on the top surface of the base body 36, so as to face the other end of the fourth wiring conductor 43.

It is preferable that, like the third wiring conductor 42, the fourth wiring conductor 43 is formed integrally with the base body 36 and is made 10 μm or above higher than the bottom surface of the concavity of the base body 36. This allows one end of the fourth wiring conductor 43 to make contact with the first electrode 14 with ease. The desired height of the fourth wiring conductor 43 can be obtained by adjusting the printing condition such that the conductor paste is print-coated in a larger thickness during the print-coating process as described above. Further, the fourth wiring conductor 43 should preferably be arranged in plural face to face with the first electrode 14. This helps reduce electric loss ascribable to the fourth wiring conductor 43. That part of the fourth wiring conductor 43 which penetrates through the base body 36 should preferably be set at a Φ50 μm or above in diameter.

It is preferable that, like the second wiring conductor 41, the fifth wiring conductor 24 is formed integrally with the lid body 37 and is made 10 μm or above higher than the lower surface of the lid body 37. This allows one end of the fifth wiring conductor 44 to make contact with the second electrode 15 with ease. The desired height of the fifth wiring conductor 44 can be obtained by adjusting the printing condition such that the conductor paste is print-coated in a larger thickness during the print-coating process as described above. Further, the fifth wiring conductor 44 should preferably be arranged in plural face to face with the second electrode 15. This helps reduce electric loss ascribable to the fifth wiring conductor 24. That part of the fifth wiring conductor 44 which penetrates through the lid body 37 should preferably be set at Φ50 μm or above in diameter.

As shown in FIGS. 3, 4, and 5, according to the fuel cell casing 32, 32a and the fuel cell 31, 31a embodying the invention, the plurality of membrane electrode assemblies 13 are housed in the concavity of the base body 36, and the third wiring conductor 42, or the fourth and fifth wiring conductors 43 and 44, is/are disposed. Thereby, in a plurality of membrane electrode assemblies 13, their respective first electrodes 14, or their first and second electrodes 14 and 15, are electrically connected together. Then, to obtain the overall output through the endmost membrane electrode assemblies 13, the first and second wiring conductors 40 and 41 are electrically connected thereto respectively. In this case, since the first to third wiring conductors 40, 41, and 42, as well as the first, second, fourth, and fifth wiring conductors 40, 41, 43, and 44, allow free three-dimensional wiring, a plurality of membrane electrode assemblies 13 can be arbitrarily connected together in series or in parallel. This makes it possible to adjust the overall output voltage and output current with efficiency. Thus, in the fuel cell, electricity which has been electrochemically produced in a plurality of membrane electrode assemblies 13 can be externally extracted satisfactorily.

It should be noted that the invention need not be limited to the above-described embodiments and examples, and therefore various changes and modifications are possible without departing from the spirit or scope of the invention. For example, the first and second fluid channels may alternatively be constructed by forming an inlet on the side surface of the base body or the lid body. In this case, the entire fuel cell is slenderized, and the down-sized fuel cell is accordingly suited for a portable electronic apparatus. Moreover, the other ends of the first and second wiring conductors may be led out over the side surfaces of the base body and the lid body, respectively, that are located on the same side, instead of being led out over the outer surfaces thereof, respectively. In this case, the wiring lines, the ducts, etc. can be put together only on one side of the fuel cell. This helps facilitate miniaturization and protection of the externally-connected portions. Thus, the fuel cell can be designed with high reliability and accordingly operated with stability for a longer period of time.

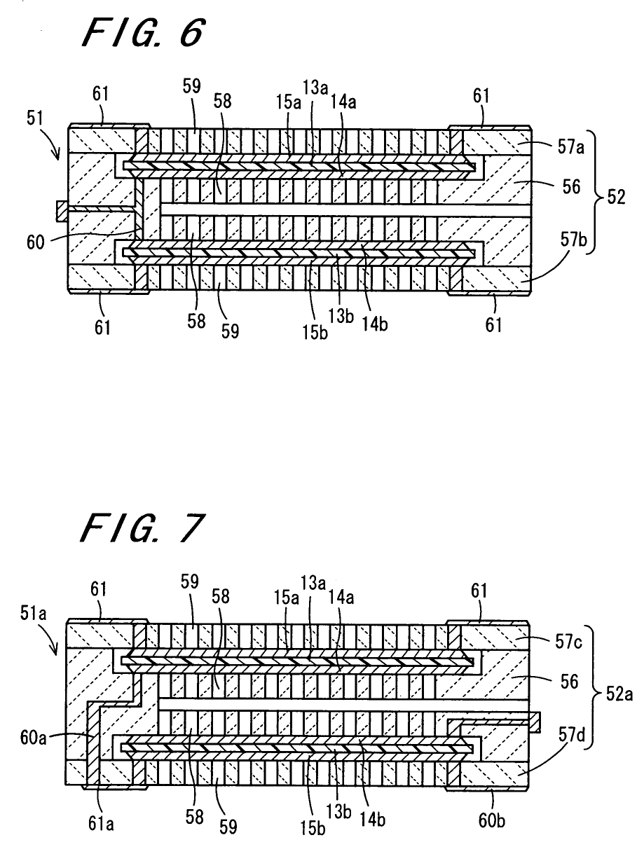

FIG. 6 is a sectional view showing a fuel cell casing and a fuel cell employing the same according to one another embodiment of the invention. In FIG. 6, reference numeral 51 denotes a fuel cell; reference numeral 52 denotes a fuel cell casing; reference numerals 13a and 13b denote a membrane electrode assembly; reference numerals 14d and 14b denote a first electrode; reference numerals 15a and 15b denotes a second electrode; reference numeral 56 denotes a base body; reference numerals 57a and 57b denote a lid body (the first and second lid bodies); reference numeral 58 denotes a first fluid channel; reference numeral 59 denotes a second fluid channel; reference numeral 60 denotes a first wiring conductor; and reference numeral 61 denotes a second wiring conductor.

On the membrane electrode assembly 13a and 13b, for example, on both principal surfaces of an ionically conductive membrane (Polymeric solid electrolytes) which is made of a platy solid electrolyte membrane, a fuel electrode (not shown in the drawing) to become an anode electrode and an all electrode (not shown in the drawing) to become a cathode electrode are formed into one body so a to face the first electrode 14a and 14b formed on the lower principal surface as one principal surface and the second electrode 15d and 15b formed on the upper principal surface as another principal surface, respectively. Then, it is possible to flow an electric current generated in the membrane electrode assembly 13a and 13b to the first electrode 14a and 14b and the second electrode 15a and 15b and take it to the outside.

Like the membrane electrode assembly 13 of the aforementioned embodiment, such an ionically conductive membrane (Polymeric solid electrolytes) of the membrane electrode assembly 13a and 13b is constituted by a proton conductive in exchange membrane such as, a perfluorocarbon sulfonic acid resin, for example, Nafion (a product name, produced by DuPont). Moreover, the fuel electrode and the air electrode are porous state gas diffusing electrodes, and have both functions of a porous catalyst layer and a gas diffusing layer. The fuel electrode and the air electrode are constituted by a porous material that holds conductive tip particles carrying a catalyst such as platinum, palladium or alloy thereof, for example, carbon fine particles by a hydrophobic resin binder such as polytetrafluoroethylene.

The first electrode 14a and 14b and the second electrode 15a and 15b on the principal-surface and the principal surface of the membrane electrode assembly 13a and 13b are formed by a method of hot pressing a carbon electrode on which fine particles of a catalyst such as platinum or platinum-ruthenium are attached on the membrane electrode assembly 3, a method of applying or transferring a mixture of a carbon electrode material on which fine particles of a catalyst such as platinum or platinum-ruthenium are attached and a solution in which an electrolyte material is dispersed onto an electrolyte membrane, or the like.

The fuel cell casing 52 of the invention surprises the base body 56 having a first concavity on an upper principal surface as one principal surface and a second concavity on a lower principal surface as another principal surface, the first lid body 57a mounted on an upper surface of the base body 56 near the first concavity so as to cover the first concavity, and a second lid body 57b mounted on a lower surface of the base body 56 near the second concavity so as to cover the second concavity. The fuel cell casing 52 has a function of storing the membrane electrode assembly 13a and 13b inside the first and second concavity and hermetically sealing, and is made of a ceramics material such as sintered aluminum oxide (Al₂O₃), sintered mullite (3Al₂O₃.2SiO₂), sintered silicon carbide (SiC), sintered aluminum nitride (AlN), sintered silicon nitride (Si₃N₄) or sintered glass ceramics.

Note that, sintered glass ceramics is made of a glass component and a filler component, these components are the same as those of the aforementioned embodiment, and it will be omitted to describe in detail.

Since the fuel cell casing 52 comprises the base body 56 having first and second concavities and the first and second lid bodies 57a and 57b, and the concavity is hermetically sealed by mounting the first and second lid bodies 57a and 57b around the first and second concavities of the base body 56 so as to cover the first and second concavities, the lid bodies 57a and 57b are mounted to the base body 56 by bonding with a metal bonding material such as solder or silver brazing filler, by bonding with a resin material such as epoxy, or by a method of bonding a sealant or the like made of ferroalloy or the like on the upper surface as one surface around the concavity and welding by seam weld, electron beam, laser or the like. Here, the first and second lid bodies 57a and 57b may be also provided with a concavity in the manner as the base body 56. In addition, a peripheral portion of the base body 56 and the first and second lid bodies 57a and 57b may be provided with through holes and the base body and the lid bodies may be mechanically secured by screwing via the through holes.

The base body 56 and the first and second lid bodies 57a and 57b are made to be thin, respectively, and in order to enable low-profiling of the fuel cell 1, it is preferable that flexural strength as mechanical strength is 200 MPa or more.

It is preferable that the base body 56 and the first and second lid bodies 57a and 57b are made of sintered aluminum oxide of a close-packed substance whose relative density is 95% or more, for example. In this case, for example, in the case of sintered aluminum oxide, firstly, rare-earth oxide powder and sintering aids are added and mixed into aluminum oxide powder, and powder materials of sintered aluminum oxide is prepared. Secondly, an organic binder and a dispersion medium are added and mixed into the powder materials of aluminum oxide sinter to make paste, and by a doctor blade method, or by adding an organic binder into the powder materials and conducting press-molding, roll-molding or the like, a green sheet having specified thickness is manufactured from the paste. Then, by punching with a die, a microdrill, a laser, press-molding or the like, through holes as the first fluid channels 58 and the second fluid channels 59, openings as fluid passages and through holes for disposing the first connection conductors 60 and the second connection conductors 61 are formed on the green sheet.

The first and second wiring conductors 60 and 61 should preferably be composed of tungsten and/or molybdenum to prevent oxidation. In this case, for example, as an inorganic substance, Al₂O₃ in an amount of 3 to 20% by mass and Nb₂O₅ in an amount of 0.5 to 5% by mass is added to 100 mass percent tungsten and/or molybdenum powder to form a conductor paste. The conductor paste is filled in the through hole pierced in the green sheet to form a via hole acting as a through conductor.

Into the conductor paste, for the purpose of increasing close adhesion of the base body 56 and the first and second lid bodies 57a and 57b to ceramics, aluminum oxide powder or powder of the same composite with a ceramics component forming the base body 56 and the first and second lid bodies 57a and 57b can be added, for example, in the ratio of 0.05-2 volume %.

The first and second wiring conductors 60 and 61 are formed in the outer and inner layers of the base body 56 and the first and second lid bodies 57a and 57b before, after, or concurrently with the formation of the via conductor achieved by filling the conductor paste into the through hole. The formation of the wiring conductors is achieved by print-coating a similar conductor paste in a predetermined pattern on the green sheet in accordance with the screen printing method, gravure printing method, or the like method.

Thereafter, a predetermined number of sheet-like molded bodies carrying the printed, filled conductor paste are subjected to positional alignment, and are then stacked on top of each other under pressure. The stacked body is then fired, in a non-oxidative atmosphere, at a high temperature of approximately 1200 to 1500° C. Thereby, the desired ceramic base body 56, the first and second lid bodies 57a and 57b, and the first and second wiring conductors 60 and 61 are obtained.

Further, it is preferable that the base body 56 and the first and second lid bodies 57a and 57b made of ceramics have thickness of 0.2 mm or more. In a case where the thickness is less than 0.2 mm, because the strengths are apt to cover, the base body 56 and the first and second lid bodies 57a and 57b tend to be easily cracked by stress caused when the base body 56 and the first and second lid bodies 57a and 57b are mounted. On the other hand, in a case where the thickness is more than 5 mm, because slenderizing and low-profiling are difficult, it is hard to use as a fuel cell installed in small mobile equipment, and because a thermal capacity is large, it is likely to become hard to instantly set to appropriate temperature corresponding to an electrochemical reaction condition of the membrane electrode assemblies 13a and 13b.

The first wiring conductors 60 and the second wiring conductors 61 are electrically connected to the first electrodes 14a and 14b and the second electrodes 15a and 15b of the membrane electrode assemblies 13a and 13b, respectively, thereby functioning as conductive paths for taking out an electric current generated in the membrane electrode assembly 13a and 13b to the outside of the fuel cell casing 52.

The first wiring conductor 60 has its one end disposed in that part of each bottom surface of the first and second concavities on both principal surfaces of the base body 56 which faces the first electrodes 14a and 14b of the membrane electrode assemblies 13a and 13b, and its other end led out toward the outer surface of the base body 56. As described above, it is preferable that the first wiring conductor 60 is formed integrally with the base body 56 and is made 10 μm or above higher than each bottom surface of the first and second concavities of the base body 56. This allows the first wiring conductor 60 to make contact with the first electrodes 14a and 14b with ease. The desired height of the first wiring conductor 60 can be achieved by adjusting the printing condition such that the conductor paste is print-coated in a larger thickness during the print-coating process as described above. Further, the first wiring conductor 60 should preferably be arranged in plural face to face with the first electrodes 14a and 14b. This helps reduce electric loss in the first wiring conductor 60. That part of the first wiring conductor 60 which penetrates through the base body 56 should preferably be Φ50 μm or above in diameter.

The second wiring conductor 61 has its one end disposed in a part of a principal surface of the first and second lid bodies 57a and 57b which face each of the second electrodes 15a and 15b of each of the membrane electrode assemblies 13a and 13b, and its other end led out toward the outer surface of each of the lid bodies 57a and 57b. It is preferable that, like the first wiring conductor 60, the second wiring conductor 61 is formed integrally with the first and second lid bodies 57a and 57b and is made 10 μm or above higher than the principal surface on a side of the second electrodes 15a and 15b of the first and second lid bodies 57a and 57b. This allows the second wiring conductor 61 to make contact with the second electrodes 15a and 15b with ease. The desired height of the second wiring conductor 61 can be achieved by adjusting the printing condition such that the conductor paste is print-coated in a larger thickness during the print-coating process as described above. Further, the second wiring conductor 61 should preferably be arranged in plural face to face with the second electrodes 15a and 15b. This helps reduce electric loss in the second wiring conductor 61. That part of the second wiring conductor 61 which penetrates through the first and second lid bodies 57a and 57b should preferably be Φ50 μm or above in diameter.

Regarding the example shown in FIG. 6, that part of the first wiring conductor 60 which is led to the outer surface of the base body 56 will be further explained. On the outer surface of the base body 56, the individual other ends of the first wiring conductors 60 are led out en masse that are respectively connected to the first electrodes 14a and 14b of the membrane electrode assemblies 13a and 13b on the bottom surfaces of the first and second concavities formed on the opposite principal surfaces of the base body 56. Moreover, the first wiring conductor 60 should preferably be arranged in plural face to face with the first electrode 14a, 14b. This helps reduce electric loss ascribable to the first wiring conductor 60. That part of the first wiring conductor 60 which penetrates through the base body 56 should preferably be set at Φ50 μm or above in diameter.

It is preferable that the first and second wiring conductors 60 and 61 each have its exposed surface coated with a highly-conductive metal material such as nickel or gold which is highly corrosion-resistant and exhibits excellent wettability with respect to a brazing filler material, using the plating method. This makes it possible to establish satisfactory electrical connection between the first and second wiring conductors 60 and 61, as well as between the first and second wiring conductors 60 and 61, first electrodes 14a and 14b, second electrodes 15a and 15b and an external electric circuit.

The first and second wiring conductors 60 and 61 can be electrically connected to the first and second electrodes 14a, 14b and 15a, 15b, respectively, by grippingly inserting the membrane electrode assembly 13a and 13b between the base body 56 and the first and second lid bodies 57a and 57b. By so doing, the first and second wiring conductors 60 and 61 are brought into pressure-contact with the first and second electrodes 14a, 14b and 15a, 15b, respectively.

In the base body 56, the first fluid channel 58 is arranged such that the openings on the bottom surfaces of the first and second concavities face each other from a part of the base body between the first and second concavities to the bottom surfaces of the first and second concavities. The first fluid channels 58 are constituted by the through holes pierced in the base body 56, or grooves. The first fluid channels 58 serve as a passage for a fluid to be supplied to the membrane electrode assemblies 13a and 13b, such as fuel gas for example hydrogen-rich reforming gas or oxidant gas for example oxygen or air, and besides serves as a passage for a fluid to be discharged from the membrane electrode assembly 13a and 13b after reactions, such as water produced through reactions.

Moreover, on the principal surface of the first/second lid body 57a, 57b facing the second electrode 15a, 15b is arranged the second fluid channel 59. The second fluid channel 59 is so formed as to extend over the outer surface of the first/second lid body 57a, 57b. The second fluid channel 59, acting as a fluid path alike to the first fluid channel 58, is created by piercing a through hole or a groove in the first/second lid body 57a, 57b.

Regarding a through hole or a groove which is pierced in the base body 56 and the first and second lid bodies 57a and 57b as the first and second fluid channels 58 and 59, the diameter and number of the through hole, or the width, depth, and arrangement of the groove are determined according to the specifications of the fuel cell 51 in such a way that a fluid such as fuel gas or oxidant gas can be evenly supplied to the membrane electrode assemblies 13a and 13b.

In the fuel cell casing 52 and the fuel cell 51 embodying the invention, the first and second fluid channels 58 and 59 should preferably have a hole diameter of Φ0.1 mm or above and be equally spaced. Alternatively, in a case of forming grooves, the first and second fluid channels 58 and 59 should preferably have a width of 0.3 mm or above and a depth of 0.1 mm or above. This allows a fluid to flow into the membrane electrode assembly 13 under uniform pressure.

In this way, the first fluid channel 58 is disposed face to face with the principal surface of the membrane electrode assemblies 13a and 13b having the first electrodes 14a and 14b, whereas the second fluid channel 59 is disposed face to face with the principal surface of the membrane electrode assembly 13a and 13b having the second electrode 15a and 15b. With this arrangement, a fluid can be exchanged between the lower and upper principal surfaces of the membrane electrode assemblies 13a and 13b and their corresponding first and second fluid channels 58 and 59, and thus the fluid can be supplied and discharged through the respective fluid path. Moreover, in the case of supplying gas as a fluid, it is possible to prevent a decrease in the partial pressure of the gas supplied to the first and second electrodes 14a and 14b and 15a and 15b of the membrane electrode assemblies 13a and 13b, and thus obtain a predetermined stable output voltage. Further, since the partial pressure of the supplied gas is stabilized, the inner pressure within the fuel cell 51 is made uniform. As a result, thermal stress occurring in the membrane electrode assemblies 13a and 13b can be suppressed, leading to enhancement of the reliability of the fuel cell 51.

With the constructions thus far described, as shown in FIG. 6, it is possible to realize the compact, sturdy fuel cell casing 52 which is capable of housing a plurality of membrane electrode assemblies 13a, 13b, and also the fuel cell 51 which is controllable with high efficiency.

FIG. 7 is a sectional view showing the fuel cell casing and the fuel cell employing it according to still another embodiment of the invention. FIG. 7 is a plan view showing the same. In FIG. 7, the same components as those of the aforementioned embodiment will be denoted by the same reference numerals, and reference numeral 51a denotes a fuel cell; reference numeral 52a denotes a fuel cell casing; reference numerals 13a and 13b denote a membrane electrode assembly; reference numerals 14a and 14b denote a first electrode; reference numerals 15a and 15b denote a second electrode; reference numeral 56 denotes a base body; reference numeral 57c denotes a first lid body; reference numeral 57d denotes a second lid body; reference numeral 58 denotes a first fluid channel; reference numeral 59 denotes a second fluid channel; reference numerals 60a and 60b denote a first wiring conductor; and reference numerals 61a and 61b denote a second wiring conductor.

In the example shown in FIG. 7, the first wiring conductor 60a has its one end opposed to the first electrode 14a of the membrane electrode assembly 13a on the bottom surface of the first concavity of the upper principal surface of the base body 56, and its other end led to the lower principal surface of the base body 56 so as to be electrically connected to the other end of the second wiring conductor 61a led to the outer surface of the second lid body 57d. Moreover, the first wiring conductor 60b has its one end opposed to the first electrode 14b of the membrane electrode assembly 13b on the bottom surface of the second concavity of the lower principal surface of the base body 56, and its other end led to the outer surface, here, the side surface, of the base body 56.

It is preferable that the first wiring conductor 60a and 60b are formed integrally with the base body 56 and is made 10 μm or above higher than each bottom surface of the first and second concavities of the base body 56. This allows one end of the first wiring conductor 60a and 60b to make contact with the first electrode 14a and 14b with ease. The desired height of the first wiring conductor 60a and 60b can be obtained by adjusting the printing condition such that the conductor paste is print-coated in a larger thickness during the print-coating process as described above. Further, the first wiring conductor 14a and 14b should preferably be arranged in plural face to face with the first electrode 14a, 14b. This helps reduce electric loss ascribable to the first wiring conductor 60a, 60b. That part of the first wiring conductor 60a, 60b which penetrate through the base body 56 should preferably be set at Φ50 μm or above in diameter.

As shown in FIGS. 6 and 7, according to the fuel cell casing 52, 52a and the fuel cell 51, 51a embodying the invention, the membrane electrode assemblies 13a and 13b are housed in the first and second concavity on both principal surfaces of the base body 56, respectively. Thereby, in the plurality of membrane electrode assemblies 13a and 13b, their respective first electrodes 14a and 14b, or their first and second electrodes 14a and 14b and 15a and 15b, are electrically connected together. Then, to obtain the overall output through the endmost membrane electrode assemblies 13a and 13b, the first and second wiring conductors 60, 60a, 60b and 61, 61a are electrically connected thereto respectively. In this case, since the first and second wiring conductors 60, 60a, 60b and 61, 61a allow free three-dimensional wiring, a plurality of membrane electrode assemblies 13a and 13b can be arbitrarily connected together in series or in parallel. This makes it possible to adjust the overall output voltage and output current with efficiency. Thus, in the fuel cell, electricity which has been electrochemically produced in a plurality of membrane electrode assemblies 13 can be externally extracted satisfactorily.

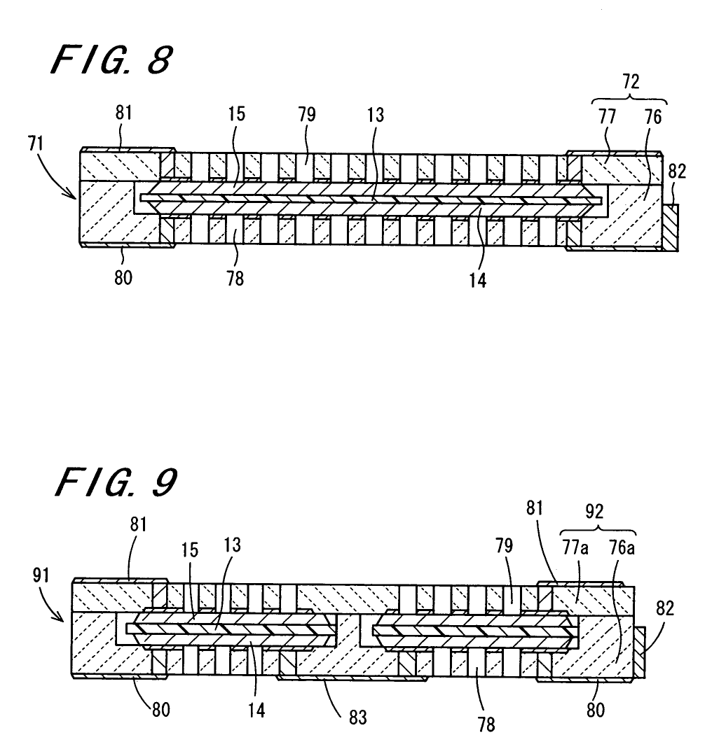

FIG. 8 is a sectional view showing one embodiment of the fuel cell which is incorporated in the electronic apparatus according to the invention.

In FIG. 8, reference numeral 71 denotes a fuel cell; reference numeral 72 denotes a fuel cell casing; reference numeral 13 denotes a membrane electrode assembly; reference numeral 14 denotes a first electrode; reference numeral 15 denotes a second electrode; reference numeral 76 denotes a base body; reference numeral 77 denotes a lid body; reference numeral 78 denotes a first fluid channel; reference numeral 79 denotes a second fluid channel; reference numeral 80 denotes a first wiring conductor; reference numeral 81 denotes a second wiring conductor; and reference numeral 82 denotes an external connection terminal. Note that this electronic apparatus refers to a portable telephone, PDA (Personal Digital Assistants), digital camera, or the like, which will be specifically described later. In this embodiment, the same components as those of the aforementioned embodiment will be denoted by the same reference numerals, and it will be omitted to describe in detail.

The fuel cell casing 72 comprises the base body 76 that has a concavity and the lid body 77, has a function of storing the membrane electrode assembly 13 inside the concavity and hermetically sealing, and is made of a ceramics material such as sintered aluminum oxide (Al₂O₃), sintered mullite (3Al₂O₃ 2SiO₂), sintered silicon carbide (SiC), sintered aluminum nitride (AlN), sintered silicon nitride (Si₃N₄) or sintered glass ceramics.

Since the fuel cell casing 72 comprises the base body 76 having a concavity and the lid body 77, and the concavity is hermetically sealed by mounting the lid body 77 around the concavity of the base body 76 so as to cover the concavity, the lid body 77 is mounted to the base body 76 by bonding with a metal bonding material such as solder or silver brazing filler, by bonding with a resin material such as epoxy, or by a method of bonding a sealant or the like made of ferroalloy or the like on the upper surface as one surface around the concavity and welding by seam weld, electron beam, laser or the like. Here, the lid body 77 may be also provided with a concavity in the manner as the base body 76. In addition, a peripheral portion of the base body and the lid body may be provided with through holes and the base body and the lid body may be mechanically secured by screwing via the through holes.

The base body 76 and the lid body 77 are made to be thin, respectively, and in order to enable low-profiling of the fuel cell 71, it is preferable that flexural strength as mechanical strength is 200 MPa or more.

It is preferable that the base body 76 and the lid body 77 are made of ceramics material of a close-packed substance whose relative density is 95% or more, for example. In a case of sintered aluminum oxide, for example, in the case of sintered aluminum oxide, firstly, rare-earth oxide powder and sintering aids are added and mixed into aluminum oxide powder, and powder materials of sintered aluminum oxide is prepared. Secondly, an organic binder and a dispersion medium are added and mixed into the powder materials of aluminum oxide sinter to make paste, and by a doctor blade method, or by adding an organic binder into the powder materials and conducting press-molding, roll-molding or the like, a green sheet having specified thickness is manufactured from the paste. Then, by punching with a die, a microdrill, a laser, or the like, through holes as the first fluid channels 78 and the second fluid channels 79, openings as fluid passages and through holes for disposing the first connection conductors 80 and the second connection conductors 81 are formed on the green sheet. The first and second fluid channels 78 and 79 may be grooves of outer layers or inner layers, formed by punching by means of a die or press molding.

In a case of using sintered aluminum oxide as ceramics material, the first and second wiring conductors 80 and 81 should preferably be composed of tungsten and/or molybdenum to prevent oxidation. In this case, for example, as an inorganic substance, Al₂O₃ in an amount of 3 to 20% by mass and Nb₂O₅ in an amount of 0.5 to 5% by mass is added to 100 mass percent tungsten and/or molybdenum powder to form a conductor paste. The conductor paste is filled in the through hole pierced in the green sheet to form a via hole acting as a through conductor.

Into the conductor paste, for the purpose of increasing close adhesion of the base body 76 and the lid body 77 to ceramics, aluminum oxide powder or powder of the same composite with a ceramics component forming the base body 76 and the lid body 117 can be added, for example, in the ratio of 0.05-2 volume %.

The first and second wiring conductors 80 and 81 are formed in the outer and inner layers of the base body 76 and the lid body 77 before, after, or concurrently with the formation of the via conductor achieved by filling the conductor paste into the through hole. The formation of the wiring conductors is achieved by print-coating a similar conductor paste in a predetermined pattern on the green sheet in accordance with the screen printing method, gravure printing method, or the like method.

Thereafter, a predetermined number of sheet-like molded bodies carrying the printed, filled conductor paste are subjected to positional alignment, and are then stacked on top of each other under pressure. The stacked body is then fired, in a non-oxidative atmosphere, at a high temperature of approximately 1200 to 1500° C. Thereby, the desired ceramic base body 76, the lid body 77, and the first and second wiring conductors 80 and 81 are obtained.

Moreover, the external connection terminal 82 is bonded to at least one of the base body and the lid body by soldering, brazing, or the like method. The external connection terminal 82 should preferably be designed in the shape which will establish satisfactory electrical connection between it and a motherboard for constituting an electronic circuit which forms the heart of the electronic apparatus. Preferably, by adopting a rod shape, a hook shape, or a conical shape, the external connection terminal 82 can be electrically and mechanically connected with ease to the electronic circuit forming the heart of the electronic apparatus by terminal-to-terminal contact or terminal insertion. It is desirable that, to receive the external connection terminal 82, an engagement portion (a hole, for example) be formed in that part of the electronic circuit forming the heart of the electronic apparatus to which the external connection terminal 82 is connected. Further, by arranging the external connection terminal 82 on the side surface of the base or lid body, the electronic apparatus can be made lower in profile.

Further, it is preferable that the base body 76 and the lid body 77 made of ceramics have thickness of 0.2 mm or more.

In a case where the thickness is less than 0.2 mm, because the strengths are apt to cover, the base body 76 and the lid body 77 tend to be easily cracked by stress caused when the base body 76 and the lid body 77 are mounted. On the other hand, in a case where the thickness is more than 5 mm, because slenderizing and low-profiling are difficult, it is hard to use as a fuel cell installed in small mobile equipment, and because a thermal capacity is large, it is likely to become hard to instantly set to appropriate temperature corresponding to an electrochemical reaction condition of the membrane electrode assembly 13.

The first wiring conductor 80 and the second wiring conductor 81 are electrically connected to the first electrode 14 and the second electrode 15, respectively, of the membrane electrode assembly 13 so as to function as current-carrying paths for extracting currents generated in the membrane electrode assembly 13 out of the fuel cell casing 72.

The first wiring conductor 80 has its one end opposed to the first electrode 14 of the membrane electrode assembly 13 on the bottom surface of the concavity of the base body 76, and its other end led to the outer surface of the base body 76. As described above, it is preferable that the first wiring conductor 80 is formed integrally with the base body 76 and is made 10 μm or above higher than the bottom surface of the concavity of the base body 76. This allows the first wiring conductor 80 to make contact with the first electrode 14 with ease. The desired height of the first wiring conductor 80 can be obtained by adjusting the printing condition such that the conductor paste is print-coated in a larger thickness during the print-coating process as described above.

The first wiring conductor 80 should preferably be arranged in plural face to face with the first electrode 14.

This helps reduce electric loss ascribable to the first wiring conductor 80. That part of the first wiring conductor 80 which penetrates through the base body 76 should preferably be set at Φ50 μm or above in diameter.

The second wiring conductor 81 has its one end opposed to the second electrode 15 of the membrane electrode assembly 13 on the lower surface of the lid body 77, and its other end led to the outer surface of the lid body 77. It is preferable that, like the first wiring conductor 80, the second wiring conductor 81 is also formed integrally with the lid body 77 and is made 10 μm or above higher than the lower surface of the lid body 77. This allows the second wiring conductor 81 to make contact with the second electrode 15 with ease. The desired height of the second wiring conductor 81 can be obtained by adjusting the printing condition such that the conductor paste is print-coated in a larger thickness during the print-coating process as described above.

The second wiring conductor 81 should preferably be arranged in plural face to face with the second electrode 15. This helps reduce electric loss ascribable to the second wiring conductor 81. That part of the second wiring conductor 81 which penetrates through the lid body 77 should preferably be set at Φ50 μm or above in diameter.

It is preferable that each of the first and second wiring conductors 80 and 81 and the external connection terminal 82 has its exposed surface coated with a highly-conductive metal material such as nickel, copper, gold, platinum, or palladium which is highly corrosion-resistant and exhibits excellent wettability with respect to a brazing filler material, using the plating method. This makes it possible to enhance the electrical connection established among the first wiring conductor 80, the second wiring conductor 81, the external connection terminal 82, the motherboard for constituting the electronic circuit which forms the heart of the electronic apparatus, etc.

The first and second wiring conductors 80 and 81 can be electrically connected to the first and second electrodes 14 and 15, respectively, by allowing the base body 76 and the lid body 77 to have sandwiched therebetween the membrane electrode assembly 13. That is, the first and second wiring conductors 80 and 81 are brought into pressure-contact with the first and second electrodes 14 and 15, respectively, thus achieving electrical connection therebetween.

Arranged on the bottom surface of the concavity of the base body 76 facing the first electrode 14 and on the lower surface of the lid body 77 facing the second electrode 15 are the first fluid channel 78 and the second fluid channel 79, respectively. The first fluid channel 78 is so formed as to extend over the outer surface of the base body 76, whereas the second fluid channel 79 is so formed as to extend over the outer surface of the lid body 77. The first and second fluid channels 78 and 79 are constituted by piercing through holes or grooves in the base body 76 and the lid body 77. The first and second fluid channels 78 and 79 each serve as a passage for a fluid material, such as fuel gas for example hydrogen-rich reforming gas or oxidant gas for example air, which is supplied to the membrane electrode assembly 13, or serve as a passage for a fluid material, such as water produced through reactions, which is discharged from the membrane electrode assembly 13 after reactions.

Regarding a through hole or a groove which is pierced in the base body 76 and the lid body 77 as the first and second fluid channels 78 and 79, the diameter and number of the through hole, or the width, depth, and arrangement of the groove are determined according to the specifications of the fuel cell 71 in such a way that a fluid material such as fuel gas or oxidant gas can be evenly supplied to the membrane electrode assembly 13.

In the fuel cell casing 72 and the fuel cell 71 embodying the invention, the first and second fluid channels 78 and 79 should preferably have a hole diameter of Φ0.1 mm or above and be equally spaced. This allows a fluid material to flow into the membrane electrode assembly 13 under uniform pressure.

In this way, the first fluid channel 78 is disposed face to face with the lower principal surface of the membrane electrode assembly 13 having the first electrode 14 thereon, whereas the second fluid channel 79 is disposed face to face with the upper principal surface of the membrane electrode assembly 13 having the second electrode 15 thereon. With this arrangement, a fluid material can be exchanged between the lower and upper principal surfaces of the membrane electrode assembly 13 and their corresponding first and second fluid channels 78 and 79, and the fluid material can be supplied or discharged through the respective fluid paths. Moreover, in the case of supplying gas as a fluid material, it is possible to prevent a decrease in the partial pressure of the gas supplied to the first and second electrodes 14 and 15 of the membrane electrode assembly 13, and thus obtain a predetermined stable output voltage. Further, since the partial pressure of the supplied gas is stabilized, the inner pressure of the fuel cell 71 is made uniform. As a result, a thermal stress occurring in the membrane electrode assembly 13 can be suppressed, leading to enhancement of the reliability of the fuel cell 71.

With the constructions thus far described, as shown in FIG. 8, it is possible to realize the compact, sturdy fuel cell casing 72 which is capable of housing the membrane electrode assembly 13, and also the fuel cell 71 to be incorporated in the electronic apparatus of the invention that is controllable with high efficiency.

FIGS. 9 through 12 are sectional views showing still another embodiment of the fuel cell which is incorporated in the electronic apparatus according to the invention.

In these figures, reference numerals 91, 101, 111, and 121 denote a fuel cell; reference numerals 92, 102, 112, and 122 denote a fuel cell casing; reference numeral 13 denotes a membrane electrode assembly; reference numeral 14 denotes a first electrode; reference numeral 15 denotes a second electrode; reference numerals 76 and 76a denote a base body; reference numerals 77 and 77a denote a lid body; reference numeral 78 denotes a first fluid channel; reference numeral 79 denotes a second fluid channel; reference numeral 80 denotes a first wiring conductor; reference numeral 81 denotes a second wiring conductor; reference numeral 82 denotes an external connection terminal; reference numeral 83 denotes a third wiring conductor; reference numeral 84 denotes a fourth wiring conductor; reference numeral 85 denotes a fifth wiring conductor; reference numeral 86 denotes a sixth wiring conductor; reference numeral 87 denotes a seventh wiring conductor; and reference numeral 88 denotes an eighth wiring conductor.

Note that, In this embodiment, the same components as those of the aforementioned embodiment will be denoted by the same reference numerals, and it will be omitted to describe in detail.

The fuel cell 91 shown in FIG. 9 is analogous to the fuel cell 11 shown in FIG. 1. The third wiring conductor 83, which is formed integrally with the base body 76a, has its one end opposed to the first electrode 14 of the membrane electrode assembly 13 on the bottom surface of one of the plurality of concavities of the base body 76a, and its other end opposed to the first electrode 14 of the other membrane electrode assembly 13 on the bottom surface of the other of a plurality of concavities. The third wiring conductor 83 should preferably be made 10 μm or above higher than the bottom surface of the concavity of the base body 76a. This allows both ends of the third wiring conductor 83 to make contact with the first electrode 14 with ease. The desired height of the third wiring conductor 83 can be obtained by adjusting the printing condition such that the conductor paste is print-coated in a larger thickness during the print-coating process as described above. Further, the third wiring conductor 83 should preferably be arranged in plural face to face with the first electrode 14. This helps reduce electric loss ascribable to the third wiring conductor 83. That part of the third wiring conductor 83 which penetrates through the base body 76a should preferably be set at Φ50 μm or above in diameter.

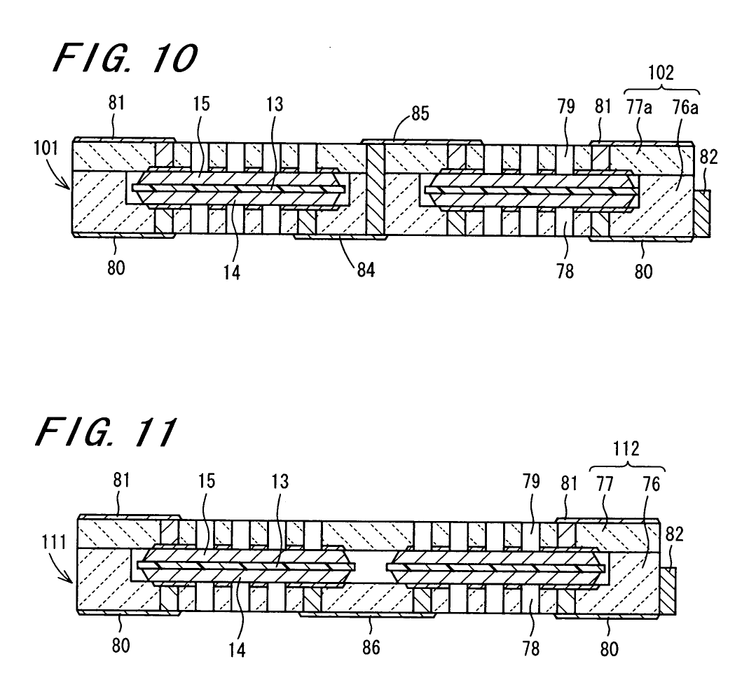

The fuel cell 101 shown in FIG. 10 is analogous to the fuel cell 11a shown in FIG. 2. The fourth wiring conductor 84 has its one end opposed to the first electrode 14 of the membrane electrode assemblies 13 on bottom surface of one of a plurality of concavities of the base body 76a, and its other end led to the top surface of the base body 76a on which the lid body 77a is mounted. Moreover, the fifth wiring conductor 85 has its one end opposed to the second electrode 15 of the other membrane electrode assembly 13 of one of the plurality of concavities on the lower surface of the lid body 77a, and its other end led to the lower surface of the lid body 77a which is mounted on the top surface of the base body 76a, so as to face the other end of the fourth wiring conductor 84.

It is preferable that, like the third wiring conductor 83, the fourth wiring conductor 84 is also formed integrally with the base body 76a and is made 10 μm or above higher than the bottom surface of the concavity of the base body 76a. This allows one end of the fourth wiring conductor 84 to make contact with the first electrode 14 with ease. The desired height of the fourth wiring conductor 84 can be obtained by adjusting the printing condition such that the conductor paste is print-coated in a larger thickness during the print-coating process as described above. Further, the fourth wiring conductor 84 should preferably be arranged in plural face to face with the first electrode 14. This helps reduce electric loss ascribable to the fourth wiring conductor 84. That part of the fourth wiring conductor 84 which penetrates through the base body 76a should preferably be set at Φ50 μm or above in diameter.

It is preferable that, like the second wiring conductor 81, the fifth wiring conductor 85 is also formed integrally with the lid body 77a and is made 10 μm or above higher than the lower surface of the lid body 77a. This allows one end of the fifth wiring conductor 85 to make contact with the second electrode 15 with ease. The desired height of the fifth wiring conductor 85 can be obtained by adjusting the printing condition such that the conductor paste is print-coated in a larger thickness during the print-coating process as described above. Further, the fifth wiring conductor 85 should preferably be arranged in plural face to face with the second electrode 15. This helps reduce electric loss ascribable to the fifth wiring conductor 85. That part of the fifth wiring conductor 85 which penetrates through the lid body 77a should preferably be set at Φ50 μm or above in diameter.

The fuel cell 111 shown in FIG. 11 is analogous to the fuel cell 31 shown in FIG. 3. The sixth wiring conductor 86, which is formed integrally with the base body 76, has its one end opposed to the first electrode 14 of one of the plurality of membrane electrode assemblies 13 on the bottom surface of the concavity of the base body 76, and its other end opposed to the first electrode 14 of the other of the plurality of membrane electrode assemblies 13 on the bottom surface of the same concavity.

It is preferable that the sixth wiring conductor 86 is made 10 μm or above higher than the bottom surface of the concavity of the base body 76. This allows both ends of the sixth wiring conductor 86 to make contact with the first electrode 14 with ease. The desired height of the sixth wiring conductor 86 can be obtained by adjusting the printing condition such that the conductor paste is print-coated in a larger thickness during the print-coating process as described above. Further, the sixth wiring conductor 86 should preferably be arranged in plural face to face with the first electrode 14. This helps reduce electric loss ascribable to the sixth wiring conductor 86. That part of the sixth wiring conductor 86 which penetrates through the base body 76 should preferably be set at Φ50 μm or above in diameter.

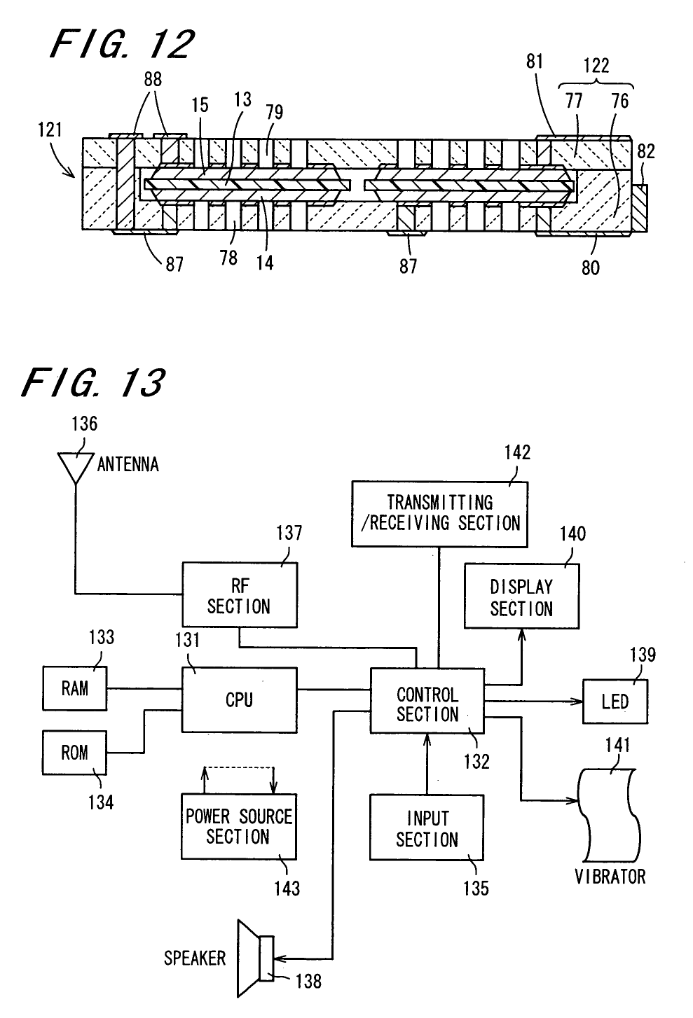

The fuel cell 121 shown in FIG. 12 is analogous to the fuel cell 31a shown in FIG. 4. The seventh wiring conductor 87 has its one end opposed to the first electrode 14 of one of a plurality of membrane electrode assemblies 13 on the bottom surface of the concavity of the base body 76, and its other end led to the top surface of the base body 76 on which the lid body 77 is mounted. Moreover, the eighth wiring conductor 88 has its one end opposed to the second electrode 15 of the other of a plurality of membrane electrode assemblies 13 on the lower surface of the lid body 77, and its other end led to the lower surface of the lid body 77 which is mounted on the top surface of the base body 76, so as to face the other end of the seventh wiring conductor 87.

It is preferable that, like the third wiring conductor 83, the seventh wiring conductor 87 is also formed integrally with the base body 76 and is made 10 μm or above higher than the bottom surface of the concavity of the base body 76. This allows one end of the seventh wiring conductor 87 to make contact with the first electrode 14 with ease. The desired height of the seventh wiring conductor 87 can be obtained by adjusting the printing condition such that the conductor paste is print-coated in a larger thickness during the print-coating process as described above. Further, the seventh wiring conductor 87 should preferably be arranged in plural face to face with the first electrode 14. This helps reduce electric loss ascribable to the seventh wiring conductor 87. That part of the seventh wiring conductor 87 which penetrates through the base body 76 should preferably be set at Φ50 μm or above in diameter.

It is preferable that, like the second wiring conductor 81, the eighth wiring conductor 88 is also formed integrally with the lid body 77 and is made 10 μm or above higher than the lower surface of the lid body 77. This allows one end of the eighth wiring conductor 88 to make contact with the second electrode 15 with ease. The desired height of the eighth wiring conductor 88 can be obtained by adjusting the printing condition such that the conductor paste is print-coated in a larger thickness during the print-coating process as described above. Further, the eighth wiring conductor 88 should preferably be arranged in plural face to face with the second electrode 15. This helps reduce electric loss ascribable to the eighth wiring conductor 88. That part of the eighth wiring conductor 88 which penetrates through the lid body 77 should preferably be set at Φ50 μm or above in diameter.

As shown in FIGS. 9 and 10, according to the fuel cell casing 92, 102 and the fuel cell 91, 101 that are incorporated in the-electronic apparatus embodying the invention, the membrane electrode assembly 13 is housed in each of the plurality of concavities of the base body 76a. Moreover, the third wiring conductor 83, or the fourth and fifth wiring conductors 84 and 85, is/are disposed so as to extend across the region between the adjacent concavities. Thereby, in a plurality of membrane electrode assemblies 13, their respective first electrodes 14, or their first and second electrodes 14 and 15, are electrically connected together. Then, to obtain the overall output through the endmost membrane electrode assemblies 13, the first and second wiring conductors 80 and 81 are electrically connected thereto respectively. In this case, since the first to third wiring conductors 80, 81, and 83, as well as the first, second, fourth, and fifth wiring conductors 80, 81, 84, and 85, allow free three-dimensional wiring, a plurality of membrane electrode assemblies 13 can be arbitrarily connected together in series or in parallel. This makes it possible to adjust the overall output voltage and output current with efficiency. Thus, in the fuel cell, electricity which has been electrochemically produced in a plurality of membrane electrode assemblies 13 can be externally extracted satisfactorily.

As shown in FIGS. 11 and 12, according to the fuel cell casing 112, 122 and the fuel cell 111, 121 that are incorporated in the electronic apparatus embodying the invention, a plurality of membrane electrode assemblies 13 are housed in the concavity of the base body 76, and the sixth wiring conductor 86, or the seventh and eighth wiring conductors 87 and 88, is/are disposed. Thereby, in a plurality of membrane electrode assemblies 13, their respective first electrodes 14, or their first and second electrodes 14 and 15, are electrically connected together. Then, to obtain the overall output through the endmost membrane electrode assemblies 13, the first and second wiring conductors 80 and 81 are electrically connected thereto respectively. In this case, since the first, second, and sixth wiring conductors 80, 81, and 86, as well as the first, second, seventh, and eighth wiring conductors 80, 81, 87, and 88, allow free three-dimensional wiring, a plurality of membrane electrode assemblies 13 can be arbitrarily connected together in series or in parallel. This makes it possible to adjust the overall output voltage and output current with efficiency. Thus, in the fuel cell, electricity which has been electrochemically produced in a plurality of membrane electrode assemblies 13 can be externally extracted satisfactorily.

It should be noted that the invention need not be limited to the above-described embodiments and examples, and therefore various changes and modifications are possible without departing from the spirit or scope of the invention. For example, the first and second fluid channels may alternatively be constructed by forming an inlet on the side surface of the base body or the lid body. In this case, the entire fuel cell is made lower in profile, and the down-sized fuel cell is accordingly suited for a portable electronic apparatus.

Moreover, the other ends of the first and second wiring conductors may be led out over the side surfaces of the base body and the lid body, respectively, that are located on the same side, instead of being led out over the outer surfaces thereof, respectively, and the external connection terminal may be put together. In this case, the wiring lines, the channels, etc. can be put together only on one side of the fuel cell. This helps facilitate miniaturization and protection of the externally-connected portions. Thus, the fuel cell can be designed with high reliability and accordingly operated with stability for a longer period of time.

Next, a description will be given below as to the electronic apparatus embodying the invention that incorporates the above-described fuel cell as a power source. Being equipped with the fuel cell as a power source, the electronic apparatus of the invention is made compact and lower in profile, is operated with stability for a longer period of time, and is excellent in safety and convenience. Various advantages brought about by the electronic apparatus will be set forth hereinbelow.

According to the electronic apparatus of the invention, in the fuel cell acting as a power source, the external connection terminal 82 (the terminal with positive and negative polarities) can be electrically connected to the circuit board of the electronic apparatus with ease, and can also be detached and attached freely. Thus, for example, the fuel cell can be replaced with a new one without any difficulty, thus attaining remarkable convenience.

Moreover, by employing, as a power source, the fuel cell and fuel cell casing composed of the multilayer ceramic-made base body 76, 76a, electrical wiring can be carried out freely in the fuel cell, and thereby a plurality of fuel cells are readily connected in series with one another. As a result, the electronic apparatus succeeds in miniaturization, low-profile styling, and weight reduction.

Further, since the base body 76, 76a is made of multi-layer ceramics, resistance, capacitance, and inductance can be created within the base body 76, 76a.

For example, by forming high-volume capacitance within the base body 76, 76a alongside the fuel cell, when the current fed from the fuel cell is in short supply, the shortage of the current can be compensated for successfully; wherefore the desired current supply appropriate to the target output current can be secured. Similarly, by using resistance, capacitance, and inductance, a voltage-boosting circuit can be formed; wherefore a voltage necessary for the electronic apparatus can be secured.

Note that, in the case of forming resistance, capacitance, and inductance within the base body 76, 76a in that way, the base body 76, 76a should preferably be made of sintered glass ceramics.

Note that, sintered glass ceramics is made of a glass component and a filler component, these components are the same as those of the aforementioned embodiment, and it will be omitted to describe in detail.

Further, it is preferable that the mixture ratio of the glass and the filler is 40:60 to 99:1 in mass ratio.

As an organic binder blended in a glass ceramic green sheet, one that has been used in a ceramic green sheet so far can be used, and it is, for example, a homopolymer or a copolymer of acrylic-base (a homopolymer or a copolymer of acrylic acid, methacrylic acid or ester thereof, concretely, an acrylic acid ester copolymer, a methacrylic acid ester copolymer, acrylic acid ester—methacrylic acid ester copolymer or the like), polyvinyl butyral-base, polyvinyl alcohol-base, acrylic-styrene-base, polypropylene carbonate-base, cellulose-base or the like.

A glass ceramic green sheet is obtained by adding a specified amount of plasticizer, a solvent (an organic solvent, water or the like) into the glass powder, the filler powder and the organic binder as necessary to obtain slurry, and molding this by doctor blade, rolling, calendar rolling, die pressing or the like to thickness of approximately 50 to 500 μm.

A conductor pattern is formed on the surface of a glass ceramic green sheet, for example, by printing paste of conductor material powder by a screen printing method, a gravure printing method or the like, or by transferring metal foil of a specified pattern shape. A conductor material is of, for example, one kind or two or more kinds selected from Au, Ag, Pd, Pt or the like, and in the case of containing two or more kinds, it may be any shape of mixture, alloy, coating or the like.

Further, in a case where a large-capacity capacitance is formed, for example, a layer made of inorganic substance powder that has high dielectric constant such as barium titanate (referred to as a barium titanate layer hereafter) is formed inside a base body 76, 76a made of glass ceramics. In this case, it is manufactured by firstly forming slurry that contains ceramic powder and glass powder to obtain a plurality of green sheets, subsequently printing metal paste to become a lower electrode layer on the green sheet, subsequently printing dielectric paste made of barium titanate or the like on the lower electrode layer by screen printing to form a dielectric layer, further printing metal pate on the dielectric layer to form an upper electrode layer, stacking these green sheets, and firing this stacked body.

Further, in a case where a resistor is formed inside the base body 76, 76a, it can be formed by print-applying resistor paste whose principal ingredients are RuO₂, IrO₂, RhO₂, SnO₂, LaB₆ and the like to the green sheet in a specified pattern by a method such as screen printing, gravure printing or the like by the same method as the first wiring conductor 80 and the second wiring conductor 81.

Further, it is good that an internal circuit is formed in the base body 76, 76a of the fuel cell 71, 91, 101, 111, 121.

Consequently, it is possible to mount an electronic part electrically connected to the internal circuit on the surface of the base body 76, 76a. Therefore, it is possible to increase functionality of electronic apparatus by the electronic part mounted on the surface of the base body 76, 76a.

Further, it is good that an electronic part electrically connected to the internal circuit is disposed to the surface of the base body 76, 76a of the fuel cell 1. Consequently, by using a sensor, a control IC or the like as the electronic part and detecting the density of fuel inside the fluid channels 78, 79 by a density sensor, optimum circulation, fuel dilution, and suppress of decrease of fuel use efficiency are enabled. In addition, by using electronic parts, a boosting circuit can be formed, it becomes possible to control a voltage necessary for electronic apparatus. Further, by using a temperature sensor or the like, it becomes possible to manage and control the temperature of the membrane electrode assembly.

It is possible to mount an electronic part electrically connected to the internal circuit on the surface of the base body 76, 76a or the lid body 71, 91, 101, 111, 121. Therefore, it is possible to increase functionality of the electronic apparatus by the electronic part mounted on the surface of the base body 76, 76a. Consequently, by mounting a sensor, a control IC or the like as the electronic component on the base body 76, 76a, optimum circulation, dilution of fuel, and prevention of decrease of fuel use efficiency are enabled by, for example, detecting the density of fuel in the fluid channels 78, 79 by a density sensor.

Further, it is good that, in the fuel cell 71, 91, 101, 111, 121 piezoelectric pumps, that is, micropumps using a piezoelectric material such as lead zirconate titanate (PZT; composition formula: Pb (Zr, Ti) O₃) are disposed in at least either the first fluid channels 78 or the second fluid channels 79. Consequently, the small piezoelectric pumps prevent backflow of fuel, with the result that it is possible to prevent unused fuel from being polluted by a reactant or the like, and it is possible to avoid that residual air affects an operation of electronic apparatus because the residual air is discharged. Besides, fuel is constantly supplied, with the result that electric power is stably generated, and actuation time is shortened because fuel is smoothly supplied.

The piezoelectric pump is constituted by an influx portion, a variable volume portion, and an efflux portion. Then, the variable volume portion can be manufactured by, for example, disposing a piezoelectric material outside the first and second fluid channels 78, 79, and by the use of expansion and contraction of the piezoelectric material responsive to an applied voltage, it is possible to vibrate upper regions of the first and second fluid channels 78, 79. Consequently, it can vary the volumes of the first and second fluid channels 78, 79, and can function as a pump.

Further, the influx portion and the efflux portion are formed by the first and second fluid channels 78, 79 connected to the variable volume portion, and they are for letting fuel flow into and out of the variable volume portion. It is preferable that the sectional area of the efflux portion is larger than the sectional area of the influx portion. Consequently, pressure of fuel of the efflux portion becomes small, and in the case of causing the variable volume portion to function as a pump, fuel flows toward the efflux portion where pressure is small, and it is possible to send fuel in a specific direction in a good manner. Backflow prevention valves that prevent backflow of fuel may be disposed to the influx portion and the efflux portion.

Such a piezoelectric pump is made of an organic or inorganic piezoelectric material, and can be manufactured by bonding this piezoelectric material after firing a ceramic green sheet to become the base body 76, 76a or the lid body 77, 77a or, in the case of using a ceramic piezoelectric material such as PZT, mounting the ceramic piezoelectric material in a specified position of a ceramic green sheet and thereafter firing at the same time.

Further, the fuel cell 71, 91, 101, 111, 121 are excellent in reliability and safety because, other than the first and second wiring conductors 80, 81 whose one ends are disposed inside the housing, nothing comes in electric contact with the membrane electrode assembly 13 itself uselessly.

On the basis of the above, according to the electronic apparatus of the invention, it is possible to provide electronic apparatus that is excellent in compactness, convenience and safety and capable of stable operation over the long run by equal supply of fluids and highly efficient electrical connection.

Then, in concrete, the electronic apparatus of the invention is mobile electronic apparatus such as a mobile phone, a PDA (personal digital assistant), a digital camera or video camera or a toy such as a game machine, and electronic apparatus that includes a laptop PC (personal computer) such as a printer, a facsimile, a television, a communication apparatus, an audio video apparatus, various kinds of household electric appliances such as an electric fan, or a machine tool of portable type.

In recent years, electronic apparatus that additionally has a function of displaying a moving image using a liquid crystal display apparatus or the like has been used. Since such moving image display requires considerably large power consumption, electronic apparatus that uses a conventional storage battery becomes incapable of operating in a short time period, whereas the electronic apparatus of the invention is provided with a fuel cell that can supply a power source for a considerably long time period, and therefore, it is capable of operating for a long time period even in the case of displaying a moving image.

For example, in a case where the electronic apparatus of the invention is a mobile phone, as shown in a block diagram of FIG. 13, it comprises a central processing unit (CPU) 131, a control portion 132, a random access memory (RAM) 133, a read only memory (ROM) 134, an input portion 135 that inputs data operated by the user to the CPU 131, an antenna 136, a radio portion 137 (RF portion) that demodulates a signal received by the antenna 136 and supplies to the control portion 132 as well as modulates a signal supplied from the control portion 132 and transmits from the antenna 136, a speaker 138 that rumbles based on a rumbling signal from the control portion 132, a light emitting diode (LED) 139 that turns on, turns off or flashes by control from the control portion 132, a display portion 140 that displays information by a signal from the control portion 132, a vibrator 141 that vibrates by a driving signal from the control portion 132, a transmission/reception portion 142 that converts a voice of the user to a voice signal and transmits to the control portion 132 as well as converts a voice signal from the control portion 132 to a voice and outputs, and a power source portion 143 that supplies power sources to the respective portions, and the fuel cell and the fuel cell casing of the invention are built in the power source portion 143.

In this case, the fuel cell and the fuel cell casing of the invention are excellent in compactness, convenience and safety, and are capable of equal supply of fuel and power source supply for a long time period by highly efficient electrical connection, whereby miniaturization, low-profiling and weight reduction of a mobile phone are enabled.

Further, considering that a recent mobile phone is miniaturized and low-profiled enough, it is possible to additionally install an electronic part that has a function of a camera, a video or the like other than a function of a telephone into a space made by miniaturizing and low-profiling a fuel cell in the above manner, and it is possible to promote multifunction.

Further, instead of newly installing an electronic part, it is also possible to dispose a shock absorber, a preventive member or the like so as to protect a major electronic circuit. In this case, it is also possible to make a structure that can possibly strengthen than ever shock-resistance when a mobile phone main body is shocked by a fall or the like, a waterproof characteristic at the time of use in the rain or the like.

Further, as a result of miniaturizing an electric circuit portion inside a mobile phone main body, restrictions on the outer shape of a mobile phone main body decrease, and it becomes possible to form a mobile phone in an outer shape that is excellent in design, for example, a shape that enables elderly people and children to hold with ease.

Further, in a case where the structure of the power source portion 70 is a structure that the fuel cell and the fuel cell casing can be freely attached and detached as described above, it is possible, by preparing a spare fuel cell and fuel cell casing, to easily replace to a spare fuel cell and fuel cell casing or take out a fuel cell to replenish and replace fuel in case of battery shutoff or the like, so that it is possible to continuously speak on the phone, and the phone becomes more excellent in convenience than conventional one that uses a storage battery as a power source.

Further, since a replaced (used) fuel cell can be instantly reused after replenished with fuel, it is easier to use than a charging type, and it is possible to effectively use resources. Moreover, there is a merit that it is possible to use even in case of emergency such as blackout for a long time period due to natural disasters and even outdoors.

Further, a laptop PC (personal computer) is made by a basic constitution of comprising a personal computer main body, a first box that contains a keyboard for inputting specified data to the personal computer main body, and a second box that contains a display for displaying data inputted by the keyboard or data processed by the personal computer main body, attaching the second box to the first box so as to be openable and closable, and forming a power source portion that supplies power sources to the respective portions in the first box, and the fuel cell and the fuel cell casing of the invention are installed in the power source portion. In this case, as in the aforementioned mobile phone, the fuel cell and the fuel cell casing installed in the electronic apparatus of the invention are excellent in compactness, convenience and safety and are capable of equal supply of fuel and power source supply for a long time period by highly efficient electrical connection, so that miniaturization, low-profiling and weight reduction of a laptop PC (personal computer) main body and making it multifunction are enabled, and it is possible to realize a highly convenient laptop PC (personal computer) that is capable of stable supply of a large electric current for a long time period and that has a display easy to look and reduces burdens of weight and volume at the time of carrying, in response to a large and high-resolution display.

Further, in a case where the structure of the power portion is a structure that the fuel cell and the fuel cell casing of the invention are freely attached and detached, by preparing a spare fuel cell and fuel cell casing of the invention, there is a merit that under the condition of using with only a secondary battery outdoors or in a mobile unit such as an airplane, it becomes possible to supply electric power for a longer time period than ever dramatically. Moreover, in the case of using in a public space, it is outstandingly excellent in convenience and can be used without restrictions because it is excellent in safety.

The invention is not limited to the above embodiments and can be changed in various manners in the scope of the invention. For example, a DMFC that uses methanol as fuel is used as a fuel cell in the above embodiments. However, a fuel cell that uses various kinds of liquids including dimethyl ether as fuel can be also used. In the DMFC, a fuel cell that uses reformed hydrogen obtained from methanol by using a compact reforming device as fuel can be also used.

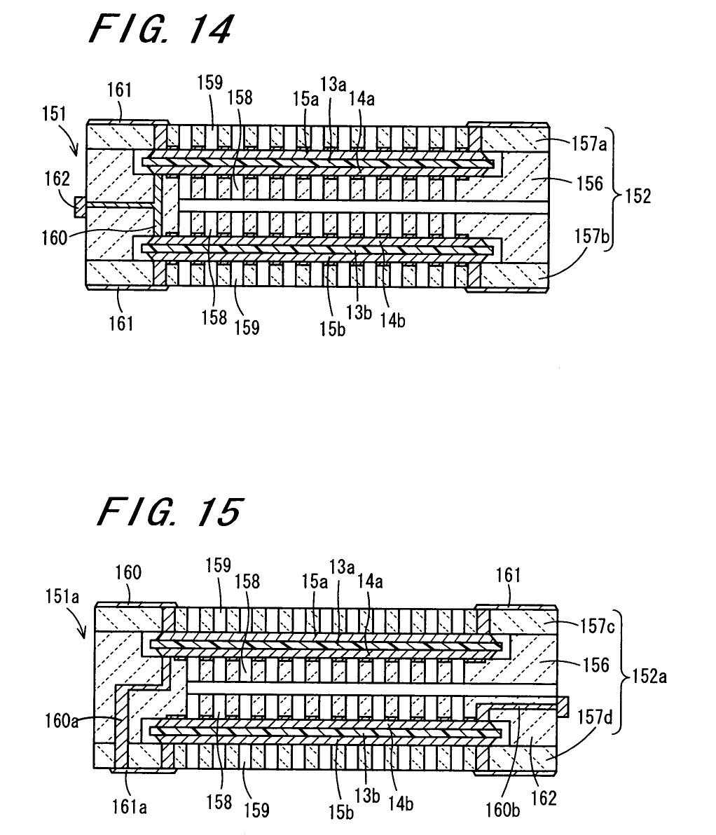

FIG. 14 is a sectional view showing still another embodiment of the fuel cell which is incorporated in the electronic apparatus according to the invention. In FIG. 14, reference numeral 151 denotes a fuel cell; reference numeral 152 denotes a fuel cell casing; reference numerals 13a and 13b denote a membrane electrode assembly; reference numerals 14a and 14b denote a first electrode; reference numerals 15a and 15b denote a second electrode; reference numeral 156 denotes a base body; reference numerals 157a and 157b denote a lid body (a first and a second lid body); reference numeral 158 denotes a first fluid channel; reference numeral 159 denotes a second fluid channel; reference numeral 160 denotes a first wiring conductor; reference numeral 161 denotes a second wiring conductor; and reference numeral 162 denotes an external connection terminal. Note that this electronic apparatus refers to a portable telephone, PDA (Personal Digital Assistants), digital camera, or the like. In this embodiment, the same components as those of the aforementioned embodiment will be denoted by the same reference numerals, and it will be omitted to describe in detail.

The fuel cell casing 152 of the invention comprises the base body 156 having a first concavity on an upper principal surface and a second concavity on a lower principal surface, the first lid body 157a mounted on an upper surface of the base body 156 near the first concavity so as to cover the first concavity, and a second lid body 157b mounted on a lower surface of the base body 156 near the second concavity so as to cover the second concavity. The fuel cell casing 152 has a function of storing the membrane electrode assembly 13a and 13b inside the first and second concavity and hermetically sealing, and is made of a ceramics material such as sintered aluminum oxide (Al₂O₃), sintered mullite (3Al₂O₃.2SiO₂), sintered silicon carbide (SiC), sintered aluminum nitride (AlN), sintered silicon nitride (Si₃N₄) or sintered glass ceramics.

Since the fuel cell casing 152 comprises the base body 156 having a first and second concavity and the first and second lid bodies 157a, 157b and the concavity is hermetically sealed by mounting the first and second lid bodies 157a, 157b around the first and second concavity of the base body 16 so as to cover the concavity, the first and second lid bodies 157a and 157b are mounted to the base body 156 by bonding with a metal bonding material such as solder or silver brazing filler, by bonding with a resin material such as epoxy, or by a method of bonding a sealant or the like made of ferroalloy or the like on the upper surface as one surface around the concavity and welding by seam weld, electron beam, laser or the like. Here, the first and second lid bodies 157a, 157b may be also provided with a concavity in the manner as the base body 156. In addition, a peripheral portion of the base body and the lid body may be provided with through holes and the base body and the lid body may be mechanically secured by screwing via the through holes.

The base body 156 and the first and second lid bodies 157a, 157b are made to be thin, respectively, and in order to enable low-profiling of the fuel cell 151, it is preferable that flexural strength as mechanical strength is 200 MPa or more.

It is preferable that the base body 156 and the first and second lid bodies 157a and 157b are made of sintered aluminum oxide of a close-packed substance whose relative density is 95% or more, for example. In this case, for example, in the case of sintered aluminum oxide, firstly, rare-earth oxide powder and sintering aids are added and mixed into aluminum oxide powder, and powder materials of sintered aluminum oxide is prepared. Secondly, an organic binder and a dispersion medium are added and mixed into the powder materials of aluminum oxide sinter to make paste, and by a doctor blade method, or by adding an organic binder into the powder materials and conducting press-molding, roll-molding or the like, a green sheet having specified thickness is manufactured from the paste. Then, by punching with a die, a microdrill, a laser, or the like, through holes as the first fluid channels 158 and the second fluid channels 159, openings as fluid passages and through holes for disposing the first connection conductors 160 and the second connection conductors 161 are formed on the green sheet. The first and second fluid channels 158 and 159 may be grooves of outer layers or inner layers, formed by punching by means of a die or press molding.

The first and second wiring conductors 160 and 161 should preferably be composed of tungsten and/or molybdenum to prevent oxidation. In this case, for example, as an inorganic substance, Al₂O₃ in an amount of 3 to 20% by mass and Nb₂O₅ in an amount of 0.5 to 5% by mass is added to 100 mass percent tungsten and/or molybdenum powder to form a conductor paste. The conductor paste is filled in the through hole pierced in the green sheet to form a via hole acting as a through conductor.

Into the conductor paste, for the purpose of increasing close adhesion of the base body 156 and the first and second lid bodies 157a and 157b to ceramics, aluminum oxide powder or powder of the same composite with a ceramics component forming the base body 156 and the first and second lid bodies 157a and 157b can be added, for example, in the ratio of 0.05-2 volume %.

The first and second wiring conductors 160 and 161 are formed in the outer and inner layers of the base body 156 and the first and second lid bodies 157a and 157b before, after, or concurrently with the formation of the via conductor achieved by filling the conductor paste into the through hole. The formation of the wiring conductors is achieved by print-coating a similar conductor paste in a predetermined pattern on the green sheet in accordance with the screen printing method, gravure printing method, or the like method.

Thereafter, a predetermined number of sheet-like molded bodies carrying the printed, filled conductor paste are subjected to positional alignment, and are then stacked on top of each other under pressure. The stacked body is then fired, in a non-oxidative atmosphere, at a high temperature of approximately 1200 to 1500° C. Thereby, the desired ceramic base body 156, the first and second lid bodies 157a and 157b, and the first and second wiring conductors 20 and 21 are obtained.

The external connection terminals 162 are bonded to at least either the base body 156 or the first and second lid bodies 157a and 157 by soldering, brazing or the like. It is desirable that the external connection terminals 162 have a shape that enables fine electrical connection with a motherboard or the like for forming an electronic circuit as a main part of electronic apparatus. Such a shape is, for example, a rod, a hook, a cone or the like that allows easy electrical and mechanical connection to an electronic circuit as a main part of electronic apparatus by making the terminals in contact with each other or inserting the terminal. It is preferable to dispose a fitting portion (a hole or the like) corresponding to the external connection terminal to a region where the external connection terminal 162 is connected of an electronic circuit as a main part of electronic apparatus. Besides, by placing the external connection terminal 162 on the side surface of the base body 156 or the first and second lid bodies 157a and 157b, it is possible to low-profile electronic apparatus.

Further, it is preferable that the base body 156 and the first and second lid bodies 157a, 157b made of ceramics have thickness of 0.2 mm or more. In a case where the thickness is less than 0.2 mm, because the strengths are apt to cover, the base body 156 and the first and second lid bodies 157a and 157b tend to be easily cracked by stress caused when the base body 156 and the first and second lid bodies 157a and 157b are mounted. On the other hand, in a case where the thickness is more than 5 mm, because slenderizing and low-profiling are difficult, it is hard to use as a fuel cell installed in small mobile equipment, and because a thermal capacity is large, it is likely to become hard to instantly set to appropriate temperature corresponding to an electrochemical reaction condition of the membrane electrode assembly 13a and 13b.

The first wiring conductors 160 and the second wiring conductors 161 are electrically connected to the first electrode 14a and 14b and the second electrode 15a and 15b of the membrane electrode assembly 13a and 13b, respectively, thereby functioning as conductive paths for taking out an electric current generated in the membrane electrode assembly 13a and 13b to the outside of the fuel cell casing 152.

The first wiring conductor 160 has its one end disposed in that part of each bottom surface of the first and second concavity on both principal surfaces of the base body 156 which faces the first electrode 14a and 14b of the membrane electrode assembly 13a and 13b, and its other end led out toward the outer surface of the base body 156. As described above, it is preferable that the first wiring conductor 160 is formed integrally with the base body 156 and is made 10 μm or above higher than each bottom surface of the first and second concavity of the base body 156. This allows both ends of the first wiring conductor 160 to make contact with the first electrode 14a and 14b with ease. The desired height of the first wiring conductor 20 can be achieved by adjusting the printing condition such that the conductor paste is print-coated in a larger thickness during the print-coating process as described above.

Further, the first wiring conductor 160 should preferably be arranged in plural face to face with the first electrode 14a and 14b. This helps reduce electric loss in the first wiring conductor 160. That part of the first wiring conductor 160 which penetrates through the base body 156 should preferably be Φ50 μm or above in diameter.

The second wiring conductor 161 has its one end disposed in a part of a outer surface as one surface of the lid body 157a and 157b which faces the second electrode 15a and 15b of the membrane electrode assembly 13a and 13b, and its other end led out toward the outer surface of each of the first and second lid bodies 157a and 157b. It is preferable that, like the first wiring conductor 160, the second wiring conductor 161 is formed integrally with the first and second lid bodies 157a and 157b and is made 10 μm or above higher than the lower surface of the first and second lid bodies 157a and 157b. This allows the second wiring conductor 161 to make contact with the second electrode 15a and 15b with ease. The desired height of the second wiring conductor 161 can be achieved by adjusting the printing condition such that the conductor paste is print-coated in a larger thickness during the print-coating process as described above.

Further, the second wiring conductor 161 should preferably be arranged in plural face to face with the second electrode 15a and 15b. This helps reduce electric loss in the second wiring conductor 161. That part of the second wiring conductor 161 which penetrates through the first and second lid bodies 157a and 157b should preferably be Φ50 μm or above in diameter.

By coating the exposed surfaces of the first wiring conductors 160, the second wiring conductors 161, and the external connection conductors 162 with metal such as nickel, copper, gold, platinum and palladium that are good in conductivity and good in corrosion-resistance and wettability with a blazing material, it is possible to realize good electrical connection between the first conductor 160, the second conductor 161, the external connection terminal 162 and a motherboard or the like for forming an electronic circuit as a main part of electronic apparatus.

Then, the first and second wiring conductors 160 and 161 can be electrically connected to the first and second electrodes 14a, 14b and 15a, 15b, respectively, by grippingly inserting the membrane electrode assembly 13a and 13b between the base body 156 and the first and second lid bodies 157a and 157b. By so doing, the first and second wiring conductors 160 and 161 are brought into pressure-contact with the first and second electrodes 14a, 14b and 15a, 15b, respectively.

In the base body 156, the first fluid channel 158 is arranged such that the openings on the bottom surfaces of the first and second concavities face each other from a part of the base body between the first and second concavities to the bottom surfaces of the first and second concavities. The first fluid channels 158 are constituted by the through holes pierced in the base body 156, or grooves. The first fluid channels 158 serve as a passage for a fluid to be supplied to the membrane electrode assemblies 13a and 13b, such as fuel gas for example hydrogen-rich reforming gas or oxidant gas for example oxygen or air, and besides serves as a passage for a fluid to be discharged from the membrane electrode assembly 13a and 13b after reactions, such as water produced through reactions.

Moreover, on the principal surface of the first/second lid body 157a, 157b facing the second electrode 15a, 15b is arranged the second fluid channel 159. The second fluid channel 159 is so formed as to extend over the outer surface of the first/second lid body 157a, 157b. The second fluid channel 159, acting as a fluid path alike to the first fluid channel 158, is created by piercing a through hole or a groove in the first/second lid body 157a, 157b.

Regarding a through hole or a groove which is pierced in the base body 156 and the first and second lid bodies 157a and 157b as the first and second fluid channels 158 and 159, the diameter and number of the through hole, or the width, depth, and arrangement of the groove are determined according to the specifications of the fuel cell 151 in such a way that a fluid such as fuel gas or oxidant gas can be evenly supplied to the membrane electrode assembly 13a and 13b.

In the fuel cell casing 152 and the fuel cell 151 embodying the invention, the first and second fluid channels 158 and 159 should preferably have a hole diameter of Φ0.1 mm or above and be equally spaced.

In this way, the first fluid channel 158 is disposed face to face with the principal surface of the membrane electrode assembly 13a and 13b having the first electrode 14a and 14b, whereas the second fluid channel 159 is disposed face to face with the principal surface of the membrane electrode assembly 13a and 13b having the second electrode 15a and 15b. With this arrangement, a fluid can be exchanged between the lower and upper principal surfaces of the membrane electrode assembly 13 and their corresponding first and second fluid channels 158 and 159, and thus the fluid can be supplied and discharged through the respective fluid path. Moreover, in the case of supplying gas as a fluid, it is possible to prevent a decrease in the partial pressure of the gas supplied to the first and second electrodes 14a, 14b and 15a, 15b of the membrane electrode assembly 13a and 13b, and thus obtain a predetermined stable output voltage. Further, since the partial pressure of the supplied gas is stabilized, the inner pressure within the fuel cell 11 is made uniform. As a result, thermal stress occurring in the membrane electrode assembly 13a and 13b can be suppressed, leading to enhancement of the reliability of the fuel cell 151.

With the construction thus far described, it is possible to provide the compact and sturdy fuel cell casing 152 capable of housing the membrane electrode assembly 13a and 13b as shown in FIG. 14 and the fuel cell 151 that allows highly-efficient control according to the invention.

FIG. 15is a sectional view showing yet another embodiment of the fuel cell which is incorporated in the electronic apparatus according to the invention. In FIG. 15, the components that play the same or corresponding roles as in FIG. 14 will be identified with the same reference symbols. Specifically, reference symbol 151a represents a fuel cell; 152a represents a fuel cell casing; 13a and 13b represent a membrane electrode assembly; 14a and 14b represent a first electrode; 15a and 15b represent a second electrode; 156 represents a base body; 157c represents a first lid body; 157d represents a second lid body; 158 represents a first fluid channel; 159 represents a second fluid channel; 160a and 160b represent a first wiring conductor; and 161 and 161a represent a second wiring conductor.

In the example shown in FIG. 15, the first wiring conductor 160a has its one end opposed to the first electrode 14a of the membrane electrode assembly 13a on the bottom surface of the first concavity of the upper principal surface of the base body 156, and its other end led to the lower principal surface of the base body 156 so as to be electrically connected to the other end of the second wiring conductor 161a led to the outer surface of the second lid body 157d. Moreover, the first wiring conductor 160b has its one end opposed to the first electrode 14b of the membrane electrode assembly 13b on the bottom surface of the second concavity of the lower principal surface of the base body 156, and its other end led to the outer surface, here, the side surface, of the base body 156.

It is preferable that the first wiring conductor 160a, 160b is formed integrally with the base body 156 and is made 10 μm or above higher than the bottom surface of the first/second concavity of the base body 156. This allows one end of the first wiring conductor 160a, 160b to make contact with the first electrode 14a, 14b with ease. The desired height of the first wiring conductor 160a, 160b can be obtained by adjusting the printing condition such that the conductor paste is print-coated in a larger thickness during the print-coating process as described above. Further, the first wiring conductor 160a, 160b should preferably be arranged in plural face to face with the first electrode 14a, 14b. This helps reduce electric loss ascribable to the first wiring conductor 160a, 160b. That part of the first wiring conductor 160a, 160b which penetrates through the base body 156 should preferably be set at Φ50 μm or above in diameter.

As shown in FIGS. 14 and 15, according to the fuel cell casing 152, 152a and the fuel cell 151, 151a, the membrane electrode assembly 13a, 13b is housed in the first/second concavity formed on each principal surface of the base body 156. Moreover, in a plurality of membrane electrode assemblies 13a, 13b, their respective first electrodes 14a, 14b, or their first and second electrodes 14a, 14b and 15a, 15b, are electrically connected together by the first wiring conductor 160, 160a, 160b, and the second wiring conductor 161, 161a. Then, to obtain the overall output through the membrane electrode assemblies 13a, 13b located at the opposite ends in terms of circuitry, the wiring conductors are electrically connected thereto respectively. In this case, since three-dimensional wiring can be carried out freely, a plurality of membrane electrode assemblies 13a, 13b can be arbitrarily connected together in series or in parallel. This makes it possible to adjust the overall output voltage and output current with efficiency. Thus, in the fuel cell, electricity which has been electrochemically produced in a plurality of membrane electrode assemblies 13a, 13b can be externally extracted satisfactorily.

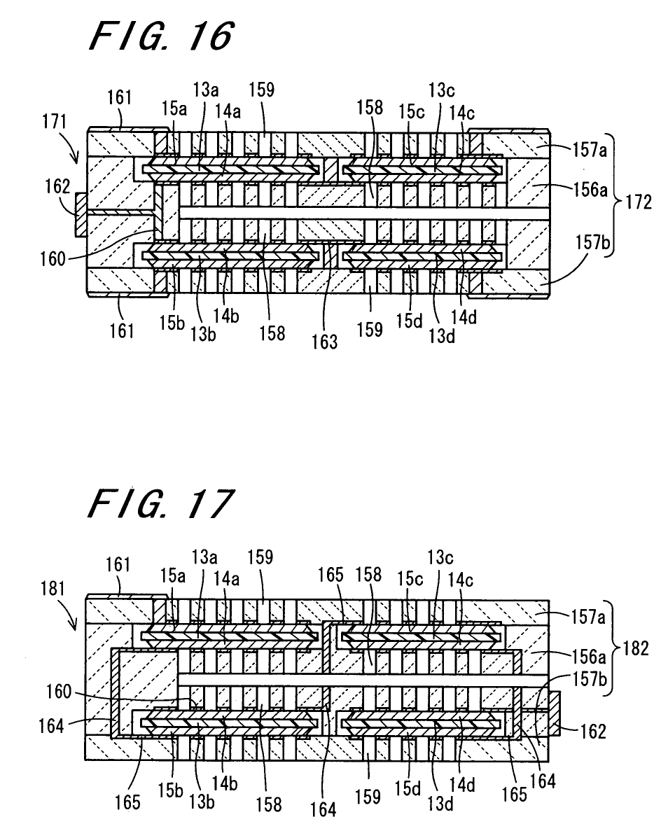

FIGS. 16 through 19 are sectional views showing yet another embodiment of the fuel cell which is incorporated in the electronic apparatus according to the invention.

In these figures, reference numerals 171, 181, 191, and 201 denote a fuel cell; reference numerals 172, 182, 192, and 202 denote a fuel cell casing; reference numerals 13a, 13b, 13c, and 13d denote a membrane electrode assembly; reference numerals 14a, 14b, 14c, and 14d denote a first electrode; reference numerals 15a, 15b, 15c, and 15d denote a second electrode; reference numerals 156 and 156a denote a base body; reference numerals 157a and 157b denote a lid body; reference numeral 158 denotes a first fluid channel; reference numeral 159 denotes a second fluid channel; reference numeral 160 denotes a first wiring conductor; reference numeral 161 denotes a second wiring conductor; reference numeral 162 denotes an external connection terminal; reference numeral 163 denotes a third wiring conductor; reference numeral 164 denotes a fourth wiring conductor; reference numeral 165 denotes a fifth wiring conductor; reference numeral 166 denotes a sixth wiring conductor; reference numeral 167 denotes a seventh wiring conductor; and reference numeral 168 denotes an eighth wiring conductor.

Note that, in this embodiment, the same components as those of the aforementioned embodiment will be denoted by the same reference numerals.

In FIG. 16, the third wiring conductor 163, which is formed integrally with the base body 156a, has its one end opposed to the first electrode 14a, 14b of the membrane electrode assembly 13a, 13b on the bottom surface of one of a plurality of first/second concavities of the base body 156a, and its other end opposed to the first electrode 14c, 14d of the other membrane electrode assembly 13c, 13d on the other bottom surface of one of the plurality of first/second concavities. The third wiring conductor 163 should preferably be made 10 μm or above higher than the bottom surface of the first/second concavity of the base body 156a. This allows both ends of the third wiring conductor 163 to make contact with the first electrode 14a, 14b, 14c, 14d with ease. The desired height of the third wiring conductor 163 can be obtained by adjusting the printing condition such that the conductor paste is print-coated in a larger thickness during the print-coating process as described above. Further, the third wiring conductor 163 should preferably be arranged in plural face to face with the first electrode 14a, 14b, 14c, 14d. This helps reduce electric loss ascribable to the third wiring conductor 163. That part of the third wiring conductor 163 which penetrates through the base body 156a should preferably be set at Φ50 μm or above in diameter.

In FIG. 17, the fourth wiring conductor 164 has its one end opposed to the first electrode 14a, 14b, 14c of the membrane electrode assembly 13a, 13b, 13c on the bottom surface of one of a plurality of first/second concavities of the base body 156a, and its other end led to the principal surface of the base body 156a on which the first/second lid body 157a, 157b is mounted. Moreover, the fifth wiring conductor 165 has its one end opposed to the second electrode 15b, 15c, 15d of the membrane electrode assembly 13b, 13c, 13d of the first/second concavity on the principal surface of the lid body 157a, 157b, and its other end led to the principal surface of the first/second lid body 157a, 157b which is mounted on the principal surface of the base body 156a, so as to face the other end of the fourth wiring conductor 164.

It is preferable that, like the third wiring conductor 163, the fourth wiring conductor 164 is also formed integrally with the base body 156a and is made 10 μm or above higher than the bottom surface of the first/second concavity of the base body 156a. This allows one end of the fourth wiring conductor 164 to make contact with the first electrode 14a, 14b, 14c with ease. The desired height of the fourth wiring conductor 164 can be obtained by adjusting the printing condition such that the conductor paste is print-coated in a larger thickness during the print-coating process as described above. Further, the fourth wiring conductor 164 should preferably be arranged in plural face to face with the first electrode 14a, 14b, 14c. This helps reduce electric loss ascribable to the fourth wiring conductor 164. That part of the fourth wiring conductor 164 which penetrates through the base body 156a should preferably be set at (50 μm or above in diameter.

It is preferable that, like the second wiring conductor 161, the fifth wiring conductor 165 is also formed integrally with the first/second lid body 157a, 157b and is made 10 μm or above higher than the lower surface of the first/second lid body 157a, 157b. This allows one end of the fifth wiring conductor 165 to make contact with the second electrode 15b, 15c, 15d with ease. The desired height of the fifth wiring conductor 165 can be obtained by adjusting the printing condition such that the conductor paste is print-coated in a larger thickness during the print-coating process as described above. Further, the fifth wiring conductor 165 should preferably be arranged in plural face to face with the second electrode 15b, 15c, 15d. This helps reduce electric loss ascribable to the fifth wiring conductor 165. That part of the fifth wiring conductor 165 which penetrates through the lid body 157a, 157b should preferably be set at Φ50 μm or above in diameter.

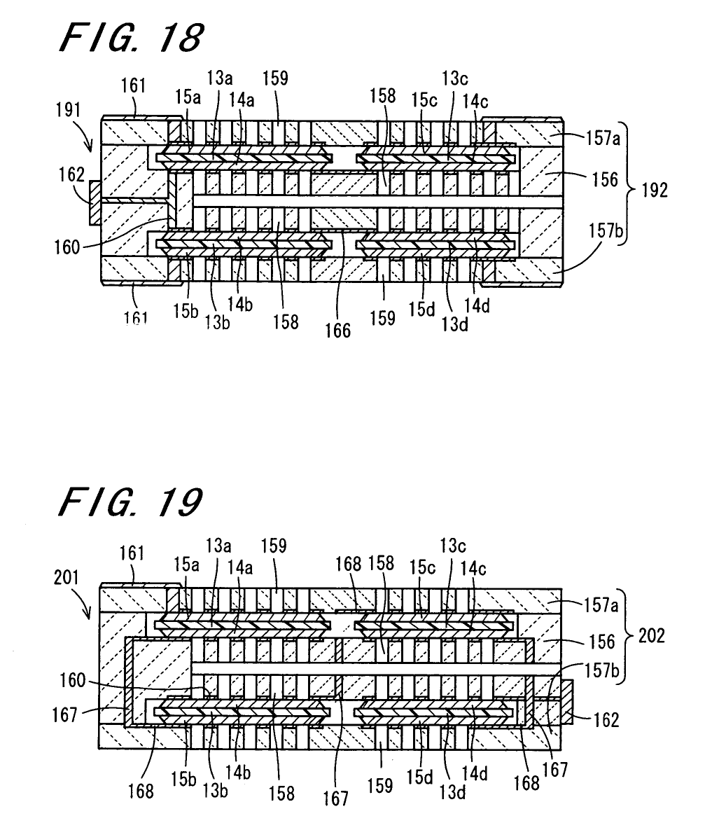

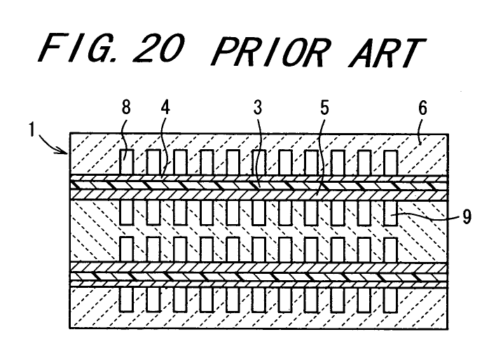

In FIG. 18, the sixth wiring conductor 166, which is formed integrally with the base body 156, has its one end opposed to the first electrode 14a, 14b of the membrane electrode assembly 13a, 13b on the bottom surface of the first/second concavity of the base body 156, and its other end opposed to the other first electrode 14c, 14d of the membrane electrode assembly 13c, 13d on the bottom surface of the same first/second concavity.

It is preferable that the sixth wiring conductor 166 is made 10 μm or above higher than the bottom surface of the first/second concavity of the base body 156. This allows both ends of the sixth wiring conductor 166 to make contact with the first electrode 14a, 14b, 14c, 14d with ease. The desired height of the sixth wiring conductor 166 can be obtained by adjusting the printing condition such that the conductor paste is print-coated in a larger thickness during the print-coating process as described above. Further, the sixth wiring conductor 166 should preferably be arranged in plural face to face with the first electrode 14a, 14b, 14c, 14d. This helps reduce electric loss ascribable to the sixth wiring conductor 166. That part of the sixth wiring conductor 166 which penetrates through the base body 156 should preferably be set at Φ50 μm or above in diameter.

In FIG. 19, the seventh wiring conductor 167 has its one end opposed to the first electrode 14a, 14b, 14c of one of a plurality of membrane electrode assemblies 13a, 13b, 13c on the bottom surface of the first/second concavity of the base body 156, and its other end led to the principal surface of the base body 156 on which the first/second lid body 157a, 157b is mounted.

Moreover, the eighth wiring conductor 168 has its one end opposed to the second electrode 15b, 15c, 15d of one of a plurality of membrane electrode assemblies 13b, 13c, 13d, on the principal surface of the first/second lid body 157a, 157b, and its other end led to the lower surface of the first/second lid body 157a, 157b which is mounted on the principal surface of the base body 156, so as to face the other end of the seventh wiring conductor 167.

It is preferable that, like the third wiring conductor 163, the seventh wiring conductor 167 is also formed integrally with the base body 156 and is made 10 μm or above higher than the bottom surface of the concavity of the base body 156. This allows one end of the seventh wiring conductor 167 to make contact with the first electrode 14a, 14b, 14c with ease. The desired height of the seventh wiring conductor 167 can be obtained by adjusting the printing condition such that the conductor paste is print-coated in a larger thickness during the print-coating process as described above. Further, the seventh wiring conductor 167 should preferably be arranged in plural face to face with the first electrode 14a, 14b, 14c. This helps reduce electric loss ascribable to the seventh wiring conductor 167. That part of the seventh wiring conductor 167 which penetrates through the base body 156 should preferably be set at Φ50 μm or above in diameter.

It is preferable that, like the second wiring conductor 161, the eighth wiring conductor 168 is also formed integrally with the first/second lid body 157a, 157b and is made 10 μm or above higher than the lower surface of the first/second lid body 157a, 157b. This allows one end of the eighth wiring conductor 168 to make contact with the second electrode 15b, 15c, 15d with ease. The desired height of the eighth wiring conductor 168 can be obtained by adjusting the printing condition such that the conductor paste is print-coated in a larger thickness during the print-coating process as described above. Further, the eighth wiring conductor 168 should preferably be arranged in plural face to face with the second electrode 15b, 15c, 15d. This helps reduce electric loss ascribable to the eighth wiring conductor 168. That part of the eighth wiring conductor 168 which penetrates through the first/second lid body 157a, 157b should preferably be set at Φ50 μm or above in diameter.

As shown in FIGS. 16 and 17, according to the fuel cell casing 172, 182 and the fuel cell 171, 181 that are incorporated in the electronic apparatus embodying the invention, the membrane electrode assembly 13a, 13b, 13c, 13d is housed in each of a plurality of first/second concavities of the base body 156a. Moreover, the third wiring conductor 163, or the fourth and fifth wiring conductors 164 and 165, is/are disposed so as to extend across the region between the adjacent first/second concavities. Thereby, in a plurality of membrane electrode assemblies 13a, 13b, 13c, 13d, their respective first electrodes 14a, 14b, 14c, 14d, or their first and second electrodes 14a, 14b, 14c, 14d and 15a, 15b, 15c, 15d, are electrically connected together. Then, to obtain the overall output through the endmost membrane electrode assemblies 13a, 13b, 13c, 13d, the first and second wiring conductors 160 and 161 are electrically connected thereto respectively. In this case, since the first to third wiring conductors 160, 161, and 163, as well as the first, second, fourth, and fifth wiring conductors 160, 161, 164, and 165, allow free three-dimensional wiring, a plurality of membrane electrode assemblies 13a, 13b, 13c, 13d can be arbitrarily connected together in series or in parallel. This makes it possible to adjust the overall output voltage and output current with efficiency. Thus, in the fuel cell, electricity which has been electrochemically produced in a plurality of membrane electrode assemblies 13a, 13b, 13c, 13d can be externally extracted satisfactorily.

As shown in FIGS. 18 and 19, according to the fuel cell casing 192, 202 and the fuel cell 191, 201 that are incorporated in the electronic apparatus embodying the invention, a plurality of membrane electrode assemblies 13a, 13b, 13c, 13d are housed in the first/second concavity of the base body 156, and the sixth wiring conductor 160, or the seventh and eighth wiring conductors 167 and 168, is/are disposed. Thereby, in a plurality of membrane electrode assemblies 13a, 13b, 13c, 13d, their respective first electrodes 14a, 14b, 14c, 14d, or their first and second electrodes 14a, 14b, 14c, 14d and 15a, 15b, 15c, 15d, are electrically connected together. Then, to obtain the overall output through the endmost membrane electrode assemblies 13a, 13b, 13c, 13d, the first and second wiring conductors 160 and 161 are electrically connected thereto respectively. In this case, since the first, second, and sixth wiring conductors 160, 161, and 166, as well as the first, second, seventh, and eighth wiring conductors 160, 161, 167, and 168, allow free three-dimensional wiring, a plurality of membrane electrode assemblies 13a, 13b, 13c, 13d can be arbitrarily connected together in series or in parallel. This makes it possible to adjust the overall output voltage and output current with efficiency. Thus, in the fuel cell, electricity which has been electrochemically produced in a plurality of membrane electrode assemblies 13a, 13b, 13c, 13d can be externally extracted satisfactorily.

It should be noted that the invention need not be limited to the above-described embodiments and examples, and therefore various changes and modifications are possible without departing from the spirit or scope of the invention. For example, the first and second fluid channels 158 and 159 may alternatively be constructed by forming an inlet on the side surface of the base body 156 and 156a or the lid body 157a and 157b. In this case, the entire fuel cell is made lower in profile, and the down-sized fuel cell is accordingly suited for a portable electronic apparatus. Moreover, the other ends of the first and second wiring conductors 160 and 161 may be led out over the side surfaces of the base body 156 and 156a and the lid body 157a and 157b, respectively, that are located on the same side, instead of being led out over the outer surfaces thereof, respectively, and the external connection terminal may be put together. In this case, the wiring lines, the ducts, etc. can be put together only on one side of the fuel cell. This helps facilitate miniaturization and protection of the externally-connected portions. Thus, the fuel cell can be designed with high reliability and accordingly operated with stability for a longer period of time.

Next, a description will be given below as to the electronic apparatus embodying the invention that incorporates the above-described fuel cell as a power source.

Being equipped with the fuel cell as a power source, the electronic apparatus of the invention is made compact and lower in profile, is operated with stability for a longer period of time, and is excellent in safety and convenience. Various advantages brought about by the electronic apparatus will be set forth hereinbelow.

According to the electronic apparatus of the invention, in the fuel cell acting as a power source, the external connection terminal 12 (the terminal with positive and negative polarities) can be electrically connected to the circuit board of the electronic apparatus with ease, and can also be detached and attached freely. Thus, for example, the fuel cell can be replaced with a new one without any difficulty, thus attaining remarkable convenience.

Moreover, by employing, as a power source, the fuel cell and fuel cell casing composed of the multilayer ceramic-made base body 156, 156a, electrical wiring can be carried out freely in the fuel cell, and thereby a plurality of membrane electrode assemblies are readily connected in series with one another. As a result, the electronic apparatus succeeds in miniaturization, low-profile styling, and weight reduction.

Further, since the base body 156, 156a are made of multi-layer ceramics, resistance, capacitance, and inductance can be created within the base body 156, 156a.

For example, by forming high-volume capacitance within the base body 156, 156a alongside the fuel cell, when the current fed from the fuel cell is in short supply, the shortage of the current can be compensated for successfully; wherefore the desired current supply appropriate to the target output current can be secured. Similarly, by using resistance, capacitance, and inductance, a voltage-boosting circuit can be formed; wherefore a voltage necessary for the electronic apparatus can be secured.

Note that, in the case of forming resistance, capacitance, and inductance within the base body 156, 156a in that way, the base body 156, 156a should preferably be made of sintered glass ceramics.

Note that, sintered glass ceramics is made of a glass component and a filler component, these components are the same as those of the aforementioned embodiment, and it will be omitted to describe in detail.

Further, it is preferable that the mixture ratio of the glass and the filler is 40:60 to 99:1 in mass ratio.

As an organic binder blended in a glass ceramic green sheet, one that has been used in a ceramic green sheet so far can be used, and it is, for example, a homopolymer or a copolymer of acrylic-base (a homopolymer or a copolymer of acrylic acid, methacrylic acid or ester thereof, concretely, an acrylic acid ester copolymer, a methacrylic acid ester copolymer, acrylic acid ester—methacrylic acid ester copolymer or the like), polyvinyl butyral-base, polyvinyl alcohol-base, acrylic-styrene-base, polypropylene carbonate-base, cellulose-base or the like.

A glass ceramic green sheet is obtained by adding a specified amount of plasticizer, a solvent (an organic solvent, water or the like) into the glass powder, the filler powder and the organic binder as necessary to obtain slurry, and molding this by doctor blade, rolling, calendar rolling, die pressing or the like to thickness of approximately 50 to 500 μm.

A conductor pattern is formed on the surface of a glass ceramic green sheet, for example, by printing paste of conductor material powder by a screen printing method, a gravure printing method or the like, or by transferring metal foil of a specified pattern shape. A conductor material is of, for example, one kind or two or more kinds selected from Cu, Au, Ag, Pd, Pt or the like, and in the case of containing two or more kinds, it may be any shape of mixture, alloy, coating or the like.

Further, in a case where a large-capacity capacitance is formed, for example, a layer made of inorganic substance powder that has high dielectric constant such as barium titanate (referred to as a barium titanate layer hereafter) is formed inside a base body 16 made of glass ceramics. In this case, it is manufactured by firstly forming slurry that contains ceramic powder and glass powder to obtain a plurality of green sheets, subsequently printing metal paste to become a lower electrode layer on the green sheet, subsequently printing dielectric paste made of barium titanate or the like on the lower electrode layer by screen printing to form a dielectric layer, further printing metal pate on the dielectric layer to form an upper electrode layer, stacking these green sheets, and firing this stacked body.

Further, in a case where a resistor is formed inside the base body, it can be formed by print-applying resistor paste whose principal ingredients are RuO₂, IrO₂, RhO₂, SnO₂, LaB₆ and the like to the green sheet in a specified pattern by a method such as screen printing, gravure printing or the like by the same method as the first wiring conductor 160 and the second wiring conductor 161.

Further, it is good that an internal circuit is formed in the base body 156, 156a of the fuel cell 151, 151a, 171, 181, 191, 201. Consequently, it is possible to mount an electronic part electrically connected to the internal circuit on the surface of the base body 156, 156a. Therefore, it is possible to increase functionality of electronic apparatus by the electronic part mounted on the surface of the base body 156, 156a.

Further, it is good that an electronic part electrically connected to the internal circuit is disposed to the surface of the base body 156, 156a of the fuel cell 151, 151a, 171, 181, 191, 201. Consequently, by using a sensor, a control IC or the like as the electronic part and detecting the density of fuel inside the fluid channels 18, 19 by a density sensor, optimum circulation, fuel dilution, and suppress of decrease of fuel use efficiency are enabled. In addition, by using electronic parts, a boosting circuit can be formed, it becomes possible to control a voltage necessary for electronic apparatus.

Further, by using a temperature sensor or the like, it becomes possible to manage and control the temperature of the membrane electrode assembly.

Further, it is good that, in the fuel cell 1, piezoelectric pumps, that is, micropumps using a piezoelectric material such as lead zirconate titanate (PZT; composition formula: Pb (Zr, Ti) O₃) are disposed in at least either the first fluid channels 158 or the second fluid channels 159. Consequently, the small piezoelectric pumps prevent backflow of fuel, with the result that it is possible to prevent unused fuel from being polluted by a reactant or the like, and it is possible to avoid that residual air affects an operation of electronic apparatus because the residual air is discharged. Besides, fuel is constantly supplied, with the result that electric power is stably generated, and actuation time is shortened because fuel is smoothly supplied.

The piezoelectric pump is constituted by an influx portion, a variable volume portion, and an efflux portion. Then, the variable volume portion can be manufactured by, for example, disposing a piezoelectric material outside the first and second fluid channels 158, 159, and by the use of expansion and contraction of the piezoelectric material responsive to an applied voltage, it is possible to vibrate upper regions of the first and second fluid channels 158, 159. Consequently, it can vary the volumes of the first and second fluid channels 158, 159, and can function as a pump.

Further, the influx portion and the efflux portion are formed by the first and second fluid channels 158, 159 connected to the variable volume portion, and they are for letting fuel flow into and out of the variable volume portion. It is preferable that the sectional area of the efflux portion is larger than the sectional area of the influx portion. Consequently, pressure of fuel of the efflux portion becomes small, and in the case of causing the variable volume portion to function as a pump, fuel flows toward the efflux portion where pressure is small, and it is possible to send fuel in a specific direction in a good manner. Backflow prevention valves that prevent backflow of fuel may be disposed to the influx portion and the efflux portion.

Such a piezoelectric pump is made of an organic or inorganic piezoelectric material, and can be manufactured by bonding this piezoelectric material after firing a ceramic green sheet to become the base body 156, 156a or the lid body 157a, 157b or, in the case of using a ceramic piezoelectric material such as PZT, mounting the ceramic piezoelectric material in a specified position of a ceramic green sheet and thereafter firing at the same time.

Further, the fuel cell 151, 151a, 171, 181, 191, 201 are excellent in reliability and safety because, other than the first and second wiring conductors 160, 161 whose one ends are disposed inside the housing, nothing comes in electric contact with the membrane electrode assembly 13a, 13b, 13c, 13d themselves uselessly.

On the basis of the above, according to the electronic apparatus of the invention, it is possible to provide electronic apparatus that is excellent in compactness, convenience and safety and capable of stable operation over the long run by equal supply of fluids and highly efficient electrical connection.

Then, in concrete, the electronic apparatus of the invention is mobile electronic apparatus such as a mobile phone, a PDA (personal digital assistant), a digital camera or video camera or a toy such as a game machine, and electronic apparatus that includes a laptop PC (personal computer) such as a printer, a facsimile, a television, a communication apparatus, an audio video apparatus, various kinds of household electric appliances such as an electric fan, or a machine tool of portable type.

In recent years, electronic apparatus that additionally has a function of displaying a moving image using a liquid crystal display apparatus has been used. Since such moving image display requires considerably large power consumption, electronic apparatus that uses a conventional storage battery becomes incapable of operating in a short time period, whereas the electronic apparatus of the invention is provided with a fuel cell that can supply a power source for a considerably long time period, and therefore, it is capable of operating for a long time period even in the case of displaying a moving image.

For example, in a case where the electronic apparatus of the invention is a mobile phone, as shown in a block diagram of FIG. 13, the fuel cell and the fuel cell casing of the invention are built in the power source portion 143.

In this case, the fuel cell and the fuel cell casing of the invention are excellent in compactness, convenience and safety, and are capable of equal supply of fuel and power source supply for a long time period by highly efficient electrical connection, whereby miniaturization, low-profiling and weight reduction of a mobile phone are enabled.

Further, considering that a recent mobile phone is miniaturized and low-profiled enough, it is possible to additionally install an electronic part that has a function of a camera, a video or the like other than a function of a telephone into a space made by miniaturizing and low-profiling a fuel cell in the above manner, and it is possible to promote multifunction.

Further, instead of newly installing an electronic part, it is also possible to dispose a shock absorber, a preventive member or the like so as to protect a major electronic circuit. In this case, it is also possible to make a structure that can possibly strengthen than ever shock-resistance when a mobile phone main body is shocked by a fall or the like, a waterproof characteristic at the time of use in the rain or the like.

Further, as a result of miniaturizing an electric circuit portion inside a mobile phone main body, restrictions on the outer shape of a mobile phone main body decrease, and it becomes possible to form a mobile phone in an outer shape that is excellent in design, for example, a shape that enables elderly people and children to hold with ease.

Further, in a case where the structure of the power source portion 143 is a structure that the fuel cell and the fuel cell casing can be freely attached and detached as described above, it is possible, by preparing a spare fuel cell and fuel cell casing, to easily replace to a spare fuel cell and fuel cell casing or take out a fuel cell to replenish and replace fuel in case of battery shutoff or the like, so that it is possible to continuously speak on the phone, and the phone becomes more excellent in convenience than conventional one that uses a storage battery as a power source.

Further, since a replaced (used) fuel cell can be instantly reused after replenished with fuel, it is easier to use than a charging type, and it is possible to effectively use resources. Moreover, there is a merit that it is possible to use even in case of emergency such as blackout for a long time period due to natural disasters and even outdoors.

Further, a laptop PC (personal computer) is made by a basic constitution of comprising a personal computer main body, a first box that contains a keyboard for inputting specified data to the personal computer main body, and a second box that contains a display for displaying data inputted by the keyboard or data processed by the personal computer main body, attaching the second box to the first box so as to be openable and closable, and forming a power source portion that supplies power sources to the respective portions in the first box, and the fuel cell and the fuel cell casing of the invention are installed in the power source portion. In this case, as in the aforementioned mobile phone, the fuel cell and the fuel cell casing installed in the electronic apparatus of the invention are excellent in compactness, convenience and safety and are capable of equal supply of fuel and power source supply for a long time period by highly efficient electrical connection, so that miniaturization, low-profiling and weight reduction of a laptop PC (personal computer) main body and making it multifunction are enabled, and it is possible to realize a highly convenient laptop PC (personal computer) that is capable of stable supply of a large electric current for a long time period and that has a display easy to look and reduces burdens of weight and volume at the time of carrying, in response to a large and high-resolution display.

Further, in a case where the structure of the power portion is a structure that the fuel cell and the fuel cell casing of the invention are freely attached and detached, by preparing a spare fuel cell and fuel cell casing of the invention, there is a merit that under the condition of using with only a secondary battery outdoors or in a mobile unit such as an airplane, it becomes possible to supply electric power for a longer time period than ever dramatically. Moreover, in the case of using in a public space, it is outstandingly excellent in convenience and can be used without restrictions because it is excellent in safety.

The invention is not limited to the above embodiments and can be changed in various manners in the scope of the invention.

For example, a DMFC that uses methanol as fuel is used as a fuel cell in the above embodiments. However, a fuel cell that uses various kinds of liquids including dimethyl ether as fuel can be also used.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A fuel cell casing comprising:
a base body made of ceramics that has a plurality of concavities formed on one surface thereof, for accommodating therein a membrane electrode assembly, the membrane electrode assembly having a first electrode and a second electrode which are formed on one principal surface and another principal surface thereof, respectively;
a first fluid channel formed so as to extend from a bottom surface of the concavity facing one principal surface of the membrane electrode assembly to an outer surface of the base body;
a first wiring conductor having its one end disposed on the bottom surface of the concavity facing the first electrode of the membrane electrode assembly, and its another end led to the outer surface of the base body;
a lid body mounted on one surface of the base body near the concavity so as to cover the concavity, for sealing the concavity hermetically;
a second fluid channel formed so as to extend from one surface of the lid body facing the other principal surface of the membrane electrode assembly to an outer surface of the lid body;
a second wiring conductor having its one end disposed on one surface of the lid body facing the second electrode of the membrane electrode assembly, and its another end led to the outer surface of the lid body; and
a third wiring conductor formed in the base body, the third wiring conductor having its one end opposed to the first electrode of the membrane electrode assembly on a bottom surface of one concavity, and its another end opposed to the first electrode of the membrane electrode assembly on a bottom surface of another concavity.

2. A fuel cell casing comprising:
a base body made of ceramics that has a plurality of concavities formed on one surface thereof, for accommodating therein a membrane electrode assembly, the membrane electrode assembly having a first electrode and a second electrode which are formed on one principal surface and another principal surface thereof, respectively;
a first fluid channel formed so as to extend from a bottom surface of the concavity facing one principal surface of the membrane electrode assembly to an outer surface of the base body;
a first wiring conductor having its one end disposed on the bottom surface of the concavity facing the first electrode of the membrane electrode assembly, and its another end led to the outer surface of the base body;
a lid body mounted on one surface of the base body near the concavity so as to cover the concavity, for sealing the concavity hermetically;
a second fluid channel formed so as to extend from one surface of the lid body facing the other principal surface of the membrane electrode assembly to an outer surface of the lid body;
a second wiring conductor having its one end disposed on one surface of the lid body facing the second electrode of the membrane electrode assembly, and its another end led to the outer surface of the lid body;
a fourth wiring conductor having its one end opposed to the first electrode of the membrane electrode assembly on a bottom surface of one concavity, and its another end led to the other surface of the base body on which the lid body is mounted; and
a fifth wiring conductor having its one end opposed to the second electrode of another membrane electrode assembly of the concavity on one surface of the lid body, and its another end led to one surface of the lid body to be mounted on one surface of the base body, so as to face the other end of the fourth wiring conductor.

3. A fuel cell casing comprising:
a base body made of ceramics that has a concavity formed on one surface thereof, for accommodating a plurality of membrane electrode assemblies, each membrane electrode assembly having a first electrode and a second electrode which are formed on one principal surface and another principal surface thereof, respectively;
a first fluid channel formed so as to extend from a bottom surface of the concavity facing one principal surface of the membrane electrode assembly to an outer surface of the base body;
a first wiring conductor having its one end disposed on the bottom surface of the concavity facing the first electrode of the membrane electrode assembly, and its another end led to the outer surface of the base body;
a lid body mounted on one surface of the base body near the concavity so as to cover the concavity, for sealing the concavity hermetically;
a second fluid channel formed so as to extend from one surface of the lid body facing the other principal surface of the membrane electrode assembly to an outer surface of the lid body;
a second wiring conductor having its one end disposed on one surface of the lid body facing the second electrode of the membrane electrode assembly, and its other end led to the outer surface of the lid body; and
a third wiring conductor formed in the base body, the third wiring conductor having its one end opposed to the first electrode of one membrane electrode assembly on the bottom surface of the concavity, and its another end opposed to the first electrode of another membrane electrode assembly on the bottom surface of the concavity.

4. A fuel cell casing comprising:
a base body made of ceramics that has a concavity formed on one surface thereof, for accommodating a plurality of membrane electrode assemblies, each membrane electrode assembly having a first electrode and a second electrode which are formed on one principal surface and another principal surface thereof, respectively;
a first fluid channel formed so as to extend from a bottom surface of the concavity facing one principal surface of the membrane electrode assembly to an outer surface of the base body;
a first wiring conductor having its one end disposed on the bottom surface of the concavity facing the first electrode of the membrane electrode assembly, and its another end led to the outer surface of the base body;
a lid body mounted on one surface of the base body near the concavity so as to cover the concavity, for sealing the concavity hermetically; a second fluid channel formed so as to extend from one surface of the lid body facing the other principal surface of the membrane electrode assembly to an outer surface of the lid body;
a second wiring conductor having its one end disposed on one surface of the lid body facing the second electrode of the membrane electrode assembly, and its another end led to the outer surface of the lid body;
a fourth wiring conductor having its one end opposed to the first electrode of one membrane electrode assembly on the bottom surface of the concavity, and its another end led to one surface of the base body on which the lid body is mounted; and
a fifth wiring conductor having its one end opposed to the second electrode of another membrane electrode assembly on one surface of the lid body, and its another end led to one surface of the lid body to be mounted on one surface of the base body, so as to face the other end of the fourth wiring conductor.

5. A fuel cell casing comprising:
a base body made of ceramics that has a first concavity and a second concavity formed on its one principal surface side and another principal surface side, respectively, for accommodating therein a membrane electrode assembly, the membrane electrode assembly having a first electrode and a second electrode which are formed on one principal surface and the other principal surfaces thereof, respectively;
a first fluid channel formed within the base body so as to extend from a region between the first and second concavities to a bottom surface of each of the concavities;
a first wiring conductor having its one end disposed on the bottom surface of the first/second concavity so as to face the first electrode of the membrane electrode assembly, and its another end led to the outer surface of the base body;
a first lid body mounted on one principal surface of the base body near the first concavity so as to cover the first concavity, for sealing the first concavity hermetically;
a second lid body mounted on another principal surface of the base body near the second concavity so as to cover the second concavity, for sealing the second concavity hermetically;
a second fluid channel formed so as to extend from a first/second concavity-side principal surface of the first/second lid body, facing the second electrode of the membrane electrode assembly, to an outer surface of the lid body; and
a second wiring conductor having its one end disposed on the first/second concavity-side principal surface of the first/second lid body facing the second electrode of the membrane electrode assembly, and its other end led to the outer surface of the lid body.

6. The fuel cell casing of claim 5, wherein the first fluid channel is arranged such that the openings on the bottom surfaces of the first and second concavities face each other.

7. A fuel cell comprising:
a plurality of membrane electrode assemblies, each having a first electrode and a second electrode which are formed on one principal surface and another principal surface thereof, respectively; and
the fuel cell casing of claim 1,
wherein the membrane electrode assembly is housed in the plurality of concavities of the fuel cell casing, respectively, one and the other principal surfaces of the membrane electrode assembly are arranged such that fluid can be exchanged between one and the other principal surfaces and their corresponding first and second fluid channels, the first and second wiring conductors are electrically connected to the first and second electrodes, respectively, the third wiring conductor is electrically connected to the first electrode, and the lid body is mounted on one surface of the base body near the concavity so as to cover the concavity.

8. An electronic apparatus comprising:
the fuel cell of claim 7, as a power source,
wherein the base body is made of multi-layer ceramics, and an external connection terminal is formed in at least one of the base body and the lid body.

9. The electronic apparatus of claim 8, wherein an internal circuit is formed in the base body.

10. The electronic apparatus of claim 9, wherein the base body has an electronic component which is disposed on the surface thereof so as to be electrically connected to the internal circuit.

11. The electronic apparatus of claim 8, wherein a piezoelectric pump is disposed partway along one of the first and second fluid channels.

12. A fuel cell comprising:
a plurality of membrane electrode assemblies, each having a first electrode and a second electrode which are formed on one principal surface and another principal surface thereof, respectively; and
the fuel cell casing of claim 2,
wherein the membrane electrode assembly is housed in the plurality of concavities of the fuel cell casing, respectively, one and the other principal surfaces of the membrane electrode assembly are arranged such that fluid can be exchanged between one and the other principal surfaces and their corresponding first and second fluid channels, the first and second wiring conductors are electrically connected to the first and second electrodes, respectively, the fourth and fifth wiring conductors are electrically connected to the first and second electrodes, respectively, the other end of the fourth wiring conductor is connected to the other end of the fifth wiring conductor, and the lid body is mounted on one surface of the base body near the concavity so as to cover the concavity.

13. An electronic apparatus comprising:
the fuel cell of claim 12, as a power source,
wherein the base body is made of multi-layer ceramics, and an external connection terminal is formed in at least one of the base body and the lid body.

14. The electronic apparatus of claim 13, wherein an internal circuit is formed in the base body.

15. The electronic apparatus of claim 14, wherein the base body has an electronic component which is disposed on the surface thereof so as to be electrically connected to the internal circuit.

16. The electronic apparatus of claim 13, wherein a piezoelectric pump is disposed partway along one of the first and second fluid channels.

17. A fuel cell comprising:
a plurality of membrane electrode assemblies, each having a first electrode and a second electrode which are formed on one principal surface and another principal surface thereof, respectively; and
the fuel cell casing of claim 3,
wherein the plurality of membrane electrode assemblies are housed in the concavity of the fuel cell casing, one and the other principal surfaces of the membrane electrode assembly are arranged such that fluid can be exchanged between one and the other principal surfaces and their corresponding first and second fluid channels, the first and second wiring conductors are electrically connected to the first and second electrodes, respectively, the third wiring conductor is electrically connected to the first electrode, and the lid body is mounted on one surface of the base body near the concavity so as to cover the concavity.

18. An electronic apparatus comprising:
the fuel cell of claim 17, as a power source,
wherein the base body is made of multi-layer ceramics, and an external connection terminal is formed in at least one of the base body and the lid body.

19. The electronic apparatus of claim 18, wherein an internal circuit is formed in the base body.

20. The electronic apparatus of claim 19, wherein the base body has an electronic component which is disposed on the surface thereof so as to be electrically connected to the internal circuit.

21. The electronic apparatus of claim 18, wherein a piezoelectric pump is disposed partway along one of the first and second fluid channels.

22. A fuel cell comprising:
a plurality of membrane electrode assemblies, each having a first electrode and a second electrode which are formed on one principal surface and another principal surface thereof, respectively; and
the fuel cell casing of claim 4,
wherein the plurality of membrane electrode assemblies are housed in the concavity of the fuel cell casing, one and the other principal surfaces of the membrane electrode assembly are arranged such that fluid can be exchanged between one and the other principal surfaces and their corresponding first and second fluid channels, the first and second wiring conductors are electrically connected to the first and second electrodes, respectively, the fourth and fifth wiring conductors are electrically connected to the first and second electrodes, respectively, the other end of the fourth wiring conductor is connected to the other end of the fifth wiring conductor, and the lid body is mounted on one surface of the base body near the concavity so as to cover the concavity.

23. An electronic apparatus comprising:
the fuel cell of claim 22, as a power source,
wherein the base body is made of multi-layer ceramics, and an external connection terminal is formed in at least one of the base body and the lid body.

24. The electronic apparatus of claim 23, wherein an internal circuit is formed in the base body.

25. The electronic apparatus of claim 24, wherein the base body has an electronic component which is disposed on the surface thereof so as to be electrically connected to the internal circuit.

26. The electronic apparatus of claim 23, wherein a piezoelectric pump is disposed partway along one of the first and second fluid channels.

27. A fuel cell comprising:
a plurality of membrane electrode assemblies, each having a first electrode and a second electrode which are formed on one principal surface and the other principal surfaces thereof, respectively; and
the fuel cell casing of claim 5,
wherein the membrane electrode assembly is housed in the first and second concavities of the fuel cell casing, one and the other principal surfaces of the membrane electrode assembly are arranged such that fluid can be exchanged between one and the other principal surfaces and their corresponding first and second fluid channels, the first and second wiring conductors are electrically connected to the first and second electrodes, respectively, and the first/second lid body is mounted on the principal surface of the base body near the first/second concavity so as to cover the first/second concavity.

28. An electronic apparatus comprising:
the fuel cell of claim 27, as a power source,
wherein the base body is made of multi-layer ceramics, and an external connection terminal is formed in at least one of the base body, the first lid body, and the second lid body.

29. The electronic apparatus of claim 28, wherein an internal circuit is formed in the base body.

30. The electronic apparatus of claim 29, wherein the base body has an electronic component which is disposed on the surface thereof so as to be electrically connected to the internal circuit.

31. The electronic apparatus of claim 28, wherein a piezoelectric pump is disposed partway along one of the first and second fluid channels.
